(19) United States
(12) Patent Application Publication
(10) Pub. No.: US 2015/0326866 A1
(43) Pub. Date: Nov. 12, 2015

(54) IMAGE DECODING DEVICE AND DATA STRUCTURE

(71) Applicant: SHARP KABUSHIKI KAISHA, Osaka (JP)

(72) Inventors: Tomohiro IKAI, Osaka-shi (JP); Tadashi UCHIUMI, Osaka-shi (JP); Yoshiya YAMAMOTO, Osaka-shi (JP)

(73) Assignee: Sharp Kabushiki Kaisha, Abeno-ku, Osaka-shi,Osaka (JP)

(21) Appl. No.: 14/652,156

(22) PCT Filed: Nov. 8, 2013
(86) PCT No.: PCT/JP2013/080245

§ 371 Date: Jun. 15, 2015

(30) Foreign Application Priority Data
Dec. 28, 2012 (JP) 2012-286712

(51) Int. Cl. H04N 19/169; H04N 19/174; H04N 19/597

(52) U.S. Cl. CPC H04N 19/188; H04N 19/597; H04N 19/174

(57) ABSTRACT

Pictures having the same time between a plurality of layers are allocated to the same display time POC. There is provided restriction of coded data in which the same POC is allocated to the pictures of the same time in all the layers, for example, by allowing all of the layers to have the same NAL unit type so that the initialization timings of the POC are the same between the layers, and a management length of the POC and a POC low-order bit are the same between the layers. An RAP picture with the layer ID other than 0 has a slice type other than an intra-slice I_SLICE.

### TECHNICAL FIELD

The present invention relates to an image decoding device and a data structure.

### BACKGROUND ART

In image coding technologies for a plurality of viewpoints, parallax prediction coding of reducing an information amount by predicting a parallax between images when images of a plurality of viewpoints are coded and decoding methods corresponding to the coding methods have been proposed (for example, see NPL 1). A vector indicating a parallax between viewpoint images is referred to as a disparity vector. The disparity vector is a 2-dimensional vector having a component (x component) in the horizontal direction and a component (y component) in the vertical direction and is calculated for each of the blocks which are regions divided from one image. When multi-viewpoint images are acquired, a camera disposed at each viewpoint is generally used. In the multi-viewpoint coding, viewpoint images are coded using as different layers in a plurality of layers. A method of coding a moving image including a plurality of layers is generally referred to as scalable coding or hierarchy coding. In the scalable coding, high coding efficiency is realized by executing prediction between layers. A layer serving as a reference point without executing the prediction between the layers is referred to as a base layer and the other layers are referred to as enhancement layers. The scalable coding when layers are configured from a viewpoint image is referred to as view scalable coding. At this time, the base layer is also referred to as a base view and the enhancement layer is also referred to a non-base view. Further, in addition to the view scalable coding, scalable coding when layers are configured from texture layers (image layers) and depth layers (distance image layers) is referred to as 3-dimensional scalable coding.

As the scalable coding, there are spatial scalable coding (a method of processing a picture with a low resolution as a base layer and processing a picture with a high resolution as an enhancement layer) and SNR scalable coding (a method of processing a picture with low quality as a base layer and processing a picture with high resolution as an enhancement layer) in addition to the view scalable coding. In the scalable coding, for example, a picture of a base layer is used as a reference picture in coding of a picture of an enhancement layer in some cases.

In NPL 1, as parameter structures of scalable coding technologies of HEVC, there are known the structure of an NAL unit header used when coded data is packeted as an NAL unit and the structure of a video parameter set defining a method of enhancing a plurality of layers. In NPL 1, in the NAL unit in which image coded data is packeted, a layer ID (layer_id) which is an ID for identifying layers from each other is known to be coded. Further, in the video parameter set defining common parameters to the plurality of layers, for example, a scalable mask scalable_mask designating an enhancement method, dimension_id indicating a dimension of each layer, and a layer IDref_layer_id of a dependent layer indicating layer on which the coded data of each layer depends, are coded. In the scalable mask, ON and OFF can be designated for scalable classification of space, image quality, depth, and view. ON of the scalable of the view or ON of the scalable of the depth and the view corresponds to 3D scalable.

In NPL 2, technologies using view scalable and depth scalable are known as HEVC-based 3-dimensional scalable coding technologies. In NPL 2, a depth intra-prediction (DMM) technology of predicting a predicted image of depth using a decoded image of texture of the same time as the depth and a motion parameter inheritance (MPI) technology using a motion compensation parameter of texture of the same time as the depth as a motion compensation parameter of the depth are known as technologies for coding depth. In NPL 2, there is a technology using the 0th bit of a layer ID for a depth flag depth_flag used to identify depth and texture and bits subsequent to the 1st bit of the layer ID for a view ID. Whether the depth is set is determined based on the layer ID. Only when the depth is determined to be set, flags enable_dmm_flag and use_mpi_flag indicating whether the depth intra-prediction and the motion parameter inheritance which are depth coding technologies can be used in a decoder are coded. In NPL 2, the coding of a picture of depth and view of the same time as the same coding unit (access unit) is described.

### CITATION LIST

### Non Patent Literature

NPL 1: “NAL unit header and parameter set designs for HEVC extensions”, JCTVC-K1007, JCTVC Shanghai, CN, 10 to 19 Oct. 2012
NPL 2: G. Tech, K. Wegner, Y. Chen, S. Yea, “3D-HEVC Test Model 1”, JCT3V-A1005, JCT3V 1st meeting, Stockholm, SE, 16-20 July, 2012

### SUMMARY OF INVENTION

### Technical Problem

However, in NPL 2, only a method of coding a picture of depth and view of the same time is coded as the same coding unit (access unit) is stated. However, how to code a display time POC in coded data is not defined. Specifically, a method of equalizing the display time POC, which is a variable managing a display time, between a plurality of layers is not defined. Therefore, when the POC is different between the plurality of layers, there is a problem that it is difficult for a decoder to determine the same time when the POC is different between the plurality of layers. When an initialization timing of the display time POC is different between the plurality of layers or a management length of the display time POC is different in the decoding of the POC, there is a problem that it is difficult to manage the same time since pictures of the same time may not have the same display time POC between the plurality of layers.

In NPL 2, a slice type of an RAP picture is restricted to an intra-slice regardless of a layer. Therefore, there is a problem that another picture may not be referred to and coding efficiency is not sufficient when a picture other than “layer ID=0” is an RAP picture.

In NPL 2, an NAL unit type is different according to a layer and whether a picture is an RAP picture is different in some cases. Therefore, there is a problem that it is difficult to reproduce a plurality of layers from the same time.

The present invention has been devised in light of the foregoing circumstances and provides an image decoding device, an image coding device, and a data structure capable of equalizing a display time POC between a plurality of layers, capable of referring to a picture other than a target layer with an RAP picture of a layer with a layer ID other than 0, or capable of facilitating reproduction a plurality of layers from the same time.

### Solution to Problem

To resolve the foregoing problems, a coded data structure according to an aspect of the invention includes a slice header that defines a slice type. The slice header has restriction that the slice type is an intra-slice in a case of a slice with a layer ID of 0 and has no restriction that the slice type is an intra-slice in a case in a slice with a layer ID other than 0.

A coded data structure according to another aspect of the invention includes one or more NAL units when an NAL unit header and NAL unit data are set as a unit (NAL unit). The NAL unit header includes a layer ID and an NAL unit type nal_unit type defining a type of NAL unit. A picture parameter set included in the NAL unit data includes a low-order bit maximum value MaxPicOrderCntLsb of a display time POC. Slice data included in the NAL unit data is configured to include a slice header and slice data. In the slice data in coded data including a low-order bit pic_order_cnt_lsb of the display time POC, all of the NAL units stored in a same access unit in all layers include the same display time POC in the included slice header.

An image decoding device according to still another aspect of the invention includes: an NAL unit header decoding section that decodes a layer ID and an NAL unit type nal_unit_type defining a type of NAL unit from an NAL unit header; a POC low-order bit maximum value decoding section that decodes a low-order bit maximum value MaxPicOrderCntLsb of a display time POC from a picture parameter set; a POC low-order bit decoding section that decodes a low-order bit pic_order_cnt_lsb of the display time POC from a slice header; a POC high-order bit derivation section that derives a high-order bit of the display time POC from the NAL unit type nal_unit_type, the low-order bit maximum value MaxPicOrderCntLsb of the display time POC, and the low-order bit pic_order_cnt_lsb of the display time POC; and a POC addition section that derives the display time POC from a sum of the high-order bit of the display time POC and the low-order bit of the display time POC. The POC high-order bit derivation section initializes the display time POC of a target layer when the NAL unit type nal_unit_type of a picture with the layer ID of 0 is an RAP picture (BLA or IDR) for which it is necessary to initialize the display time POC.

A coded data structure according to further still another aspect of the invention includes one or more NAL units when an NAL unit header and NAL unit data are set as a unit (NAL unit). The NAL unit header includes a layer ID and an NAL unit type nal_unit_type defining a type of NAL unit. The NAL unit header of a picture with the layer ID other than 0 indispensably includes (shall have) nal_unit_type which is the same as the NAL unit header of a picture with the layer ID of 0 at the same display time POC.

A coded data structure according to further still another aspect of the invention one or more NAL units when an NAL unit header and NAL unit data are set as a unit (NAL unit). The NAL unit header includes a layer ID and an NAL unit type nal_unit_type defining a type of NAL unit. The coded data structure has restriction that in a case in which the NAL unit header of a picture with a layer ID of 0 at a same output time as a picture with the layer ID other than 0 includes an NAL unit type nal_unit_type of an RAP picture (BLA or IDR) for which it is necessary to initialize a display time POC, the NAL unit header of a picture with the layer ID other than 0 indispensably includes nal_unit_type which is the same as the NAL unit header of the picture with the layer ID of 0 at the same display time POC.

### Advantageous Effects of Invention

In the coded data structure according to the invention, the display time POC is initialized with the pictures of the same time in the plurality of layers having the same time. Therefore, for example, when a display timing is managed using a time of a picture, the fact that pictures are the pictures of the same time can be managed using the POC, and thus it is possible to obtain the advantageous effect of facilitating retrieval and synchronization of the reference picture.

In the coded data structure having restriction of a range of the value of the slice type depending on the layer ID according to the invention, a picture with the layer ID of 0 at the same display time can be used as the reference image even when an NAL unit type is a random access picture (RAP) in the picture of the layer with the layer ID other than 0. Therefore, it is possible to obtain the advantageous effect of improving coding efficiency.

### BRIEF DESCRIPTION OF DRAWINGS

FIG. 1 is a schematic diagram illustrating the configuration of an image transmission system according to an embodiment of the invention.

FIG. 2 is a diagram illustrating a data hierarchy structure of coded data #1 according to the embodiment.

FIG. 3 is a conceptual diagram illustrating an example of a reference picture list.

FIG. 4 is a conceptual diagram illustrating an example of a reference picture.

FIG. 5 is a schematic diagram illustrating the configuration of an image decoding device according to the embodiment.

FIG. 6 is a schematic diagram illustrating the configuration of an inter-prediction parameter decoding section 303 according to the embodiment.

FIG. 7 is a schematic diagram illustrating the configuration of a merge prediction parameter derivation section 3036 according to the embodiment.

FIG. 8 is a schematic diagram illustrating the configuration of an AMVP prediction parameter derivation section 3032 according to the embodiment.

FIG. 9 is a conceptual diagram illustrating an example of a vector candidate.

FIG. 10 is a schematic diagram illustrating the configuration of an intra-predicted image generation section 310 according to the embodiment.

FIG. 11 is a schematic diagram illustrating the configuration of an inter-predicted image generation section 309 according to the embodiment.

FIG. 12 is a conceptual diagram illustrating residual prediction according to the embodiment.

FIG. 13 is a conceptual diagram illustrating illumination (illuminance) compensation according to the embodiment.

FIG. 14 is a diagram illustrating a table used for illumination compensation according to the embodiment.

FIG. 15 is a diagram for describing depth intra-prediction processed by the intra-predicted image generation section 310 according to the embodiment of the invention.

FIG. 16 is a diagram for describing depth intra-prediction processed by the intra-predicted image generation section 310 according to the embodiment of the invention.

FIG. 17 is a schematic diagram illustrating the structure of an NAL unit according to the embodiment of the invention.

FIG. 18 is a diagram illustrating the structure of coded data of the NAL unit according to the embodiment of the invention.

FIG. 19 is a diagram illustrating a relation between values of NAL unit types and classification of the NAL units according to the embodiment of the invention.

FIG. 20 is a diagram illustrating the structure of coded data of VPS according to the embodiment of the invention.

FIG. 21 is a diagram illustrating the structure of coded data of VPS extension according to the embodiment of the invention.

FIG. 22 is a diagram illustrating the structure of a random access picture according to the embodiment of the invention.

FIG. 23 is a functional block diagram illustrating a schematic configuration of an image decoding device 1 according to the embodiment of the invention.

FIG. 24 is a functional block diagram illustrating a schematic configuration of a header decoding section 10 according to the embodiment of the invention.

FIG. 25 is a functional block diagram illustrating a schematic configuration of an NAL unit header decoding section 211 according to the embodiment of the invention.

FIG. 26 is a functional block diagram illustrating a schematic configuration of a VPS decoding section 212 according to the embodiment of the invention.

FIG. 27 is a diagram illustrating information stored in a layer information storage section 213 according to the embodiment of the invention.

FIG. 28 is a schematic diagram illustrating a configuration of a picture structure according to the embodiment.

FIG. 29 is a schematic diagram illustrating the configuration of an image coding device 2 according to the embodiment.

FIG. 30 is a block diagram illustrating the configuration of a picture coding section 21 according to the embodiment.

FIG. 31 is a schematic diagram illustrating the configuration of an inter-prediction parameter coding section 112 according to the embodiment.

FIG. 32 is a functional block diagram illustrating a schematic configuration of an NAL unit header coding section 10E according to the embodiment.

FIG. 33 is a functional block diagram illustrating a schematic configuration of an NAL unit header coding section 211E according to the embodiment.

FIG. 34 is a functional block diagram illustrating a schematic configuration of a VPS coding section 212E according to the embodiment.

FIG. 35 is a schematic diagram illustrating the configuration of a POC information decoding section 216 according to the embodiment of the invention.

FIG. 36 is a diagram illustrating an operation of the POC information decoding section 216 according to the embodiment of the invention.

FIG. 37 is a conceptual diagram illustrating POC restriction according to the embodiment of the invention.

FIG. 38 is a diagram for describing slice types in a RAP picture according to the embodiment of the invention.

FIG. 39 is a functional block diagram illustrating a schematic configuration of a reference picture management section 13 according to the embodiment.

FIG. 40 is a diagram illustrating examples of a reference picture set and a reference picture list, FIG. 40(a) is a diagram illustrating arrangement of pictures forming a moving image in a display order, FIG. 40(b) is a diagram illustrating an example of RPS information applied to a target picture, FIG. 40(c) is a diagram illustrating an example of a current RPS derived at the time of application of the RPS information exemplified in FIG. 40(b) when the POC of the target picture is 0, and FIGS. 40(d) and 40(e) are diagrams illustrating examples of reference picture lists generated from a reference picture included in the current RPS.

FIG. 41 is a diagram illustrating a correction example of the reference picture list, FIG. 41(a) is a diagram illustrating an L0 reference list before correction, FIG. 41(b) is a diagram illustrating RPL correction information, and FIG. 41(c) is a diagram illustrating the L0 reference list after correction.

FIG. 42 is a diagram exemplifying a part of an SPS syntax table used at the time of SPS decoding in a header decoding section and a reference picture information decoding section of the image decoding device.

FIG. 43 is a diagram exemplifying a syntax table of a short-term reference picture set used at the time of the SPS decoding and the time of slice header decoding in the header decoding section and the reference picture information decoding section of the image decoding device.

FIG. 44 is a diagram exemplifying a part of a slice header syntax table used at the time of the slice header decoding in the header decoding section and the reference picture information decoding section of the image decoding device.

FIG. 45 is a diagram exemplifying a part of a slice header syntax table used at the time of the slice header decoding in the header decoding section and the reference picture information decoding section of the image decoding device.

FIG. 46 is a diagram exemplifying a part of a syntax table of reference list modification information used at the time of the slice header decoding in the header decoding section and the reference picture information decoding section of the image decoding device.

FIG. 47 is a diagram exemplifying a syntax table of the reference list modification information used at the time of the slice header decoding in the image decoding device.

FIG. 48 is a schematic diagram illustrating the configuration of a POC information coding section 216E according to the embodiment of the invention.

### DESCRIPTION OF EMBODIMENTS

### First Embodiment

Hereinafter, embodiments of the present invention will be described with reference to the drawings.

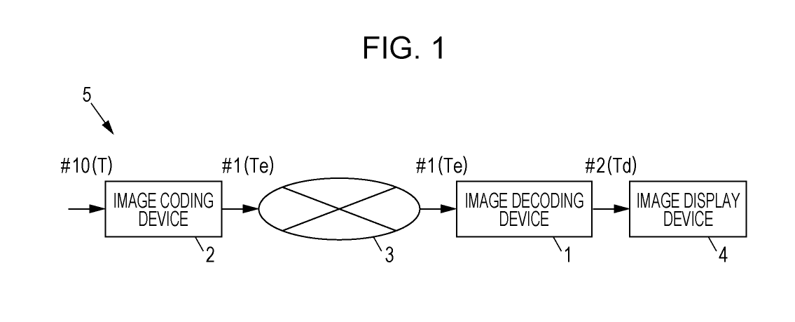

FIG. 1 is a schematic diagram illustrating the configuration of an image transmission system 5 according to the embodiment.

The image transmission system 5 is a system in which codes obtained by coding a plurality of layer images are transmitted and images obtained by decoding the transmitted codes are displayed. The image transmission system 5 includes an image coding device 2, a network 3, an image decoding device 1, and an image display device 4.

Signals T (input image #10) indicating a plurality of layer images (also referred to as texture images) are input to the image coding device 2. The layer image is an image that is recognized and photographed at a certain resolution and a certain viewpoint. When view scalable coding of coding 3-dimensional images using a plurality of layer images is executed, each of the plurality of layer images is referred to as a viewpoint image. Here, the viewpoint corresponds to the position or an observation point of a photographing device. For example, the plurality of viewpoint images are images obtained when right and left photographing devices photograph a subject. The image coding device 2 codes each of the signals to generate coded data #1 (coded data). The details of the coded data #1 will be described below. The viewpoint image refers to a 2-dimensional image (planar image) observed at a certain viewpoint. The viewpoint image is denoted, for example, with a luminance value or a color signal value of each of the pixels arranged in a 2-dimensional plane. Hereinafter, one viewpoint image or a signal indicating the viewpoint image is referred to as a picture. When spatial scalable coding is executed using a plurality of layer images, the plurality of layer images include a base layer image with a low resolution and an enhancement layer image with a high resolution. When SNR scalable coding is executed using the plurality of layer images, the plurality of layer images include a base layer image with low image quality and an enhancement layer image with high image quality. The view scalable coding, the spatial scalable coding, and the SNR scalable coding may be arbitrarily combined.

The network 3 transmits the coded data #1 generated by the image coding device 2 to the image decoding device 1. The network 3 is the Internet, a wide area network (WAN), a local area network (LAN), or a combination thereof. The network 3 is not necessarily restricted to a bi-directional communication network, but may be a uni-directional or bi-directional communication network that transmits broadcast waves of terrestrial wave digital broadcast, satellite broadcast, or the like. The network 3 may be substituted with a storage medium that records the coded data #1, such as a Digital Versatile Disc (DVD) or a Blue-ray Disc (BD).

The image decoding device 1 decodes each of the coded data #1 transmitted by the network 3 and generates each of a plurality of decoded layer images Td (decoded viewpoint images Td or decoded images #2) obtained through the decoding.

The image display device 4 displays some or all of the plurality of decoded layer images Td (the decoded images #2) generated by the image decoding device 1. For example, in the view scalable coding, 3-dimensional images (stereoscopic images) or free viewpoint images are displayed in the case of all of the images and 2-dimensional images are displayed in the case of some of the images. The image display device 4 includes, for example, a display device such as a liquid crystal display or an organic electro-luminescence (EL) display. In the spatial scalable coding or the SNR scalable coding, when the image decoding device 1 and the image display device 4 have high processing capabilities, enhancement layer images with high image quality are displayed. When the image decoding device 1 and the image display device 4 have lower processing capabilities, base layer images for which the high processing capability and display capability of the enhancement layer images are not necessary are displayed.

### <Structure of Coded Data #1>

A data structure of the coded data #1 generated by the image coding device 2 and decoded by the image decoding device 1 will be described before the image coding device 2 and the image decoding device 1 according to the embodiment are described in detail.

### (NAL Unit Layer)

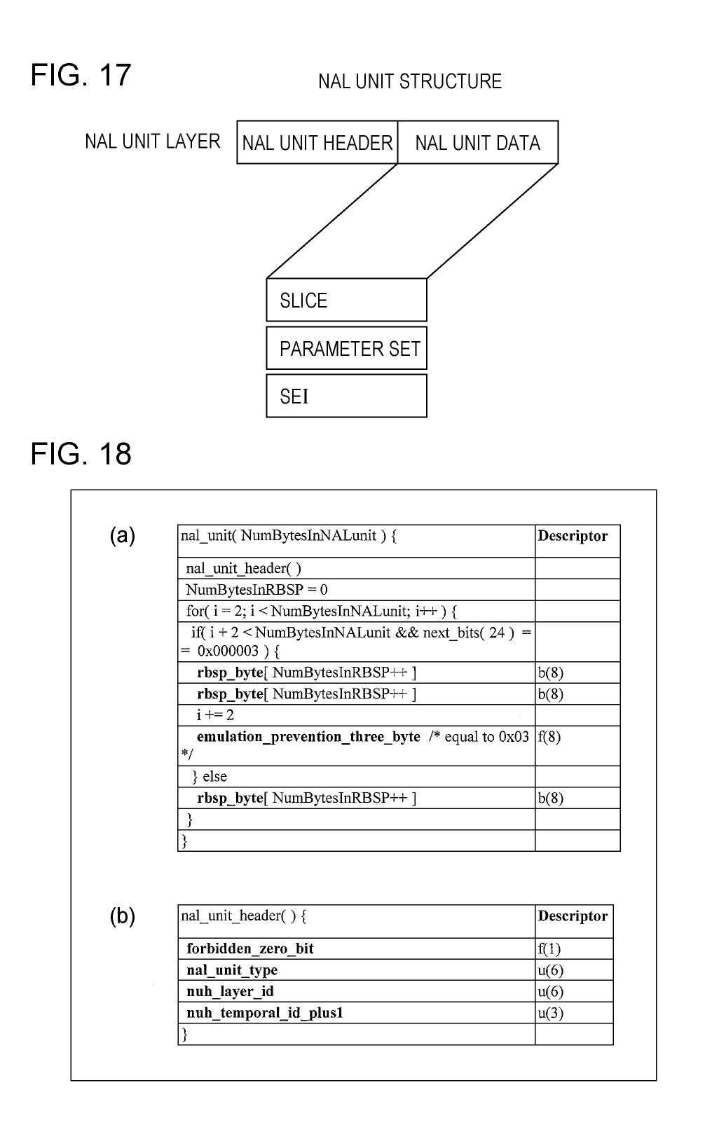

FIG. 17 is a schematic diagram illustrating a data hierarchy structure of the coded data #1. The coded data #1 is coded in a unit called a Network Abstraction Layer (NAL) unit.

The NAL is a layer that is provided to abstract communication between a Video Coding Layer (VCL) which is a layer in which a moving-image coding process is executed and a low-order system transmitting and accumulating coded data.

The VCL is a layer in which an image coding process is executed. Coding is executed in the VCL. The low-order system mentioned herein corresponds to the file formats of H.264/AVC and HEVC or an MPEG-2 system. In an example to be described below, the low-order system corresponds to a decoding process in a target layer and a reference layer. In the NAL, a bit stream generated in the VCL is separated in a unit called an NAL unit to be transmitted to the low-order system which is a destination.

FIG. 18(a) illustrates a syntax table of a Network Abstraction Layer (NAL) unit. The NAL unit includes coded data coded in the VCL and a header (NAL unit header: nal_unit_header( )) configured such that the coded data appropriately arrives at the low-order system which is a destination. The NAL unit header is denoted with, for example, a syntax illustrated in FIG. 18(b). In the NAL unit header, “nal_unit_type” indicating a type of coded data stored in the NAL unit, “nuh_temporal_id_plus1” indicating an identifier (temporal identifier) of a sub-layer to which the stored coded data belongs, and “nuh_layer_id” (or nuh_reserved_zero_{—}6 bits) indicating an identifier (layer identifier) of a layer to which the stored coded data belongs are described.

The NAL unit data includes a parameter set, SEI, and a slice to be described below.

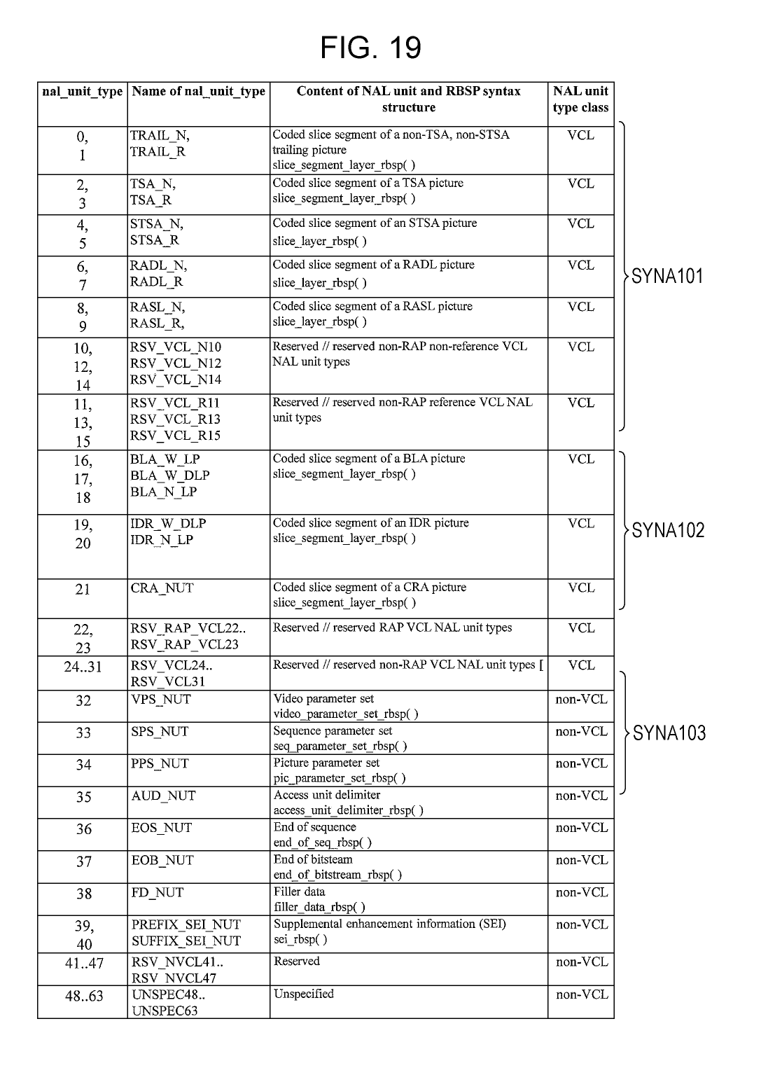

FIG. 19 is a diagram illustrating a relation between values of NAL unit types and classification of the NAL units. As illustrated in FIG. 19, the NAL units having NAL unit types of values 0 to 15 indicated by SYNA 101 are slices of non-Random Access Picture (RAP). The NAL units having NAL unit types of values 16 to 21 indicated by SYNA 102 are slices of Random Access Picture (RAP). The RAP pictures are broadly classified into BLA pictures, IDR pictures, and CRA pictures. The BLA pictures are classified into BLA_W_LP, BLA_W_DLP, and BLA_N_LP. The IDR pictures are classified into IDR_W_DLP and IDR_N_LP. As pictures other than the RAP pictures, there are an LP picture, a TSA picture, an STSA picture, a TRAIL picture, and the like to be described below.

### (Access Unit)

A set of the NAL units summarized according to a specific classification rule is referred to as an access unit. When the number of layers is 1, the access unit is a set of the NAL unit that forms one picture. When the number of layers is greater than 1, the access unit is a set of the NAL units that form pictures of a plurality of layers of the same time. To denote the delimitation of the access unit, the coded data may include an NAL unit referred to as an access unit delimiter. The access unit delimiter is included between the set of the NAL units forming the access unit present in the coded data and the set of the NAL units forming a different access unit.

### (Video Parameter Set)

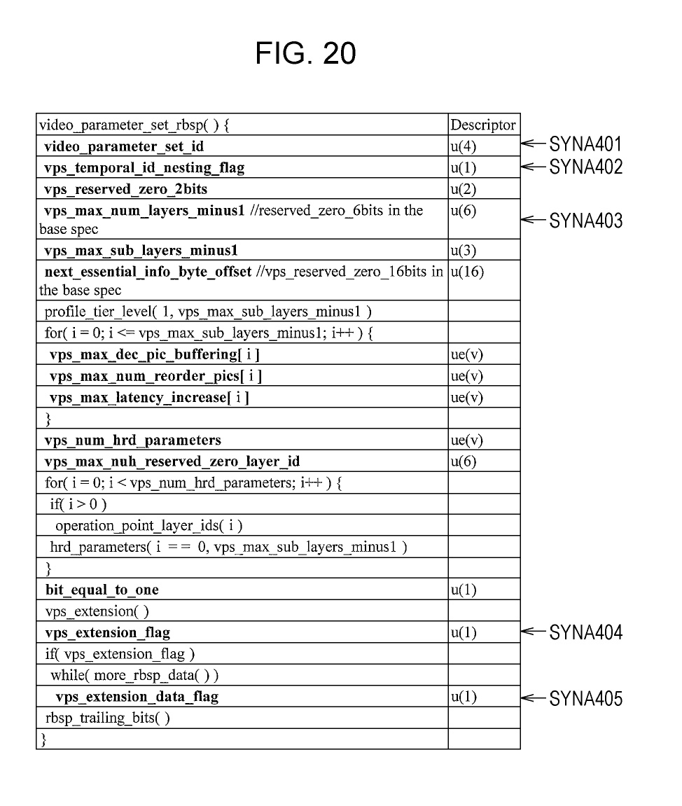

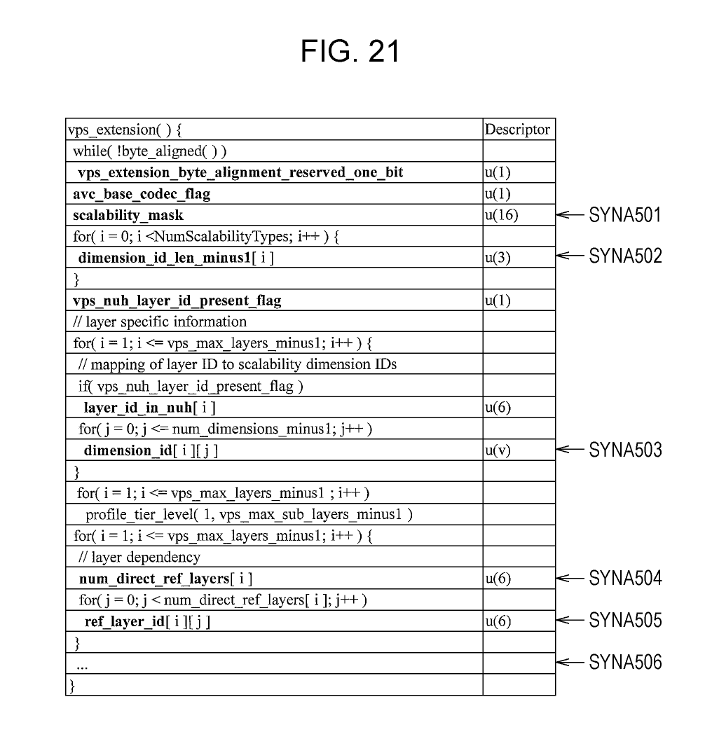

FIG. 20 is a diagram illustrating the structure of coded data of a Video Parameter Set (VPS) according to the embodiment of the invention. The meanings of some of the syntax elements are as follows. A VPS is a parameter set for defining common parameters to the plurality of layers. In the parameter set, a picture is referred to using an ID (video_parameter_set_id) from the coded data which is compressed data.
video_parameter_set_id (SYNA 401 in FIG. 20) is an identifier for identifying each VPS.
vps_temporal_id_nesting_flag (SYNA 402 in FIG. 20) is a flag indicating whether additional restriction is imposed on inter-prediction in a picture in which the VPS is referred to.
vps_max_num_sub_layers_minus1 (SYNA 403 in FIG. 20) is a syntax used to calculate an upper limit value MaxNumLayers of the number of layers regarding other scalability excluding temporal scalability in regard to hierarchy coded data including at least a basic layer. The upper limit value MaxNumLayers of the number of layers is denoted with “MaxNumLayers=vps_max_num_sub_layers_minus1+1.” When the hierarchy coded data is formed by only the basic layer, “vps_max_num_sub_layers_minus1=0” is satisfied.
vps_extension_flag (SYNA 404 in FIG. 20) is a flag indicating whether the VPS further include a VPS extension.
vps_extension_data_flag (SYNA 405 in FIG. 20) is a VPS extension body and will be specifically described with reference to FIG. 21.

When “a flag indicating whether XX is indicated” is described in the present specification, 1 is set to a case in which XX is indicated and 0 is set to a case of XX is not indicated. Then, 1 is treated to be true and 0 is treated to be false in logical NOT, logical AND, or the like (the same applies below). However, in an actual device or method, other values can also be used as true and false values.

FIG. 21 is a diagram illustrating the structure of the coded data of VPS extension according to the embodiment of the invention. The meanings of some of the syntax elements are as follows.
scalability_mask (SYNA 501 in FIG. 21) is a value indicating classification of the scalability. In a scalability mask, each bit corresponds to each scalable classification. A bit 1 corresponds to spatial scalable, a bit 2 corresponds to quality scalable, a bit 3 corresponds to depth scalable, and a bit 4 corresponds to view scalable. When each bit is 1, the corresponding scalable classification means to be valid. A plurality of bits can also be 1. For example, when scalability_mask is 12, the bit 3 and the bit 4 are 1. Therefore, the depth scalable and the view scalable are valid. That is, 3D scalable including a plurality of views and depths is meant.
dimension_id_len_minus1 (SYNA 502 in FIG. 21) indicates a number num_dimensions which is the number of dimensions ID dimension_id included in each of scalable classification. “num_dimensions=dimension_id_len_minus1 [1]+1” is satisfied. For example, num_dimensions is 2 when the scalable classification is the depth. When the scalable classification is the view, the number of viewpoints is decoded.
A dimension ID dimension_id_(SYNA 503 in FIG. 21) is information indicating classification of a picture for each scalable classification.
The number of dependent layers num_direct_ref_layers (SYNA 504 in FIG. 21) is information indicating the number of dependent layers ref_layer_id.
A dependent layer ref_layer_id (SYNA 505 in FIG. 21) is information indicating a layer ID of a layer which is referred to by a target layer.
A portion indicated as “ . . . ” by SYNA 506 in FIG. 21 is information different for each profile or scalable classification (of which details will be described below).

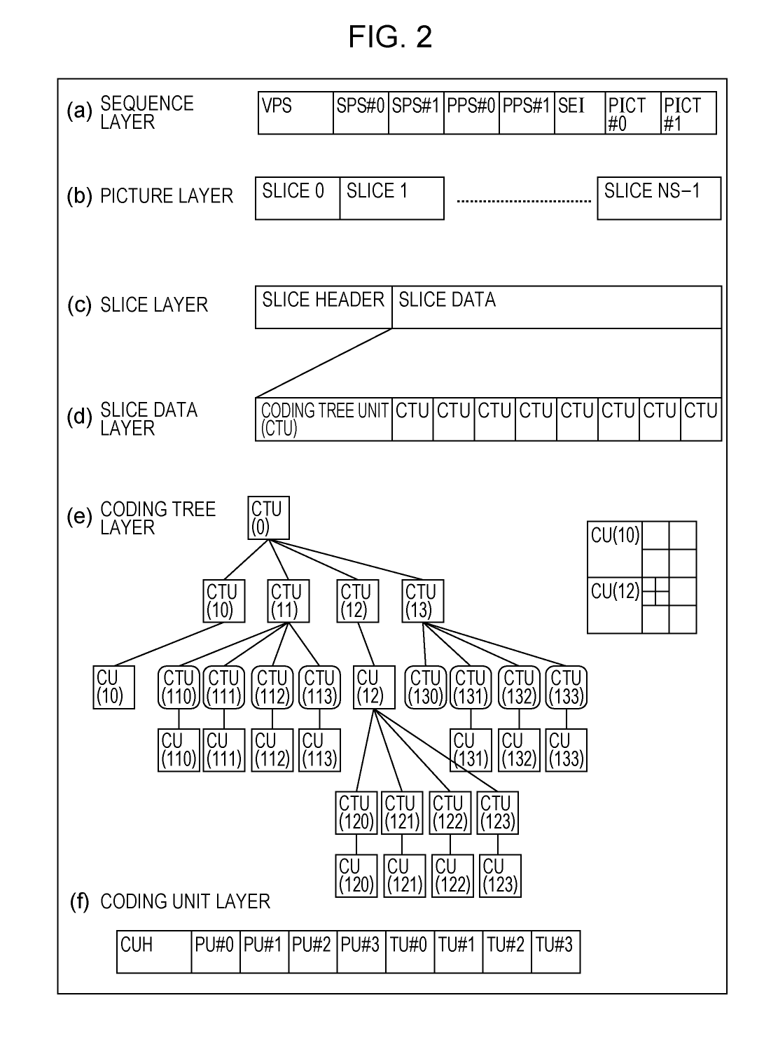

FIG. 2 is a diagram illustrating a data hierarchy structure of coded data #1. The coded data #1 includes, for example, a sequence and a plurality of pictures included in the sequence. (a) to (f) of FIG. 2 are diagrams illustrating a sequence layer prescribing a sequence SEQ, a picture layer defining a picture PICT, a slice layer defining a slice S, a slice data layer defining slice data, a coded tree layer defining a coded tree unit included in the slice data, and a coding unit layer defining a coding unit (CU) included in the coding tree.

### (Sequence Layer)

In the sequence layer, a set of data referred to by the image decoding device 1 is defined to decode the sequence SEQ of a processing target (hereinafter also referred to as a target sequence). As illustrated in (a) of FIG. 2, the sequence SEQ includes a video parameter set (VPS), a sequence parameter set (SPS), a picture parameter set (PPS), pictures PICT, and supplemental enhancement information (SEI). Here, a numeral shown after # indicates a layer ID. In FIG. 2, an example in which coded data of #0 and #1, that is, layer 0 and layer 1, are present is illustrated, but the kinds and number of layer are not restricted thereto.

In the video parameter set VPS, a set of coded parameters common to a plurality of moving images and a set of coding parameters related to a plurality of layers and an individual layer included in a moving image are defined in a moving image formed by a plurality of layers.

In the sequence parameter set SPS, a set of coding parameters referred to by the image decoding device 1 is defined to decode a target sequence. For example, the width and height of a picture are defined.

In the picture parameter set PPS, a set of coding parameters referred to by the image decoding device 1 is defined to decode each picture in the target sequence. For example, a reference point (criterion) value (pic_init_qp_minus26) of a quantization width used to decode the picture and a flag (weighted_pred_flag) indicating application of weighting prediction are included. The plurality of PPSs may be present. In this case, one of the plurality of PPSs from each picture in the target sequence is selected.

### (Picture Layer)

In the picture layer, a set of data referred to by the image decoding device 1 is defined to decode the picture PICT of a processing target (hereafter also referred to as a target picture). As illustrated in (b) of FIG. 2, the picture PICT includes a plurality of slices S0 to SNS-1 (where NS is a total number of slices included in the picture PICT).

When it is not necessary to distinguish the slices S0 to SNS-1 from each other, the slices are described below in some cases by omitting the subscripts of the codes. The same also applies to data which is data included in the coded data #1 to be described below and is other data to which subscripts are appended.

### (Slice Layer)

In the slice layer, a set of data referred to by the image decoding device 1 is defined to decode the slice S of a processing target (also referred to as a target slice). As illustrated in (c) of FIG. 2, the slice S includes a slice header SH and slice data SDATA.

The slice header SH includes a coding parameter group referred to by the image decoding device 1 to decide a method of decoding the target slice. Slice type designation information (slice_type) designating the types of slices is an example of a coding parameter included in the slice header SH.

As the types of slices which can be designated by the slice type designation information, for example, (1) an I slice using only intra-prediction at the time of coding, (2) a P slice using uni-directional prediction or intra-prediction at the time of coding, and (3) a B slice using uni-directional prediction, bi-directional prediction, or intra-prediction at the time of coding can be exemplified.

The slice header SH may include a reference (pic_parameter_set_id) in the picture parameter set PPS included in the sequence layer.

### (Slice Data Layer)

In the slice data layer, a set of data referred to by the image decoding device 1 is defined to decode the slice data SDATA of a processing target. As illustrated in (d) of FIG. 2, the slice data SDATA includes coded tree blocks (CTB). The CTB is a block with a fixed size (for example, 64×64) included in the slice and is also sometimes referred to as a largest cording unit (LCU).

### (Coded Tree Layer)

In the coded tree layer, as illustrated in (e) of FIG. 2, a set of data referred to by the image decoding device 1 is defined to decode the coded tree block of a processing target. The coded tree unit is segmented through recursive quadtree splitting. A node of a tree structure obtained through the recursive quadtree splitting is referred to as a coding tree. An immediate node of a quadtree is defined as a coded tree unit (CTU) and the coded tree block is also defined as a highest CTU. The CTU includes a split flag (split_flag). When split_flag is 1, the coded tree unit is split to four coded tree units CTU is executed. When split_flag is 0, the coded tree unit CTU is split into four coded units (CU). The coded unit CU is an end node of the coding tree and no further splitting is executed in this layer. The coded unit CU is a basic unit of a coding process.

When the coded tree block CTB has a size of 64×64 pixels, the size of the coded unit can be one of 64×64 pixels, 32×32 pixels, 16×16 pixels, and 8×8 pixels.

### (Coding Unit Layer)

In the coding unit layer, as illustrated in (f) of FIG. 2, a set of data referred to by the image decoding device 1 is defined to decode the coding unit of a processing target. Specifically, the coding unit is configured to include a CU header CUH, a prediction tree, a transform tree, and a CU header CUF. In the CU header CUH, for example, whether the coding unit is a unit used for intra-prediction or a unit used for inter-prediction is defined. The coding unit is a root of a prediction tree (PT) and a transform tree (TT). The CU header CUF is included between the prediction tree and the transform tree or after the transform tree.

In the prediction tree, the coding unit is split into one prediction block or a plurality of prediction blocks and the position and size of each prediction block are defined. In other words, the prediction block is a region included in the coding unit and one or plurality of regions which do not overlap with each other. The prediction tree includes one prediction block or a plurality of prediction blocks obtained through the above-described splitting.

The prediction process is executed for each prediction block. Hereinafter, the prediction block which is a unit of prediction is referred to as a prediction unit (PU).

Roughly speaking, there are two types of splitting in the prediction tree in the case of intra-prediction and the case of inter-prediction. The intra-prediction refers to prediction in the same picture and the inter-prediction refers to a prediction process executed between mutually different pictures (for example, between display times or between layer images).

In the case of intra-prediction, there are 2N×2N (which is the same size of the coding unit) and N×N splitting methods.

In the case of inter-prediction, coding is executed by part_mode of the coded data in a splitting method and there are 2N×2N (which is the same size of the coding unit), 2N×N, 2N×nU, 2N×nD, N×2N, nL×2N, nR×2N, and N×N. Further, 2N×nU indicates that the coding unit of 2N×2N is split into two regions of 2N×0.5N and 2N×1.5N in order from the top. Further, 2N×nD indicates that the coding unit of 2N×2N is split into two regions of 2N×1.5N and 2N×0.5N in order from the top. Further, nL×2N indicates that the coding unit of 2N×2N is split into two regions of 0.5N×2N and 1.5N×2N in order from the left. Further, nR×2N indicates that the coding unit of 2N×2N is split into two regions of 1.5N×2N and 0.5N×1.5N in order from the top. Since the number of splits is one of 1, 2, and 4, the number of PUs included in the CU is 1 to 4. The PUs are denoted as PU0, PU1, PU2, and PU3 in order.

In the transform tree, the coding unit is split into one transform block or a plurality of transform blocks and the position and size of each transform block are defined. In other words, the transform block is a region included in the coding unit and one or plurality of regions which do not overlap with each other. The transform tree includes one transform block or a plurality of transform blocks obtained through the above-described splitting.

As the splitting of the transform tree, there is splitting in which a region with the same size as the coding unit is allocated as the transform block and splitting by recursive quadtree splitting, as in the splitting of the above-described tree block.

A transform process is executed for each transform block. Hereinafter, the transform block which is a unit of transform is referred to as a transform unit (TU).

### (Prediction Parameter)

A predicted image of the prediction unit is derived by a prediction parameter subordinate to the prediction unit. As the prediction parameter, there is a prediction parameter of intra-prediction or a prediction parameter of inter-prediction. Hereinafter, the prediction parameter of inter-prediction (inter-prediction parameter) will be described. The inter-prediction parameter is configured to include prediction list use flags predFlagL0 and predFlagL1, reference picture indexes refldxL0 and refIdxL1, and vectors mvL0 and mvL1. The prediction list use flags predFlagL0 and predFlagL1 are flags indicating whether to use reference picture lists respectively called an L0 list and an L1 list and the reference picture list corresponding to the case of a value of 1 is used. A case in which two reference picture lists are used, that is, a case of predFlagL0=1 and predFlagL1=1, corresponds to bi-prediction. A case in which one reference picture list is used, that is, a case of (predFlagL0, predFlagL1)=(1, 0), or (predFlagL0, predFlagL1)=(0, 1), corresponds to uni-prediction. Information regarding the prediction list use flag can also be denoted as an inter-prediction flag inter_pred_idx to be described below. Normally, the prediction list use flag is used in a predicted image generation section and a prediction parameter memory to be described below. When information indicating whether a certain reference picture list is used or not is decoded from the coded data, the inter prediction flag inter_pred_idx is used.

Examples of syntax elements used to derive the inter-prediction parameter included in the coded data include a split mode part_mode, a merge flag merge_flag, a merge index merge_idx, an inter-prediction flag inter_pred_idx, a reference picture index refldxLX, a prediction vector index mvp_LX_idx, and a difference vector mvdLX.

### (Example of Reference Picture List)

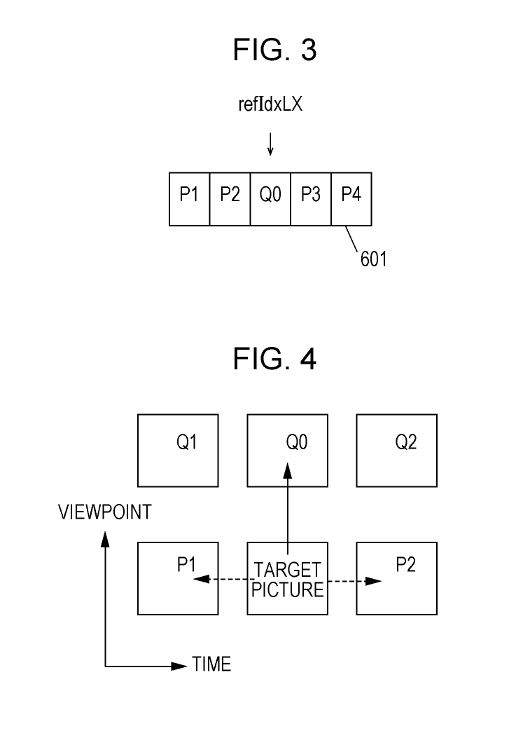

Next, an example of the reference picture list will be described. The reference picture list is a line formed by reference pictures stored in a decoded picture buffer 12. FIG. 3 is a conceptual diagram illustrating an example of the reference picture list. In a reference picture list 601, five rectangles arranged horizontally in a line indicate reference pictures. Codes P1, P2, Q0, P3, and P4 shown in order from the left end to the right are codes indicating reference pictures. P of P1 and the like indicates a viewpoint P and Q of Q0 and the like indicates a different viewpoint Q from the viewpoint P. The suffixes of P and Q indicate picture order numbers POC. A downward arrow immediately below refldxLX indicates that the reference picture index refldxLX is an index referring to the reference picture Q0 in the decoded picture buffer 12.

### (Example of Reference Picture)

Next, an example of the reference picture used at the time of derivation of a vector will be described. FIG. 4 is a conceptual diagram illustrating an example of the reference picture. In FIG. 4, the horizontal axis represents a display time and the vertical axis represents a viewpoint. As illustrated in FIG. 4, rectangles of two vertical rows and three horizontal columns (a total of six rectangles) indicate pictures. Of the six rectangles, the second rectangle from the left in the low row indicates a picture of a decoding target (target picture). The remaining five rectangles indicate reference pictures. A reference picture Q0 indicated by an upward arrow from the target picture is a picture of which a display time is the same as the target picture and a viewpoint is different from the target picture. In disparity prediction in which a target picture serves as a reference point, the reference picture Q0 is used. A reference picture P1 indicated by a leftward arrow from the target picture is a past picture of which the viewpoint is the same as the target picture. A reference picture P2 indicated by a rightward arrow from the target picture is a future picture of which the viewpoint is the same as the target picture. In motion prediction in which a target picture serves as a reference point, the reference picture P1 or P2 is used.

### (Random Access Picture)

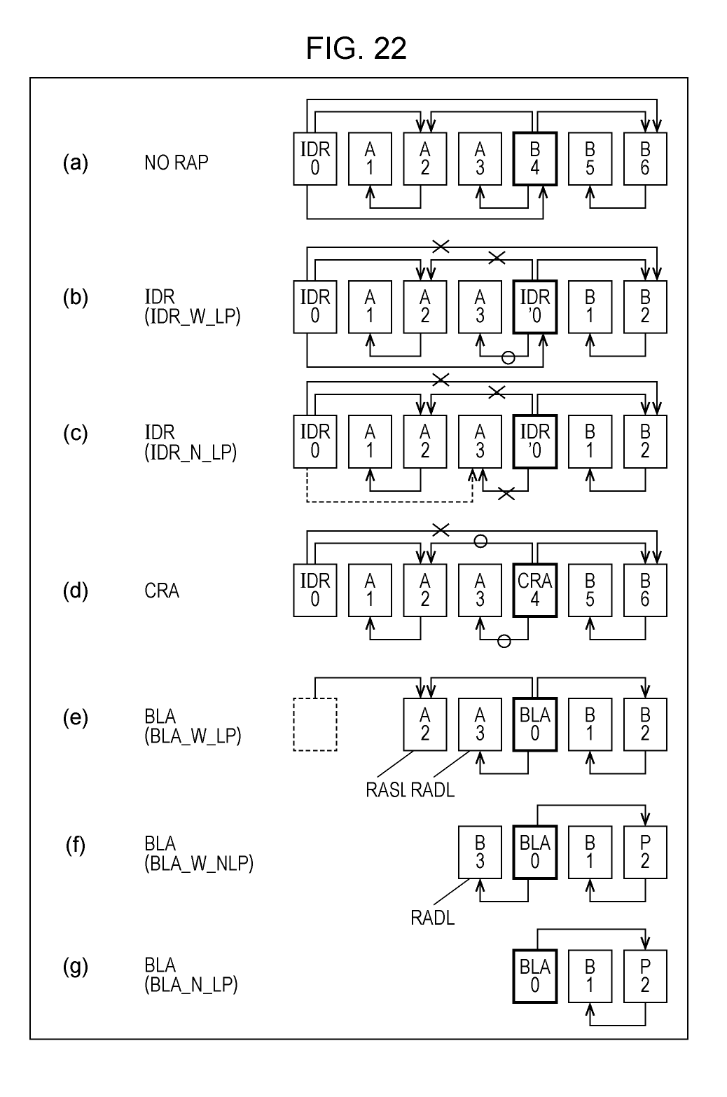

The structure of the random access picture (RAP) treated in the embodiment will be described. FIG. 22 is a diagram illustrating the structure of the random access picture. There are three types of RAPs, an Instantaneous Decoding Refresh (IDR), a Clean Randum Access (CRA), and a Broken Link Access (BLA). Whether a certain NAL unit is an NAL unit including the slice of the RAP picture is identified by the NAL unit type. The NAL unit types IDR_W_LP, IDR_N_LP, CRA, BLA_W_LP, BLA_W_DLP, and BLA_N_LP correspond to an IDR_W_LP picture, an IDR_N_LP picture, a CRA picture, a BLA_W_LP picture, a BLA_W_DLP picture, and a BLA_N_LP picture to be described below, respectively. That is, the NAL units including the slices of the pictures have the above-described NAL unit types.

FIG. 22(a) shows a case in which the RAP picture is not present excluding the beginning picture. Letters of the alphabet in boxes indicate names of the pictures and numerals indicate the POCs (the same applies below). The pictures are lined in a display order from the left to the right of the drawing. IDR0, A1, A2, B4, B5, and B6 are decoded in the order of IDR0, B4, A1, A2, B6, and B5. Hereinafter, cases in which the picture indicated by B4 in FIG. 22(a) is changed to the RAP picture are shown in FIGS. 22(b) to 22(g).

FIG. 22(b) shows an example in which the IDR picture (particularly, the IDR_W_LP picture) is inserted. In this example, the pictures are decoded in the order of IDR0, IDR′0, A1, A2, B2, and B1. To distinguish the two IDR pictures from each other, the picture of which a time is earlier (earlier also in a decoding order) is referred to as IDR0 and the picture of which a time is later is referred to as IDR′0. For all of the RAP pictures including the IDR picture of this example, other pictures are prohibited from being referred to. The other pictures are referred to by restricting the slice of the RAP picture to an intra I_SLICE, as will be described below (this restriction is alleviated for a layer with the layer ID other than 0 in an embodiment to be described below). Accordingly, the RAP picture can be independently decoded without dependency on decoding of other pictures. Further, when the IDR picture is decoded, a reference picture set (RPS) to be described below is initialized. Therefore, prediction executed using a picture decoded before the IDR picture, for example, prediction from B2 to IDR0, is prohibited. The picture A3 has a display time POC earlier than the display time POC of the RAP (here, IDR′0), but is decoded later than the RAP picture. A picture decoded later than the RAP picture but reproduced earlier than the RAP picture is referred to as a leading picture (LP picture). A picture other than the RAP picture and the LP picture is a picture decoded and reproduced later than the RAP picture and is generally referred to as a TRAIL picture. IDR_W_LP is an abbreviation for Instantaneous Decoding Refresh With Leading Picture and the LP picture such as the picture A3 may be included. The picture A2 refers to the pictures of IDR0 and POC4 in the example of FIG. 22(a). However, in the case of the IDR picture, the RPS is initialized when IDR′0 is decoded. Therefore, reference from A2 to IDR′0 is prohibited. When the IDR picture is decoded, the POC is initialized.

To sum up, the IDR picture is a picture that has the following restrictions:
the POC is initialized at the time of picture decoding;
the RPS is initialized at the time of picture decoding;
other pictures are prohibited from being referred to;
pictures from a picture later than the IDR in a decoding order to a picture earlier than the IDR in the decoding order are prohibited from being referred to;
an RASL picture (to be described below) is prohibited;
an RADL picture (to be described below) can be included (in the case of the IDR_W_LP picture); and
the RADL picture (to be described below) can be included (in the cases of BLA_W_LP and BLA_W_DLP pictures).

FIG. 22(c) shows an example in which the IDR picture (particularly, the IDR_N_LP picture) is inserted. IDR_N_LP is an abbreviation for Instantaneous Decoding Refresh NoLeading Picture. The LP picture is prohibited from being present. Accordingly, the A3 picture in FIG. 22(b) is prohibited from being present. Thus, the A3 picture is necessarily decoded earlier than the IDR′0 picture by referring to the IDR0 picture instead of the IDR′0 picture.

FIG. 22(d) shows an example in which the CRA picture is inserted. In this example, the pictures are decoded in the order of IDR0, CRA4, A1, A2, B6, and B5. In the CRA picture, the RPS is not initialized unlike the IDR picture. Accordingly, it is not necessary to prohibit the pictures from the picture later than the RAP (here, the CRA) in the decoding order to the picture earlier than the RAP (here, the CRA) in the decoding order from being referred to (the pictures from A2 to CRA4 are prohibited from being referred to). However, when the decoding starts from the CRA picture which is the RAP picture, it is necessary to be able to decode the pictures later than the CRA in the display order. Therefore, it is necessary to prohibit a picture later than the RAP (CRA) in a display order to a picture earlier than the RAP (CRA) in the decoding order from being referred to (the pictures from B6 to IDR0 are prohibited from being referred to). For the CRA, the POC is not initialized.

To sum up, the CRA picture is a picture that has the following restrictions:
the POC is not initialized at the time of picture decoding;
the RPS is not initialized at the time of picture decoding;
other pictures are prohibited from being referred to;
pictures from a picture later than the CRA in the display order to a picture earlier than the CRA in the decoding order are prohibited from being referred to; and
an RADL picture and an RASL picture can be included.

FIGS. 22(e) to 22(g) are examples of the BLA pictures. The BLA picture is an RAP picture which is used at the time of restructure of a sequence using the CRA picture as a beginning picture by editing the coded data including the CRA picture.

The BLA picture has the following restrictions:
the POC is initialized at the time of picture decoding;
other pictures are prohibited from being referred to;
pictures from a picture later than the BLA in the display order to a picture earlier than the BLA in the decoding order are prohibited from being referred to;
an RASL picture (to be described below) can be included (in the cases of BLA_W_LP); and
the RADL picture (to be described below) can be included (in the cases of BLA_W_LP and BLA_W_DLP pictures).

For example, a case in which decoding of the sequence starts from the position of the CRA4 picture in FIG. 22(d) will be described as an example.

FIG. 22(e) shows an example in which the BLA picture (particularly, the BLA_W_LP picture) is used. BLA_W_LP is an abbreviation for Broken Link Access With Leading Picture. The LP picture is permitted to be present. When the CRA4 picture is substituted with the BLA_W_LP picture, the A2 and A3 pictures which are the LP pictures of the BLA pictures may be present in the coded data. However, since the A2 picture is a picture decoded earlier than the BLA_W_LP picture, the A2 picture is not present in the coded data edited using the BLA_W_LP picture as the beginning picture. For the BLA_W_LP picture, the LP picture for which the decoding may not be possible is treated as a random access skipped leading (RASL) picture which is correspondingly not decoded and displayed. The A3 picture is an LP picture for which the decoding is possible and is referred to as a random access decodable leading (RADL) picture. The RASL picture and the RADL picture are distinguished from each other by NAL unit types RASL_NUT and RADL_NUT.

FIG. 22(f) shows an example in which the BLA picture (particularly, the BLA_W_DLP picture) is used. BLA_W_DLP is an abbreviation for Broken Link Access With Decorable Leading Picture. The LP picture which can be decoded is permitted to be present. Accordingly, for the BLA_W_DLP picture, unlike FIG. 22(e), the A2 picture which is the undecodable LP picture (RASL) is not permitted to be present in the coded data. The A3 picture which is the decodable LP picture (RADL) is permitted to be present in the coded data.

FIG. 22(g) shows an example in which the BLA picture (particularly, the BLA_N_LP picture) is used. BLA_N_LP is an abbreviation for Broken Link Access No Leading Picture. The LP picture is not permitted to be present. Accordingly, for the BLA_N_DLP picture, unlike FIGS. 22(e) and 22(f), not only the picture A2 (RASL) but also the A3 picture (RADL) are not permitted to be present in the coded data.

### (Inter-Prediction Flag and Prediction List Use Flag)

A relation between the inter-prediction flag and the prediction list use flags predFlagL0 and predFlagL1 can be mutually converted as follows. Therefore, as the inter-prediction parameter, the prediction list use flag may be used or the inter-prediction flag may be used. Hereinafter, in determination using the prediction list use flag, the flag can also be substituted with the inter-prediction flag. In contrast, in determination using the inter-prediction flag, the flag can also be substituted with the prediction list use flag.

Inter-prediction flag=(predFlagL1<<1)+predFlagL0

predFlagL0=inter-prediction flag & 1

predFlagL1=inter-prediction flag>>1

Here, >> is right shift and << is left shift.

### (Merge Prediction and AMVP Prediction)

In a method of decoding (coding) the prediction parameter, there are a merge prediction (merge) mode and an Adaptive Motion Vector Prediction (AMVP) mode. The merge flag merge_flag is a flag used to identify these modes. In either the merge prediction mode or the AMVP mode, a prediction parameter of a target PU is derived using the prediction parameter of the block which has already been processed. The merge prediction mode is a mode in which the prediction list use flag predFlagLX (the inter-prediction flag inter_pred_idx), the reference picture index refldxLX, and the vector mvLX are not included in coded data and is a mode in which the already derived prediction parameters are used without change. The AMVP mode is a mode in which the inter-prediction flag inter_pred_idx, the reference picture index refldxLX, and the vector mvLX are included in coded data. The vector mvLX is coded as a difference vector (mvdLX) and a prediction vector index mvp_LX_idx indicating a prediction vector.

The inter-prediction flag inter_pred_idc is data indicating the kinds and numbers of reference pictures and is the value of one of Pred_L0, Pred_L1, and Pred_Bi. Pred_L0 and Pred_L1 each indicate that reference pictures stored in the reference picture lists referred to as the L0 list and the L1 list are used and both indicate that one reference picture is used (uni-prediction). The prediction using the L0 list and the L1 list are referred to as L0 prediction and L1 prediction, respectively. Pred_Bi indicates that two reference pictures are used (bi-prediction) and indicates that two reference pictures stored in the L0 list and the L1 list are used. The prediction vector index mvp_LX_idx is an index indicating a prediction vector and the reference picture index refldxLX is an index indicating the reference picture stored in the reference picture list. LX is a description method used when the L0 prediction and the L1 prediction are not distinguished from each other and distinguish the parameter in regard to the L0 list from the parameter with regard to the L1 list by substituting the LX with L0 or L1. For example, refldxL0 is a reference picture index used for the L0 prediction, refIdxL1 is a reference picture index used for the L1 prediction, and refldx (refldxLX) is notation used when refldxL0 and refIdxL1 are not distinguished from each other.

The merge index merge_idx is an index indicating that one prediction parameter among prediction parameter candidates (merge candidates) derived from the completely processed block is used as a prediction parameter of the decoding target block.

### (Motion Vector and Disparity Vector)

As the vector mvLX, there are a motion vector and a disparity vector (parallax vector). The motion vector is a vector that indicates a position deviation between the position of a block in a picture of a certain layer at a certain display time and the position of a corresponding block in the picture of the same layer at a different display time (for example, an adjacent discrete time). The disparity vector is a vector that indicates a position deviation between the position of a block in a picture of a certain layer at a certain display time and the position of a corresponding block in a picture of a different layer at the same display time. The picture of the different layer is a picture with a different viewpoint in some cases or is a picture with a different resolution in some cases. In particular, the disparity vector corresponding to the picture with the different viewpoint is referred to as a parallax vector. In the following description, when the motion vector and the disparity vector are not distinguished from each other, the motion vector and the disparity vector are simply referred to as vectors mvLX. A prediction vector and a difference vector in regard to the vector mvLX are referred to as a prediction vector mvpLX and a difference vector mvdLX, respectively. Whether the vector mvLX and the difference vector mvdLX are the motion vectors or the disparity vectors is executed using the reference picture index refldxLX subordinate to the vector.

### (Configuration of Image Decoding Device)

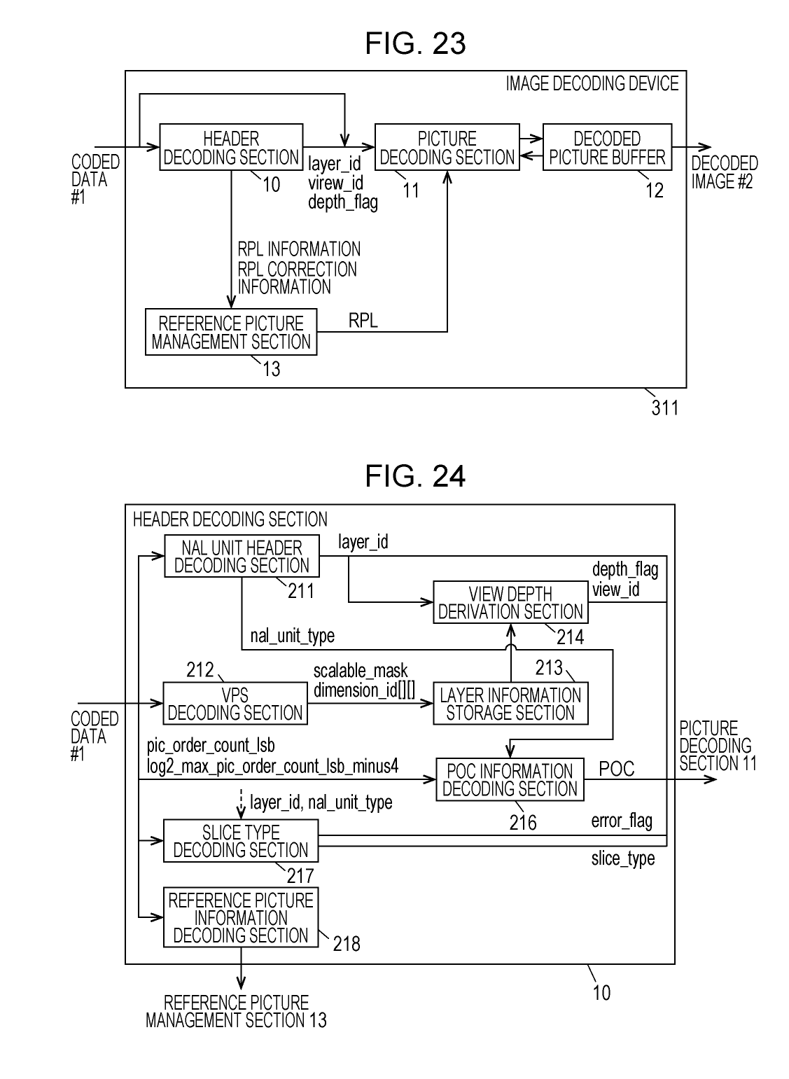

The configuration of the image decoding device 1 according to the embodiment will be described. FIG. 23 is a functional block diagram illustrating a schematic configuration of the image decoding device 1 according to the embodiment of the invention. The image decoding device 1 is configured to include a header decoding section 10, a picture decoding section 11, a decoded picture buffer 12, and a reference picture management section 13. The image decoding device 1 can execute a random access decoding process of starting decoding from a picture at a specific time in an image including a plurality of layers, as will be described below.

### [Header Decoding Section 10]

The header decoding section 10 decodes information used to be decoded in an NAL unit, a sequence unit, a picture unit, or a slice unit from the coded data #1 supplied from the image coding device 2. The decoded information is output to the picture decoding section 11 and the reference picture management section 13.

The header decoding section 10 parses the VPS and the SPS included in the coded data #1 based on the given definition of the syntax and decodes information used for decoding in the sequence unit. For example, information regarding the number of layers is decoded from the VPS and information regarding the image size of the decoded image is decoded from the SPS.

The header decoding section 10 parses a slice header included in a coded data #1 based on the given definition of the syntax and decodes information used for decoding in the slice unit. For example, a slice type is decoded from the slice header.

As illustrated in FIG. 24, the header decoding section 10 includes an NAL unit header decoding section 211, a VPS decoding section 212, a layer information storage section 213, a view depth derivation section 214, a POC information decoding section 216, a slice type decoding section 217, and a reference picture information decoding section 218.

### [NAL Unit Header Decoding Section 211]

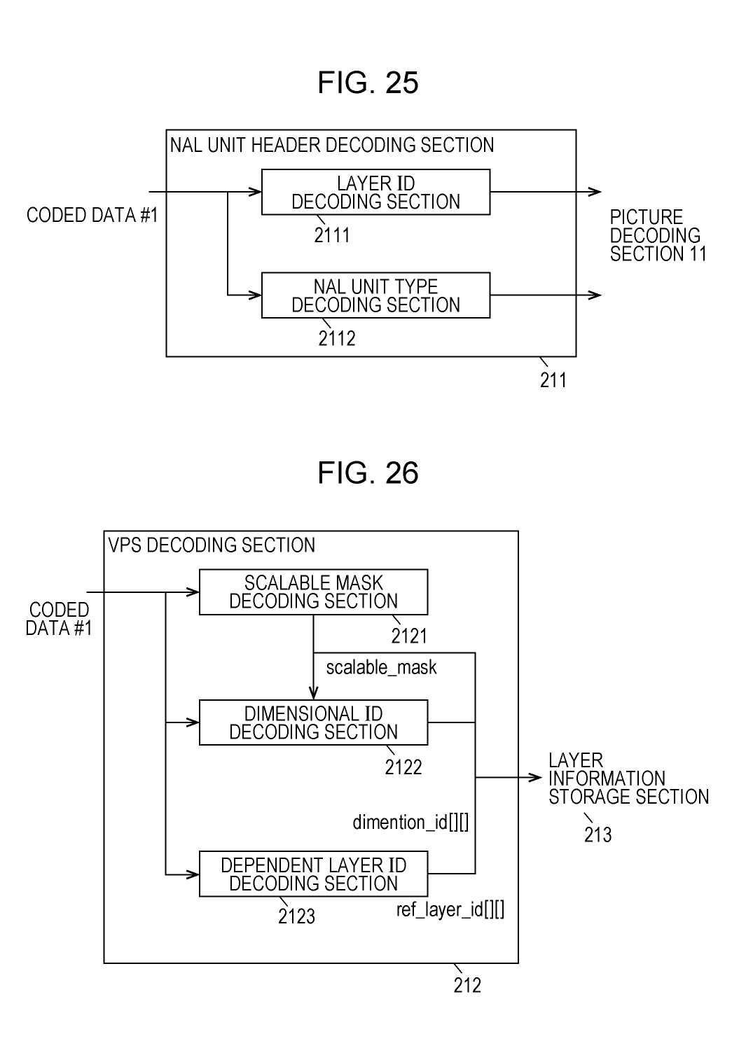

FIG. 25 is a functional block diagram illustrating a schematic configuration of the NAL unit header decoding section 211. As illustrated in FIG. 25, the NAL unit header decoding section 211 is configured to include a layer ID decoding section 2111 and an NAL unit type decoding section 2112.

The layer ID decoding section 2111 decodes the layer ID from the coded data. The NAL unit type decoding section 2112 decodes the NAL unit type from the coded data. The layer ID is, for example, 6-bit information from 0 to 63 and indicates the base layer when the layer ID is 0. The NAL unit type is, for example, 6-bit information from 0 to 63 and indicates classification of data included in the NAL unit. As will be described below, the classification of data is identified from, for example, the parameter sets such as the VPS, the SPS, and the PPS, the RPS pictures such as the IDR picture, the CRA picture, and the LBA picture, and a non-RPS picture such as the LP picture, and the NAL unit type such as the SEI.

### [VPS Decoding Section 212]

The VPS decoding section 212 decodes information used for decoding in a plurality of layers based on the given definition of the syntax from the VPS included in the coded data and the VPS extension. For example, the syntax illustrated in FIG. 20 is decoded from the VPS and the syntax illustrated in FIG. 21 is decoded from the VPS extension. The VPS extension is decoded when the flag vps_extension_flag is 1. In the present specification, the structure (syntax table) of the coded data and the meaning or restriction (semantics) of the syntax elements included in the structure of the coded data are referred to as a coded data structure. The coded data structure is related to a random access property and a memory size when the image decoding device decodes the coded data and is related to compensation of the same operation between different image decoding devices, and is an important technology component which also has an influence on the coding efficiency of the coded data.

FIG. 26 is a functional block diagram illustrating a schematic configuration of the VPS decoding section 212. As illustrated in FIG. 26, the VPS decoding section 212 is configured to include a scalable type decoding section 2121, a dimensional ID decoding section 2122, and a dependent layer ID decoding section 2123.

In the VPS decoding section 212, a syntax element vps_max_layers_minus1 indicating the number of layers is decoded from the coded data by an internal layer number decoding section (not illustrated), is output to the dimensional ID decoding section 2122 and the dependent layer ID decoding section 2123, and is stored in the layer information storage section 213.

The scalable type decoding section 2121 decodes the scalable mask scalable_mask from the coded data, outputs the scalable mask scalable_mask to the dimensional ID decoding section 2122, and stores the scalable mask scalable_mask in the layer information storage section 213.

The dimensional ID decoding section 2122 decodes the dimension ID dimension_id from the coded data and stores the dimension ID dimension_id in the layer information storage section 213. Specifically, the dimensional ID decoding section 2122 first operates each bit of the scalable mask and derives the number NumScalabilityTypes of bits which are 1. For example, in the case of scalable_mask=1, only bit 0 (which is a 0th bit) is 1. Therefore, in the case of NumScalabilityTypes=1 and scalable_mask=12, two bit 2 (=4) and bit 3 (=8) are 1, and thus NumScalabilityTypes=2 is satisfied.

In the embodiment, the first bit viewed from the LSB side is denoted as bit 0 (0th bit). That is, an Nth bit is denoted as bit N−1.

Subsequently, the dimensional ID decoding section 2122 decodes a dimension ID dimension_id[i][j] for every layer i and scalable classification j. The index i of the layer ID has a value from 1 to vps_max_layers_minus1 and the index j indicating the scalable classification has a value from 0 to NumScalabilityTypes−1.

The dependent layer ID decoding section 2123 decodes the number of dependent layers num_direct_ref_layers and the dependent layer flag ref_layer_id from the coded data and stores the number of dependent layers num_direct_ref_layers and the dependent layer flag ref_layer_id in the layer information storage section 213. Specifically, dimension_id[i][j] is decoded by the number of dependent layers num_direct_ref_layers for every index i. The index i of the layer ID has a value from 1 to vps_max_layers_minus1 and the index j of the dependent layer flag has a value from 0 to num_direct_ref_layers−1. For example, when a layer with the layer ID of 1 depends on a layer with the layer ID of 2 and a layer with the layer ID of 3, the layer with the layer ID of 1 depends on the two layers. Therefore, the number of dependent layers num_direct_ref_layers [ ]=2 is satisfied and the dependent layer IDs are two, that is, ref_layer_id[1][0]=2 and ref_layer_id[1][1]=3.

### [Layer Information Storage Section 213]

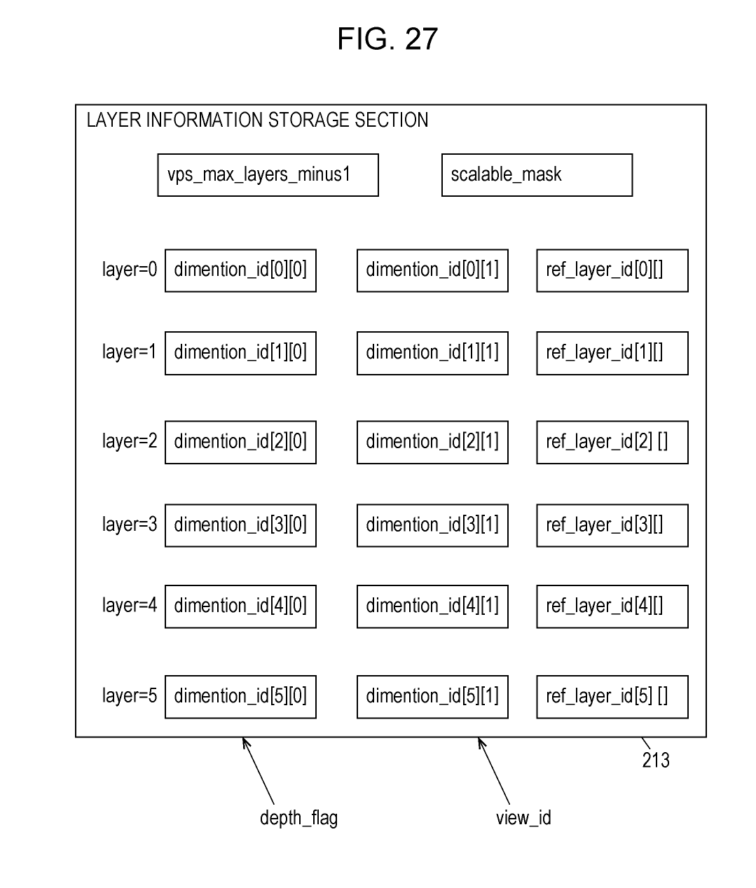

FIG. 27 is a diagram illustrating information stored in the layer information storage section 213 according to the embodiment of the invention. FIG. 27 shows a case in which the number of layers is 6 (vps_max_layers_minus1=5) and the scalable mask is 3D scalable (a case in which either bit 3 meaning the depth scalable or bit 4 indicating the view scalable is 1, that is, the case of scalable_mask=24). As illustrated in FIG. 27, the layer information storage section 213 stores not only the number of layers vps_max_layers_minus1 and the scalable mask scalable_mask but also the individual dimension ID dimension_id[ ][ ] and dependent layer ref_layer_id[ ][ ] of each of the layers (from layer_id=0 to layer_id=5).

### [View Depth Derivation Section 214]

The view depth derivation section 214 derives the depth flag depth_flag and the view ID view_id of the target layer with reference to the layer information storage section 213 based on the layer ID layer_id (hereinafter referred to as a target layer_id) of the target layer input to the view depth derivation section 214. Specifically, the view depth derivation section 214 reads the scalable mask stored in the layer information storage section 213 and executes the following process according to the value of the scalable mask.

When the scalable mask means the depth scalable (when bit 3 indicating the depth scalable is 1, that is, when scalabl_e mask=8), the view depth derivation section 214 sets 0 in the dimension ID view_dimension_id_indicating the view ID and derives view_id and depth_flag by the following expression.

view_dimension_id=0

depth_flag=dimension_id[layer_id][view_dimension_id]

That is, the view depth derivation section 214 reads dimension_id[ ][ ] corresponding to the target layer_id from the layer information storage section 213 and sets dimension_id[ ][ ] in the depth flag depth_flag. The view ID is set to 0.

When the scalable mask means the view scalable (when bit 4 indicating the view scalable is 1, that is, when scalable_mask=16), the view depth derivation section 214 sets 0 in the dimension ID depth_dimension_id indicating the depth flag and derives view_id and depth_flag by the following expression.

depth_dimension_id=0

view_id=dimension_id[layer_id][depth_dimension_id]

depth_flag=0

That is, the view depth derivation section 214 reads dimension_id[ ][ ] corresponding to the target layer_id from the layer information storage section 213 and sets dimension_id[ ][ ] in the view ID view_id. The depth flag depth_flag is set to 0.

When the scalable mask means the 3D scalable (when either bit 3 indicating the depth scalable is 1 or bit 4 indicating the view scalable is 1, that is, when scalable_mask=24), the view depth derivation section 214 sets 0 in the dimension ID depth_dimension_id indicating the depth flag, sets 1 in the dimension ID view_dimension_id indicating the view ID, and derives view_id and depth_flag by the following expression.

depth_dimension_id=0

view_dimension_id=1

depth_flag=dimension_id[layer_id][depth_dimension_id]

view_id=dimension_id[layer_id][view_dimension_id]

That is, the view depth derivation section 214 reads two dimension IDs dimension_id[ ][ ] corresponding to the target layer_id from the layer information storage section 213, sets one of the dimension IDs in the depth flag depth_flag, and sets the other of the dimension IDs in view_id.

In the foregoing configuration, the view depth derivation section 214 reads dimension_id corresponding to the depth flag depth_flag indicating whether the target layer is texture or depth and sets dimension_id in the depth flag depth_flag when the scalable classification includes the depth scalable. The view depth derivation section 214 reads dimension_id corresponding to the view ID view_id and sets dimension_id in the view ID view_id when the scalable classification includes the view scalable. The view depth derivation section 214 reads two dimension IDs dimension_id and sets the dimension IDs in depth_flag and view_id when the scalable classification is the depth scalable and the view scalable.

### [POC Information Decoding Section 216]

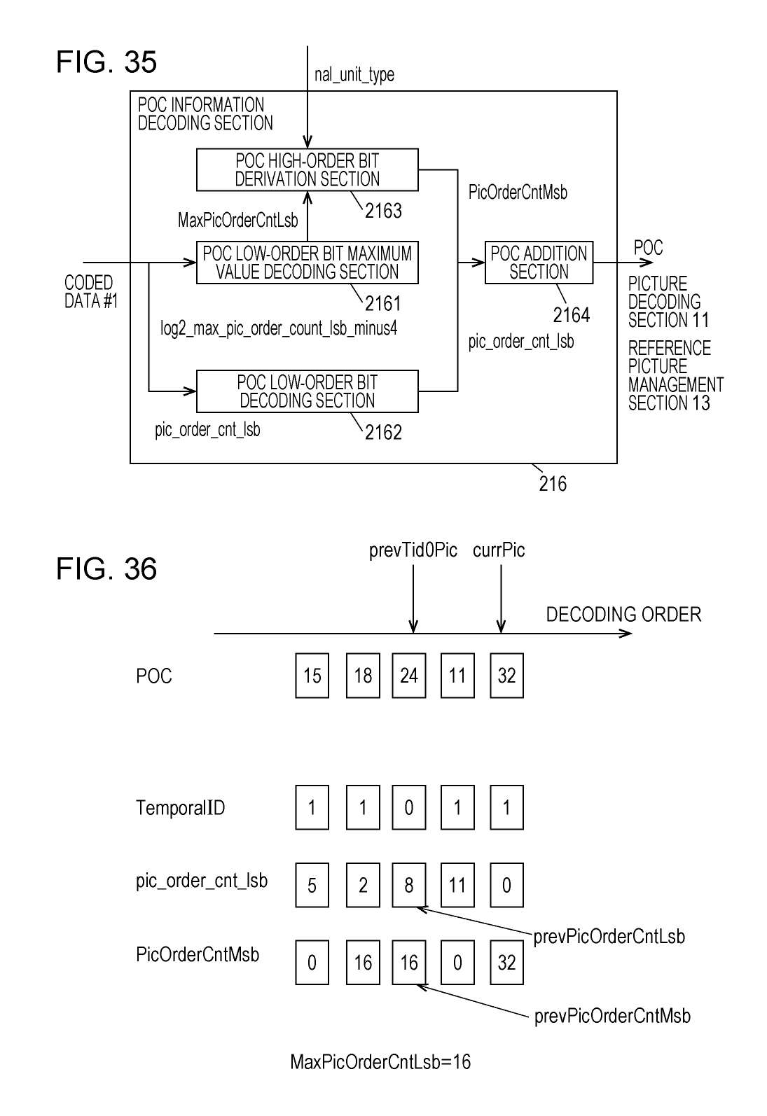

FIG. 35 is a functional block diagram illustrating a schematic configuration of the POC information decoding section 216 (POC derivation section). As illustrated in FIG. 35, the POC information decoding section 216 is configured to include a POC low-order bit maximum value decoding section 2161, a POC low-order bit decoding section 2162, a POC high-order bit derivation section 2163, and a POC addition section 2164. The POC information decoding section 216 derives the POC by decoding the high-order bit PicOrderCntMsb of the POC and the low-order bit pic_order_cnt_lsb of the POC and outputs the POC to the picture decoding section 11 and the reference picture management section 13.

The POC low-order bit maximum value decoding section 2161 decodes a POC low-order bit maximum value MaxPicOrderCntLsb of the target picture from the coded data. Specifically, a syntax element log 2_max_pic_order_cnt_lsb_minus4 coded as a value obtained by subtracting an integer 4 from a logarithm of the POC low-order bit maximum value MaxPicOrderCntLsb is decoded from the coded data of the PPS defining the parameter of the target picture, and then the POC low-order bit maximum value MaxPicOrderCntLsb is derived by the following expression.

MaxPicOrderCntLsb=2^{(log2}^{_{—}}^{max}^{_{—}}^{pic}^{_{—}}^{order}^{_{—}}^{cnt}^{_{—}}^{lsb}^{_{—}}^{minus4+4)}

MaxPicOrderCntLsb indicates delimitation of the high-order bit PicOrderCntMsb of the POC and the low-order bit pic_order_cnt_lsb. For example, when MaxPicOrderCntLsb is 16 (log 2_max_pic_order_cnt_lsb_minus4=0), low-order 4 bits, which is from 0 to 15, are indicated as pic_order_cnt_lsb and the high-order bit over the 4 bits is indicated as PicOrderCntMsb.

The POC low-order bit decoding section 2162 decodes the POC low-order bit pic_order_cnt_lsb which is a low-order bit of the POC of the target picture from the coded data. Specifically, pic_order_cnt_lsb included in the slice header of the target picture is decoded.

The POC high-order bit derivation section 2163 derives the POC high-order bit PicOrderCntMsb which is a high-order bit of the POC of the target picture. Specifically, when the NAL unit type of the target picture input from the NAL unit header decoding section 211 indicates the RAP picture for which the initialization of the POC is necessary (the case of the BLA or the IDR), the POC high-order bit PicOrderCntMsb is initialized to 0 by the following expression.

PicOrderCntMsb=0

An initialization timing is assumed to be a point of time at which the first slice (the slice with a slice address of 0 included in the slice header or the first slice input to the image decoding device among the slices input to the target picture) of the target picture is decoded.

In the case of the other NAL unit types, the POC high-order bit PicOrderCntMsb is derived using the POC low-order bit maximum value MaxPicOrderCntLsb, which is decoded by the POC low-order bit maximum value decoding section 2161, or temporary variables prevPicOrderCntLsb and prevPicOrderCntMsb to be described below by the following expression.

if ((pic_order_cnt_lsb<prevPicOrderCntLsb)&&((prevPicOrderCntLsb−pic_order_cnt_lsb)>=(MaxPicOrderCntLsb/2)))

PicOrderCntMsb=prevPicOrderCntMsb+MaxPicOrderCntLsb else if ((pic_order_cnt_lsb>prevPicOrderCntLsb)&&

((pic_order_cnt_lsb−prevPicOrderCntLsb)>(MaxPicOrderCntLsb/2)))

PicOrderCntMsb=prevPicOrderCntMsb−MaxPicOrderCntLsb

else

PicOrderCntMsb=prevPicOrderCntMsb

That is, when pic_order_cnt_lsb is less than prevPicOrderCntLsb and a difference between prevPicOrderCntLsb and pic_order_cnt_lsb is equal to or greater than half of MaxPicOrderCntLsb, a number obtained by adding MaxPicOrderCntLsb and prevPicOrderCntMsb is set as PicOrderCntMsb. Further, when pic_order_cnt_lsb is greater than prevPicOrderCntLsb and the difference between prevPicOrderCntLsb and pic_order_cnt_lsb is equal to or greater than the half of MaxPicOrderCntLsb, a number obtained by subtracting MaxPicOrderCntLsb from prevPicOrderCntMsb is set as PicOrderCntMsb. In the other cases, prevPicOrderCntMsb is set as PicOrderCntMsb.

The POC high-order bit derivation section 2163 derives the temporary variables prevPicOrderCntLsb and prevPicOrderCntMsb in the following order. When the reference picture for which an immediately previous TemporalId is 0 is assumed to be prevTid0Pic in the decoding order, the POC low-order bit pic_order_cnt_lsb of the picture prevTid0Pic is set in prevPicOrderCntMsb and the POC high-order bit PicOrderCntMsb of the picture revTid0Pic is set in prevPicOrderCntMsb.

FIG. 36 is a diagram illustrating an operation of the POC information decoding section 216. As illustrated in FIG. 36, an example is shown in which the pictures of POC=15, 18, 24, 11, and 32 are decoded in the order from the left to the right of the drawing in the case of MaxPicOrderCntLsb=16. Here, when the picture at the right end (the picture of POC=32) is assumed to be a target picture, the immediately previous picture of TemporalID=0 in the decoding order is the picture of POC=24 at the time of the decoding of the target picture. Therefore, the POC information decoding section 216 sets the picture of POC=24 as the picture prevTid0Pic. From the POC low-order bit and the POC high-order bit of the picture prevTid0Pic, prevPicOrderCntLsb and prevPicOrderCntMsb are derived as 8 and 16. Since pic_order_cnt_lsb of the target picture is 0, the derived prevPicOrderCntLsb is 8, and the half of MaxPicOrderCntLsb is 8, the case is established in which the above-described determination pic_order_cnt_lsb is less than prevPicOrderCntLsb and the difference between prevPicOrderCntLsb and pic_order_cnt_lsb is equal to or greater than the half of MaxPicOrderCntLsb. Thus, the POC information decoding section 216 sets a number obtained by adding MaxPicOrderCntLsb and prevPicOrderCntMsb as PicOrderCntMsb. That is, PicOrderCntMsb of the target picture is derived as 32 (=16+16).

The POC addition section 2164 adds the POC low-order bit pic_order_cnt_lsb decoded by the POC low-order bit decoding section 2162 and the POC high-order bit derived by the POC high-order bit derivation section 2163 to derive POC (PicOrderCntVal) by the following expression.

PicOrderCntVal=PicOrderCntMsb+pic_order_cnt_lsb

In the example of FIG. 36, PicOrderCntVal which is the POC of the target picture is derived as 32 because of PicOrderCntMsb=32 and pic_order_cnt_lsb=0.

### [POC Restriction]

Hereinafter, the POC restriction in the coded data according to the embodiment will be described. As described in the POC high-order bit derivation section 2163, the POC is initialized when the NAL unit type of the target picture indicates the RAP picture for which it is necessary to initialize the POC (the case of the BLA or the IDR). Thereafter, the POC is derived using pic_order_cnt_lsb obtained by decoding the slice header of the target picture.

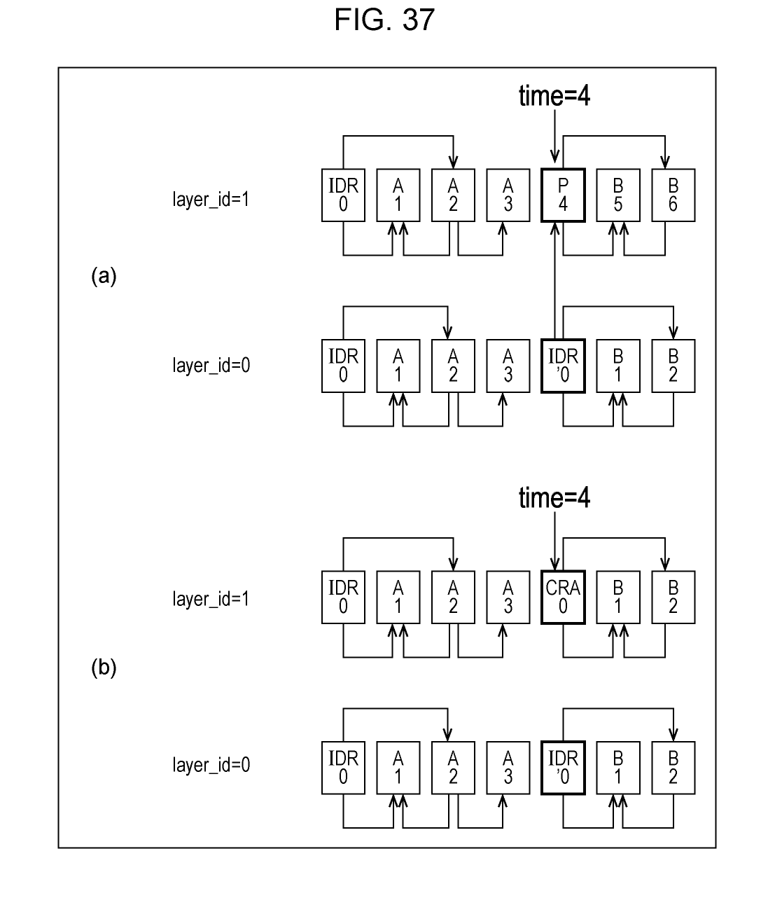

FIG. 37(a) is a diagram for describing the POC restriction. Letters of the alphabet in boxes indicate names of the pictures and numerals indicate the POCs (the same applies below). In FIG. 37(a), IDR0, A0, A1, A3, IDR′0, B0, and B1 are coded in the layer with the layer ID of 0. IDR0, A0, A1, A3, P4, B5, and B6 are coded in the layer with the layer ID of 1. In this example, at a time indicated by TIME=4, the picture with layer ID=0 is the IDR picture which is the RAP picture for which it is necessary to initialize the POC, as indicated by IDR′0. However, in the layer with the layer ID of 1, as indicated by P4, the picture is not the RAP picture for which it is necessary to initialize the POC. In this case, for the layer with the layer ID=0, the POC is initialized in the IDR′0 picture. However, for the layer with the layer ID of 1, the POC is not initialized. Therefore, after the time TIME=4, a different POC is derived in the picture of the same display time. For example, the pictures for which POC=1 and POC=2 as in B1 and B2 in the layer with the layer ID of 0 correspond to the pictures for which POC=5 and POC=6 as in B5 and B6 in the layer with the layer ID of 1. In the picture decoding section 11, except for the POC, it is difficult to execute management in such a manner that the pictures having different POCs have the same time since there is no information managing the display time.

### (First NAL Unit Type Restriction)

In the coded data structure according to the embodiment, the NAL unit header and the NAL unit data are set as a unit (NAL unit) and the NAL unit header includes a layer ID and an NAL unit type nal_unit_type defining a type of NAL unit in the coded data configured from one or more NAL units. The picture parameter set included in the NAL unit data includes the low-order bit maximum value MaxPicOrderCntLsb of the display time POC. The slice data included in the NAL unit data is configured to include the slice header and the slice data. In the slice data in the coded data including the low-order bit pic_order_cnt_lsb of the display time POC, all of the pictures in all of the layers having the same time in the slice data, that is, all of the pictures included in the same access unit, have the same display time POC.

In the coded data structure, since it is ensured that the NAL units of the pictures of the same time have the same display time (POC), whether a picture is the picture having the same time between different layers can be determined using the display time POC. Thus, it is possible to obtain the advantageous effect in which a decoded image having the same time can be referred to using the display time.

Time Management is assumed to be executed irrespective of the display time POC using the access unit as a unit. In the case of the image decoding device in which “the coded data structure in which there is the restriction that all of the layers of the same access unit have the same time in the included slice header even when the layers have different display times POC” is set as a target, it is necessary to clearly identify the delimitation of the access unit in order to identify the NAL picture of the same time. However, when the delimitation of the access unit is coded even in the case in which the access unit delimiter which is the delimitation of the access unit is coded arbitrarily and the access unit delimiter is forcibly coded, there is a possibility of the image coding device becoming complicated and the access unit delimiter being lost during transmission or the like. Therefore, it is difficult for the image decoding device to identify the delimitation of the access unit. Accordingly, it is difficult to determine that the plurality of pictures having different POCs are the pictures of the same time using the foregoing condition that the NAL units included in the same access unit correspond to the same time and to synchronize the pictures.

Hereinafter, first NAL unit type restriction and second NAL unit type restriction, which are specific methods in which different layers have the same display time POC, and a second POC high-order bit derivation section 2163B will be described.

In the coded data according to the embodiment, as the first NAL unit type restriction, there is provided restriction that all of the pictures in the all of the layers having the same time, that is, the pictures in all of the layers of the same access unit, indispensably include the same NAL unit type. For example, when a picture is the IDR_W_LP in regard to the layer ID of 0, a picture with the layer ID of 1 of the same time is also the IDR_W_LP picture.

In the coded data structure having the first NAL unit type restriction, the display time POC is initialized in the pictures of the same time in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing is managed using the time of the picture. Thus, it is possible to obtain the advantageous effect of facilitating retrieval and synchronization of the reference picture.

### (Second NAL Unit Type Restriction)

In the coded data according to the embodiment, as the second NAL unit type restriction, there is provided restriction that when the picture of the layer with the layer ID of 0 is the RAP picture which is the picture for which the POC is initialized (when the picture is the IDR picture or the BLA picture), the pictures of the all the layers having the same time, that is, the pictures of all the layers of the same access unit, indispensably include the NAL unit type of the RAP picture which is the picture for which the POC is initialized. For example, when the pictures with the layer ID of 0 are the IDR_W_LP, IDR_N_LP, LBA_W_LP, LBA_W_DLP, and LBA_N_LP pictures, the picture of layer 1 of the same time has to be one of IDR_W_LP, IDR_N_LP, LBA_W_LP, LBA_W_DLP, and LBA_N_LP. Such prediction is provided. In this case, when the picture with the layer ID of 0 is the RAP picture which is the picture for which the POC is initialized, for example, the picture is the IDR picture, the picture with the layer ID other than 0 at the same time has not to be the picture other than the RAP picture which is the picture for which the POC is initialized, for example, the CRA picture, the RASL picture, the RADL picture, or the TRAIL picture.

In the coded data structure having the foregoing second NAL unit type restriction, the display time POC is initialized in the pictures of the same time in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing is managed using the time of the picture. Thus, it is possible to obtain the advantageous effect of facilitating retrieval and synchronization of the reference picture.

### (Second POC High-Order Bit Derivation Section 2163B)

An image decoding device including the second POC high-order bit derivation section 2163B is configured such that the POC high-order bit derivation section 2163 in the POC information decoding section 216 is substituted with the second POC high-order bit derivation section 2163B to be described below and the above-described means is used as other means.

When the target picture is the picture with the layer ID of 0 and the NAL unit type of the target picture input from the NAL unit header decoding section 211 indicates the RAP picture for which it is necessary to initialize the POC (in the case of the BLA or the IDR), the second POC high-order bit derivation section 2163B initializes the POC high-order bit PicOrderCntMsb to 0 by the following expression.

PicOrderCntMsb=0

When the target picture is a picture with the layer ID other than 0 and the NAL unit type of the picture with the layer ID of 0 at the same time as the target picture indicates the RAP picture for which it is necessary to initialize the POC (in the case of the BLA or the IDR), the POC high-order bit PicOrderCntMsb is initialized to 0 by the following expression.

PicOrderCntMsb=0

An operation of the second POC high-order bit derivation section 2163B will be described with reference to FIG. 37(b). FIG. 37(b) is a diagram for describing POC initialization according to the embodiment. Letters of the alphabet in boxes indicate names of the pictures and numerals indicate the POCs (the same applies below). In FIG. 37(b), IDR0, A0, A1, A3, IDR′0, B0, and B1 are coded in the layer with the layer ID=0. IDR0, A0, A1, A3, CRA0, B1, and B2 are coded in the layer with the layer ID=1. In this example, when the picture CRA of layer 1 is decoded at the time TIME=4, the picture with the layer ID of 0 at the same time is the IDR picture (IDR′0 in FIG. 37(b)) indicating that the target picture input from the NAL unit header decoding section 211 is the RAP picture for which it is necessary to initialize the POC. Therefore, even in the case of the CRP picture which is not the RAP picture for which it is necessary to initialize the POC, the POC is initialized. Accordingly, the picture with the layer ID of 0 and the picture with the layer ID of 1 are the RAP pictures for which it is necessary to initialize the POC, the pictures of the same time have the same POC in a POC decoding section including the POC high-order bit derivation section 2163B, as shown that numerals in the drawing of FIG. 37(b) are the same as the layer with the layer ID of 0 and the picture with the layer ID of 1 of the same time, although not arranged.

In an image decoding device including the second POC high-order bit derivation section 2163B, the display time POC is initialized in the pictures of the same picture as the picture with the layer ID of 0 in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing is managed using the time of the picture. Thus, it is possible to obtain the advantageous effect of facilitating retrieval and synchronization of the reference picture.

### (POC Low-Order Bit Maximum Value Restriction)

POC low-order bit maximum value restriction in the coded data according to the embodiment will be described. As described in the POC high-order bit derivation section 2163, the POC is derived from the low-order bit of pic_order_cnt_lsb decoded from the slice header of the target picture and the POC high-order bit PicOrderCntMsb of the target picture derived from pic_order_cnt_lsb and the POC high-order bit PicOrderCntMsb of the already decoded picture. The derivation of the POC high-order bit PicOrderCntMsb is updated using the POC low-order bit maximum value MaxPicOrderCntLsb as a unit. Accordingly, in order to decode the pictures having the same POC between the plurality of layers, updating timings of the high-order bits of the POC are necessarily the same.

Accordingly, in the coded data according to the embodiment, as the POC low-order bit maximum value restriction, there is provided restriction that a parameter set (for example, the PPS) defining the parameters of the pictures in all of the layers having the same time has the same POC low-order bit maximum value MaxPicOrderCntLsb.

In the coded data structure having the foregoing POC low-order bit maximum value restriction, the display time POC (POC high-order bits) is updated at the same time in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing is managed using the time of the picture. Thus, it is possible to obtain the advantageous effect of facilitating retrieval and synchronization of the reference picture.

### (POC Low-Order Bit Restriction)

POC low-order bit restriction in the coded data according to the embodiment will be described. As described in the POC high-order bit derivation section 2163, the POC is derived using pic_order_cnt_lsb in the slice. Accordingly, in order to decode the pictures having the same POC between the plurality of layers, updating timings of the low-order bits of the POC are necessarily the same.

Accordingly, in the coded data according to the embodiment, as the POC low-order bit restriction, there is provided restriction that the slice headers of the pictures in all of the layers having the same time have the same POC low-order bit pic_order_cnt_lsb.

In the coded data structure having the foregoing POC low-order bit restriction, the low-order bits of the display time POC are the same in the pictures of the same time in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing can be managed using the time of the picture. Thus, it is possible to obtain the advantageous effect of facilitating retrieval and synchronization of the reference picture.

It is ensured that the NAL units having the same time have the same display time (POC).

### [Slice Type Decoding Section 217]

The slice type decoding section 217 decodes a slice type slice_type from a coded data. The slice type slice_type is one of an intra-slice I_SLICE, a uni-prediction slice P_SLICE, and a bi-prediction slice B_SLICE. The intra-slice I_SLICE is a slice that has only the intra-prediction which is an in-screen prediction and has only an intra-prediction mode as a prediction mode. The uni-prediction slice P_SLICE is a slice that has the inter-prediction in addition to the intra-prediction, but has only one reference picture list as a reference image. In the uni-prediction slice P_SLICE, one of the prediction list use flags predFlagLX can have the prediction parameter of 1 and the other thereof can have the prediction parameter of 0. In the uni-prediction slice P_SLICE, prediction parameters of 1 and 2 can be used as the inter-prediction flags inter_pred_idx in some cases. The bi-prediction slice B_SLICE is a slice that has inter-prediction of the bi-prediction in addition to the intra-prediction and the inter-prediction of the uni-prediction. A case in which only two reference picture lists are owned as the reference images is permitted. That is, both of the use flags predFlagLX can be 1 in some cases. A prediction parameter of 3 can be used as the inter-prediction flag inter_pred_idx in addition to the prediction parameters of 1 and 2.

A range of the slice type slice_type in a coded data is decided according to the NAL unit type. In a technology of the related art, when a target picture is a random access picture (RAP), that is, the target picture is the BLA, the IDR, or the CRA, the slice type slice_type is restricted to only an intra-slice I_SLICE in order that reproduction is possible without referring to pictures (for example, a picture earlier than the target picture before decoding) of a time other than the target picture. In this case, since the picture other than the target picture is not referred to, there is a problem that coding efficiency is low.

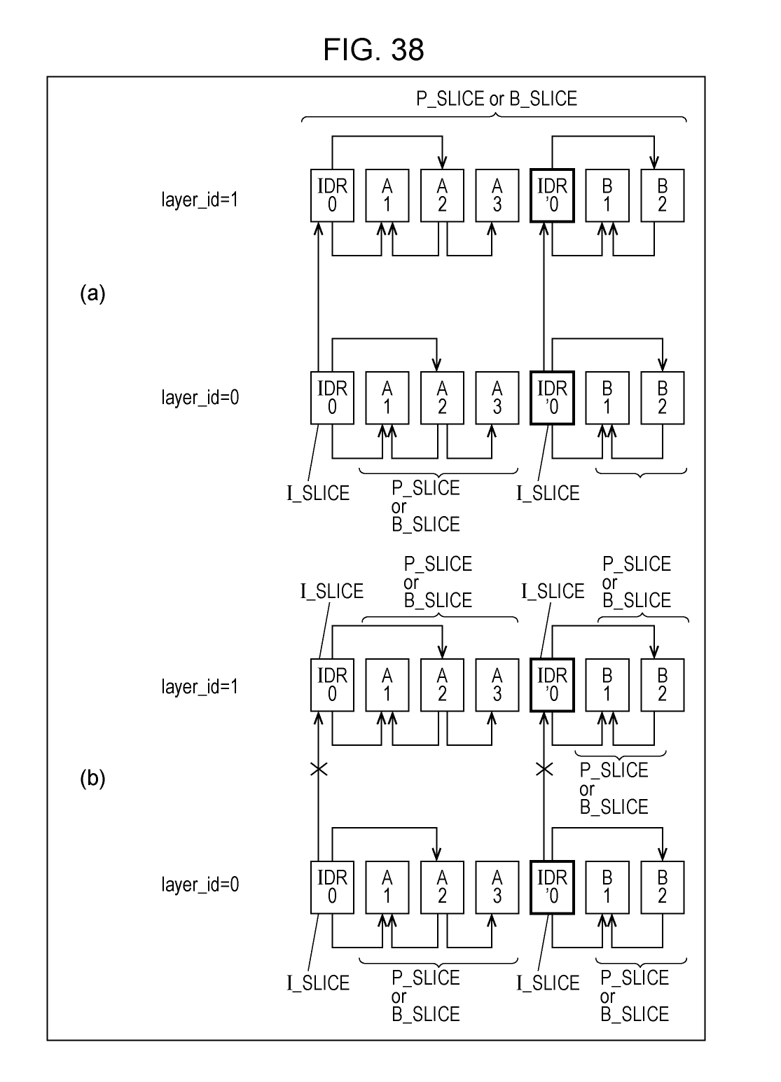

FIG. 38(b) is a diagram for describing a slice type in a RAP picture according to a technology of the related art. As described with reference to FIG. 22, for the RAP picture, other pictures are prohibited from being referred to. That is, since the intra-slice I_SLICE is restricted irrespective of whether the layer ID is 0, a picture with the layer ID of 0 may not be referred to for the picture with the layer ID other than 0.

### [Slice Type Restriction]

In order to resolve the foregoing problem, in the embodiment, the following restriction is imposed as coded data restriction. In first coded data restriction of the embodiment, when the layer is the base layer (when the layer ID is 0) and the NAL unit type is a random access picture (RAP picture), that is, the picture is the BLA, the IDR, or the CRA, the slice type slice_type is restricted to only the intra-slice I_SLICE. In the case of the layer ID other than 0, the slice type is not restricted. According to this restriction, in the case of the layer ID other than 0 even in the case in which the NAL unit type is a random access picture (RAP picture), P_SLICE and B_SLICE, which are slices using the inter-prediction, can be used in addition to the intra-slice I_SLICE. That is, the restriction on the random access picture (RAP picture) called the restriction on only the intra-slice I_SLICE is alleviated.

FIG. 38 is a diagram for describing the slice types in the RAP picture. Letters of the alphabet in boxes indicate names of the pictures and numerals indicate the POCs (the same applies below). FIG. 38(a) is a diagram for describing the slice type in the RAP picture according to the embodiment of the invention. As illustrated in FIG. 38, the IDR0, A1, A2, A3, IDR′0, B1, and B2 pictures are decoded in the layer with the layer ID of 0. The IDR0, A1, A2, A3, IDR′0, B1, and B2 pictures are decoded in the layer with the layer ID other than 0 (here, the layer ID=1). The RAP picture (here, the IDR picture) with the layer ID of 0 is restricted to the intra-slice I_SLICE. However, the RAP picture (here, the IDR picture) with the layer ID other than 0 is not restricted to the intra-slice I_SLICE and the picture with the layer ID of 0 can be referred to.

The fact that random access is possible even when the foregoing restriction is alleviated will be described again with reference to FIG. 38(a). As illustrated in FIG. 38, for the pictures (the pictures of IDR0 and IDR′0 in FIG. 38) in the layer with the layer ID other than 0 at a random access point, the reference picture is restricted to only the picture with the layer ID of 0. That is, the reference pictures of the picture at the random access point of layer 1 are only the pictures with the layer ID of 0 at the same random access point (the same display time) (the picture of IDR0 with the layer ID of 0 and the picture of IDR′0). Accordingly, when decoding starts from the random access point without decoding the picture earlier than the random access point, the pictures after the display time can be decoded from the random access point in both of the layer with the layer ID of 0 and the layer with the layer ID of 1. At this time, the slice in the layer with the layer ID of 1 has a slice type other than the intra-slice I_SLICE since the inter-prediction is executed using the picture with the layer ID of 0 as the reference picture.

In the alleviation of the foregoing restriction, a condition may be added in which the restriction is alleviated in the case of a specific scalable mask or a specific profile. Specifically, when a specific bit is valid in the scalable mask, for example, when the depth scalable or the view scalable is applied (when either scalable bit rises), the foregoing alleviation may be applied. When the scalable mask is a specific value, for example, when the depth scalable, the view scalable, or the depth scalable and the view scalable is applied, the foregoing alleviation may be applied. When the profile is a multi-view profile or a multi-view+depth profile, the foregoing alleviation may be applied.

In the coded data structure in which the range of the value of the slice type dependent on the layer ID is restricted, as described above, the slice type is restricted to the intra-slice I_SLICE when the NAL unit type is a random access picture (RAP picture) in the picture of the layer with the layer ID of 0. In the picture of the layer with the layer ID other than 0, the slice type is not restricted to the intra-slice I_SLICE even when the NAL unit type is a random access picture (RAP picture). Therefore, in the picture of the layer with the layer ID other than 0, the picture with the layer ID of 0 at the same display time can be used as the reference image even when the NAL unit type is a random access picture (RAP). Therefore, it is possible to obtain the advantageous effect of improving the coding efficiency.

In the coded data structure in which the range of the value of the slice type dependent on the layer ID is restricted, as described above, the picture with the layer ID other than 0 at the same display time can be set to a random access picture (RAP picture) without deterioration in the coding efficiency when the picture is a random access picture with the layer ID of 0. Therefore, it is possible to obtain the advantageous effect of facilitating the random access. In the structure in which the POC is initialized in the case of the NAL unit type of the IDR or the BLA, in order to equalize the initialization timings of the POCs between different layers, it is necessary to set the IDR or the BLA as the picture even in the layer with the layer ID other than 0 when the picture is the IDR or the BLA with the layer ID of 0. However, even in this case, the NAL unit type can remain in the IDR or the BLA for which the POC is initialized in the picture of the layer with the layer ID other than 0 and the picture with the layer ID of 0 at the same display time can be used as the reference image. Therefore, it is possible to obtain the advantageous effect of improving the coding efficiency.

### [Reference Picture Information Decoding Section 218]

The reference picture information decoding section 218 is a constituent element of the header decoding section 10 and decodes information regarding the reference picture from the coded data #1. The information regarding the reference picture includes reference picture set information (hereinafter referred to as RPS information) and reference picture list correction information (hereinafter referred to as RPL correction information).

A reference picture set (RPS) indicates a set of target pictures or pictures which are likely to be used as reference pictures in the pictures subsequent to the target picture in the decoding order. The RPS information is information decoded from the SPS or the slice header and is information used to derive the reference picture set at the time of decoding of each picture.

A reference picture list (RPL) is a candidate list of the reference picture to be referred to when motion compensation prediction is executed. Two or more reference picture lists may be present. In the embodiment, an L0 reference picture list (L0 reference list) and an L1 reference picture list (L1 reference list) are assumed to be used. The RPL correction information is information which is decoded from the SPS or the slice header and indicates an order of the reference pictures in the reference picture list.

In the motion compensation prediction, a reference picture recorded at the position of a reference image index (refIdx) on the reference image list is used. For example, when the value of refIdx is 0, the position of 0 of the reference image list, that is, the beginning reference picture of the reference image list, is used for the motion compensation prediction.

Since a decoding process for the RPS information and the RPL correction information by the reference picture information decoding section 218 is an important process in the embodiment, the decoding process will be described in detail later.

Here, examples of the reference picture set and the reference picture lists will be described with reference to FIG. 40. FIG. 40(a) shows arrangement of pictures forming a moving image in a display order. A numeral in the drawing indicates the POC corresponding to each picture. As will be described below in the decoded picture buffer, the POCs are allocated to the pictures in an ascending order of an output order. A picture with the POC of 9 indicated as “curr” is a current decoding target picture.

FIG. 40(b) shows an example of the RPS information applied to the target picture. The reference picture set (current RPS) in the target picture is derived based on the RPS information. The RPS information includes long-term RPS information and short-term RPS information. The POC of the picture included in the current RPS is directly shown as the long-term RPS information. In the example illustrated in FIG. 40(b), the long-term RPS information indicates that the picture of POC=1 is included in the current RPS. In the short-term RPS information, the picture included in the current RPS is recorded with a difference from the POC of the target picture. The short-term RPS information shown as “Before, dPOC=1” in the drawing indicates that the picture of the POC smaller by 1 than the POC of the target picture is included in the current RPS. Likewise, “Before, dPOC=4” in the drawing indicates that the picture of the POC smaller by 4 is included in the current RPS and “After, dPOC=1” indicates that the picture of the POC greater by 1 is included in the current RPS. “Before” indicates the picture in the front of the target picture, that is, the picture earlier than the target picture in the display order. Further, “after” indicates the picture in the rear of the target picture, that is, the picture later than the target picture in the display order.

FIG. 40(c) shows an example of the current RPS derived at the time of application of the RPS information exemplified in FIG. 40(b) when the POC of the target picture is 0. The picture of POC=1 shown by the long-term RPS information is included. The picture having the POC smaller by 1 than the target picture (POC=9) shown by the short-term RPS information, that is, the picture of POC=8, is included. Likewise, the pictures of POC=5 and POC=10 shown by the short-term RPS information are included.

FIGS. 40(d) and 40(e) show examples of the reference picture lists generated from the reference picture included in the current RPS. An index (reference picture index) is given to each component of the reference picture list (which is indicated by idx in the drawing). FIG. 40(d) shows the example of the L0 reference list. The reference pictures included in the current RPS having the POCs of 5, 8, 10, and 1 are included in this order in the L0 reference list. FIG. 40(e) shows the example of the L1 reference list. The reference pictures included in the current RPS having the POCs of 10, 5, and 8 are included in this order in the L1 reference list. As shown in the example of the L1 reference list, it is not necessary to include all of the reference pictures (referable pictures) included in the current RPS in the reference picture list. However, the number of components of the reference picture list is the number of reference pictures included in the current RPS at most. In other words, the length of the reference picture list is equal to or less than the number of referable pictures as the current pictures.

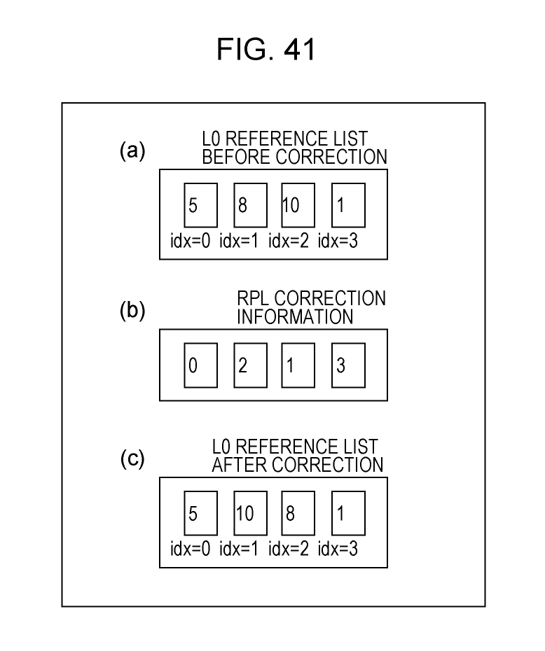

Next, an example of the reference picture list correction will be described with reference to FIG. 41. FIG. 41 exemplifies a corrected reference picture list (FIG. 41(c)) obtained when RPL correction information (FIG. 41(b)) is applied to a specific reference picture list (FIG. 41(a)). The L0 reference list before correction shown in FIG. 41(a) is the same as the L0 reference list described in FIG. 40(d). The RPL correction information shown in FIG. 41(b) is a list in which the values of reference picture indexes are components, and values 0, 2, 1, and 3 are stored in order from the beginning. The RPL correction information indicating that the reference pictures indicated by the reference picture indexes 0, 2, 1, and 3 included in the reference list before correction are set as the reference pictures of the L0 reference list after correction in this order. FIG. 41(c) shows the L0 reference list after correction and the pictures of the POCs of 5, 10, 8, and 1 are included in this order.

### (Moving Image Decoding Process Order)

An order in which the image decoding device 1 generates decoded image #2 from the input coded data #1 is as follows.

(S11) The header decoding section 10 decodes the VPS and the SPS from the coded data #1.

(S12) The header decoding section 10 decodes the PPS from the coded data #1.

(S13) The pictures indicated by the coded data #1 are sequentially set as target pictures. Processes of S14 to S17 are executed on each target picture.

(S14) The header decoding section 10 decodes the slice header of each slice included in the target picture from the coded data #1. The reference picture information decoding section 218 included in the header decoding section 10 decodes the RPS information from the slice header and outputs the RPS information to the reference picture set setting section 131 included in the reference picture management section 13. The reference picture information decoding section 218 decodes the RPL correction information from the slice header and outputs the RPL correction information to the reference picture list derivation section 132.

(S15) The reference picture set setting section 131 generates a reference picture set RPS to be applied to the target picture based on the RPS information and a combination of the POC of a locally decoded image recorded in the decoded picture buffer 12 and positional information on a memory and outputs the reference picture set RPS to the reference picture list derivation section 132.

(S16) The reference picture list derivation section 132 generates a reference picture list RPL based on the reference picture sets RPS and the RPL correction information and outputs the reference picture list RPL to the picture decoding section 11.

(S17) The picture decoding section 11 generates a local decoded mage of the target picture based on the slice data of each slice included in the target picture and the reference picture list RPL from the coded data #1 and records the locally decoded image in association with the POC of the target picture in the decoded picture buffer. The locally decoded image recorded in the decoded picture buffer is output as decoded image #2 to the outside at an appropriate timing decided based on the POC.

### [Decoded Picture Buffer 12]

In the decoded picture buffer 12, the locally decoded image of each picture decoded by the picture decoding section is recorded in association with the layer ID and the Picture Order Count (POC: picture order information and a display time) of the picture. The decoded picture buffer 12 decides an output target POC at a predetermined output timing. Thereafter, the locally decoded image corresponding to the POC is output as one of the pictures forming the decoded image #2 to the outside.

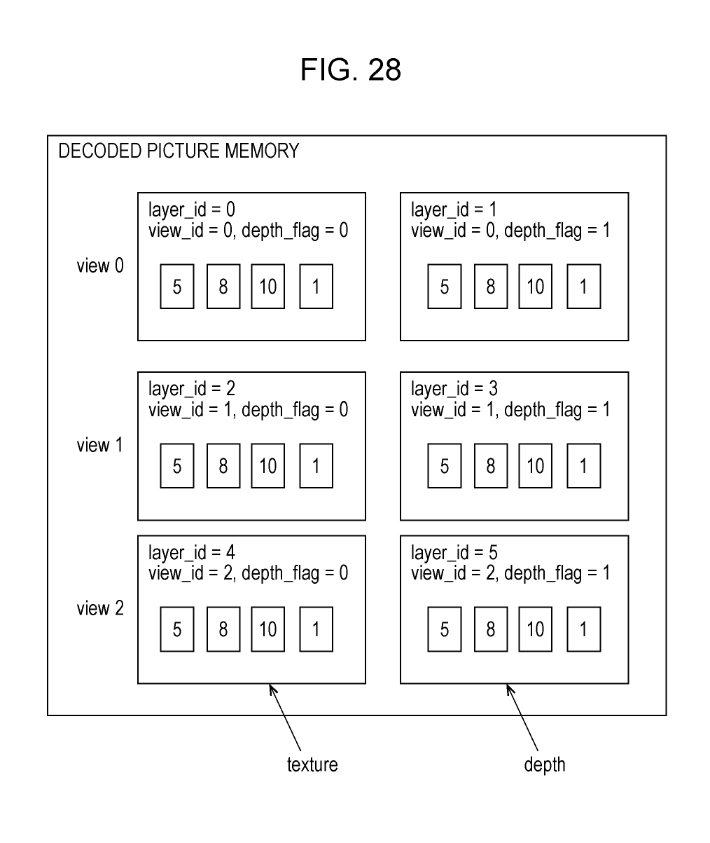

FIG. 28 is a conceptual diagram illustrating the configuration of a decoding picture memory. Boxes denoted by numerals in the drawing indicate the locally decoded images. The numeral indicates the POC. As illustrated in FIG. 28, the locally decoded images in the plurality of layers are recorded so that the locally decoded image is associated with the layer ID and the POC. The view ID view_id and the depth flag depth_flag corresponding to the layer ID are also recorded in association with the locally decoded image.

### [Reference Picture Management Section 13]

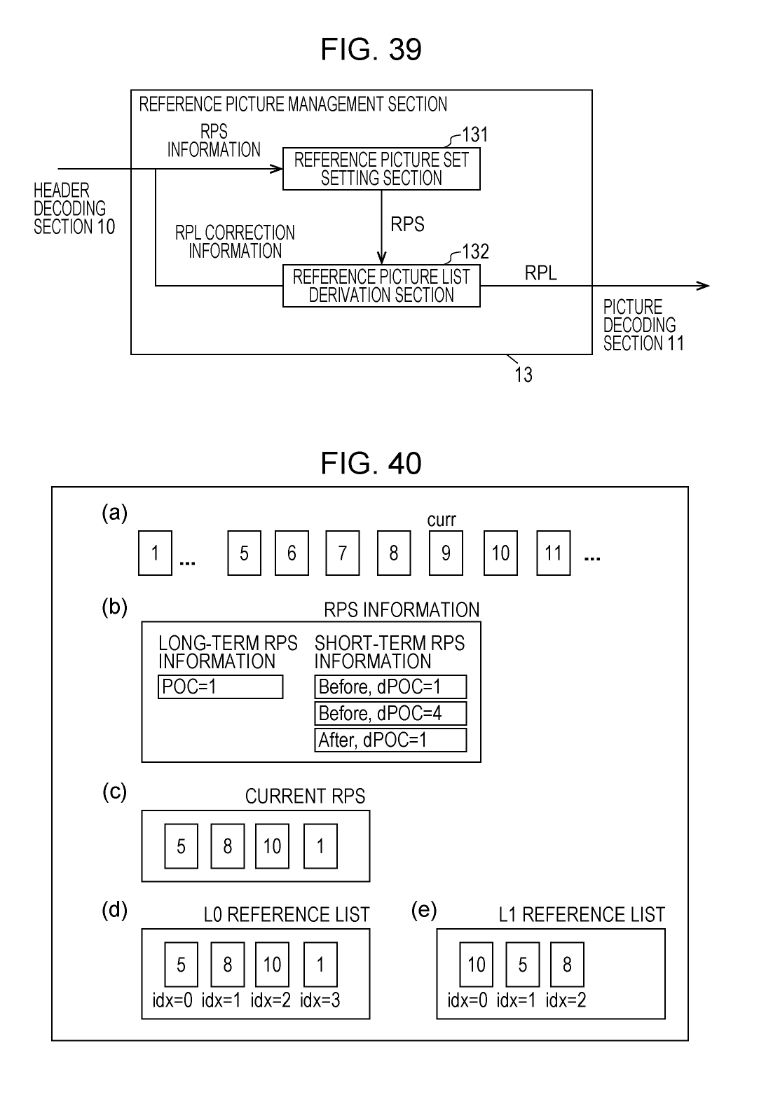

FIG. 39 is a schematic diagram illustrating the configuration of the reference picture management section 13 according to the embodiment. The reference picture management section 13 is configured to include a reference picture set setting section 131 and a reference picture list derivation section 132.

The reference picture set setting section 131 constructs the reference picture set RPS based on the RPS information decoded by the reference picture information decoding section 218, and the locally decoded image, the layer ID, and the information regarding the POC recorded in the decoded picture buffer 12 and outputs the reference picture set RPS to the reference picture list derivation section 132. The details of the reference picture set setting section 131 will be described below.

The reference picture list derivation section 132 generates the reference picture list RPL based on the RPL correction information decoded by the reference picture information decoding section 218 and the reference picture set RPS input from the reference picture set setting section 131 and outputs the reference picture list RPL to the picture decoding section 11. The details of the reference picture list derivation section 132 will be described below.

### (Details of Reference Picture Information Decoding Process)

The details of a process of decoding the RPS information and the RPL correction information in the process of S14 in the decoding order will be described.

### (RPS Information Decoding Process)

The RPS information is information that is decoded from the SPS or the slice header to construct the reference picture set. The RPS information includes the following information:

1. SPS short-term RPS information: short-term reference picture set information included in the SPS;

2. SPS long-term RP information: long-term reference picture information included in the SPS;

3. SH short-term RPS information: short-term reference picture set information included in the slice header; and

4. SH long-term RP information: long-term reference picture information included in the slice header.

### (1. SPS Short-Term RPS Information)

The SPS short-term information includes information regarding a plurality of short-term reference picture sets used from each picture referring to the SPS. The short-term reference picture set is a set of pictures which can be reference pictures (short-term reference pictures) designated by relative positions (for example, POC differences from a target picture) with respect to the target picture.

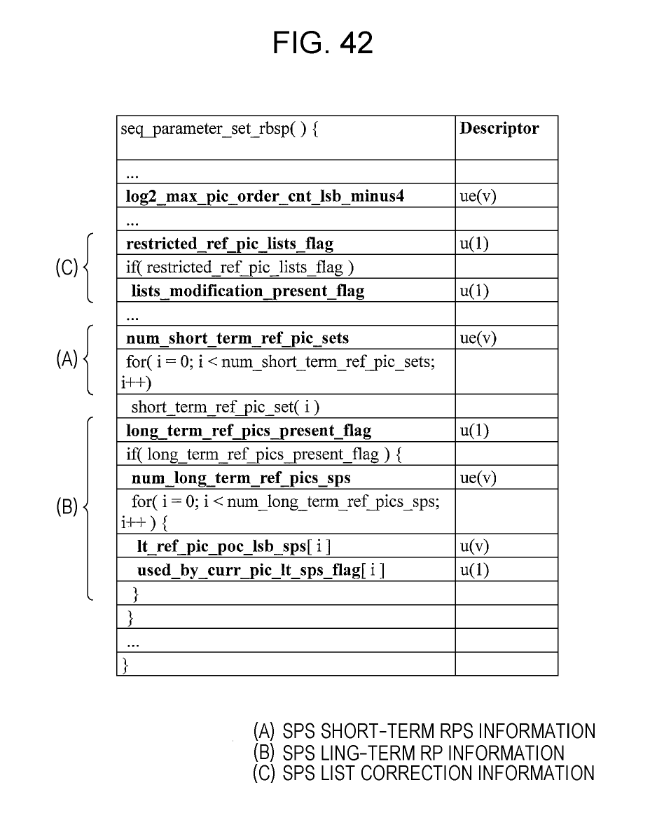

The decoding of the SPS short-term RPS information will be described with reference to FIG. 42. FIG. 42 exemplifies a part of an SPS syntax table used at the time of SPS decoding by the header decoding section 10 and the reference picture information decoding section 218. A part (A) of FIG. 42 corresponds to the SPS short-term RPS information. The SPS short-term RPS information includes the number of short-term reference picture sets (num_short_term_ref_pic_sets) included in the SPS and information (short_term_ref_pic_set(i)) of each short-term reference picture set.

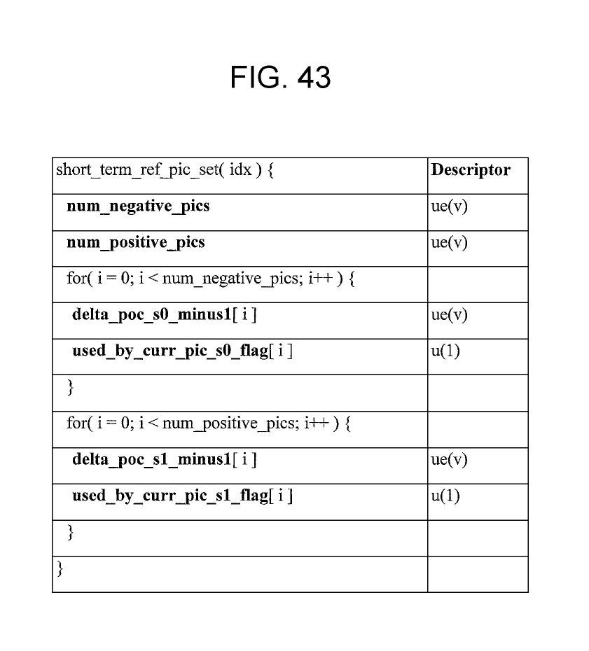

The short-term reference picture set information will be described with reference to FIG. 43. FIG. 43 exemplifies a syntax table of the short-term reference picture set used at the time of SPS decoding and at the time of slice header decoding in the header decoding section 10 and the reference picture information decoding section 218.

The short-term reference picture set information includes the number of short-term reference pictures (num_negative_pics) earlier than the target picture in the display order and the number of short-term reference pictures (num_positive_pics) later than the target picture in the display order. Hereinafter, the short-term reference picture earlier than the target picture in the display order is referred to as front short-term reference picture and the short-term reference picture later than the target picture in the display order is referred to as a rear short-term reference picture.

The short-term reference picture set information includes an absolute value (delta_poc_s0_minus1[i]) of the POC difference from the target picture and presence or absence of a possibility (used_by_curr_pic_s0_flag[i]) of a picture being usable as a reference picture of the target picture in regard to each front short-term reference picture. The short-term reference picture set information further includes an absolute value (delta_poc_s1_minus1[i]) of the POC difference from the target picture and presence or absence of a possibility (used_by_curr_pic_s1_flag[i]) of a picture being usable as a reference picture of the target picture in regard to each rear short-term reference picture.

### (2. SPS Long-Term RP Information)

The SPS long-term RP information includes information regarding the plurality of long-term reference pictures which can be used from each picture referring the SPS. The long-term picture refers to a picture designated by the absolute position (for example, the POC) in the sequence.

Referring back to FIG. 42, the decoding of the SPS long-term RP information will be described. A part (B) of FIG. 42 corresponds to the SPS long-term RP information. The SPS long-term RP information includes information (long_term_ref_pics_present_flag) indicating presence or absence of the long-term reference picture transmitted with the SPS, the number of long-term reference pictures (num_long_term_ref_pics_sps) included in the SPS, and information regarding each long-term reference picture. The information regarding the long-term reference picture includes the POC (lt_ref_pic_poc_lsb_sps[i]) of the reference picture and presence or absence of a possibility (used_by_curr_pic_lt_sps flag[i]) of a picture being usable as the reference picture of the target picture.

The POC of the reference picture may be the value of the POC associated with the reference picture or the Least Significant Bit (LSB) of the POC, that is, the value of a remainder obtained by dividing the POC by a given number of a power of 2, may also be used.

### (3. SH Short-Term RPS Information)

The SH short-term RPS information includes information regarding a single short-term reference picture set which can be used as a picture referring to the slice header.

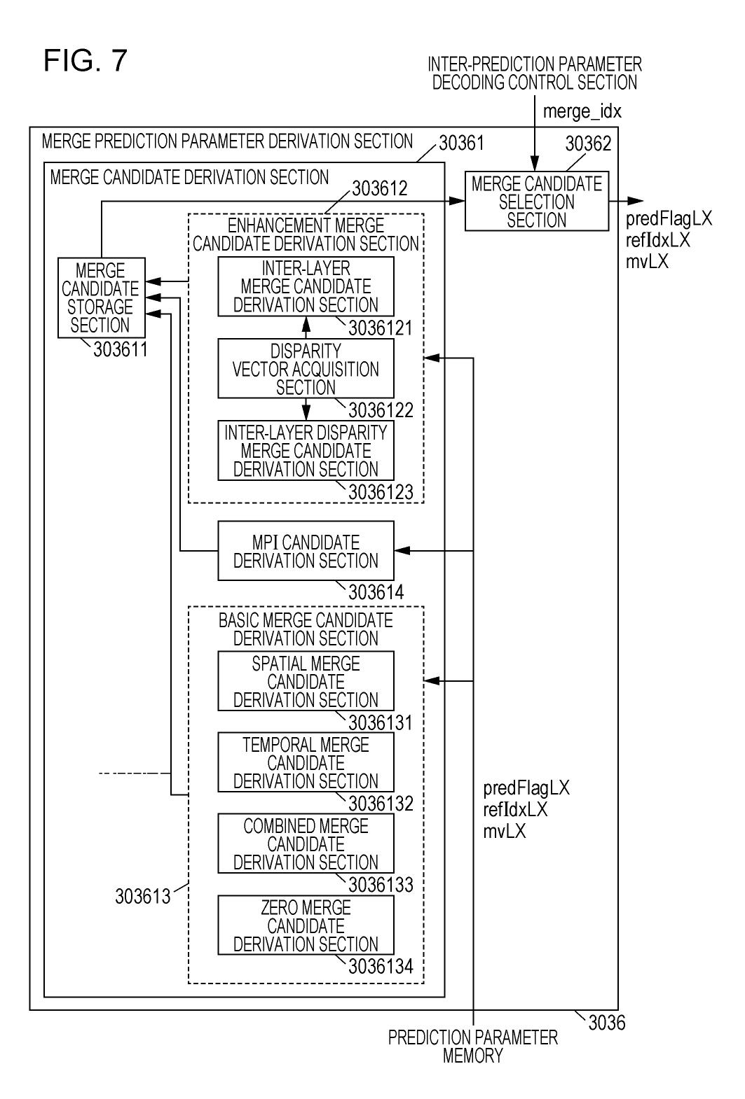

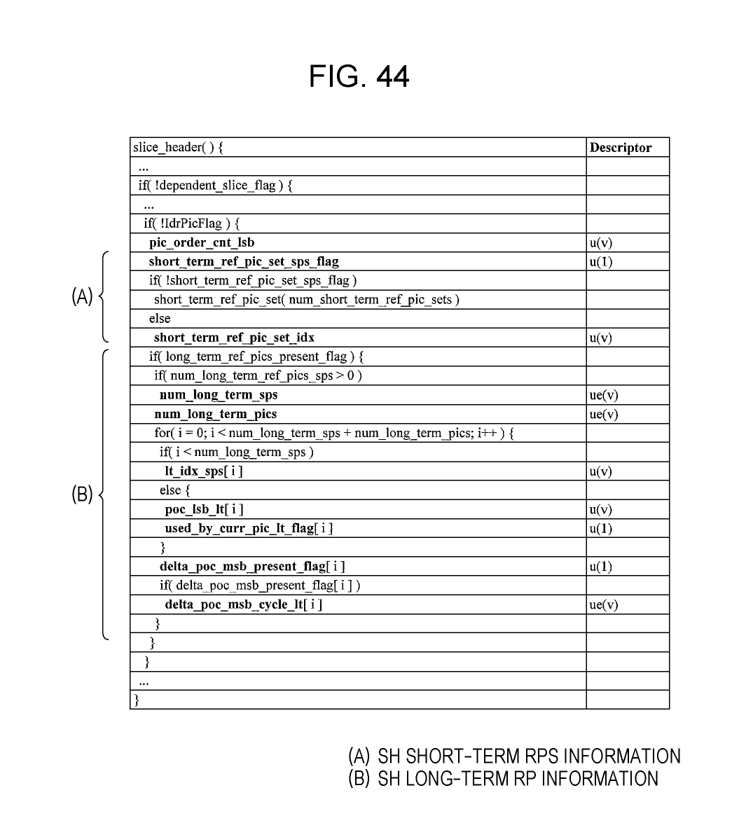

The decoding of the SPS short-term RPS information will be described with reference to FIG. 44. FIG. 44 exemplifies a part of a slice header syntax table used at the time of the slice header decoding in the header decoding section 10 and the reference picture information decoding section 218. A part (A) of FIG. 44 corresponds to the SH short-term RPS information. The SH short-term RPS information includes a flag (short_term_ref_pic_set_sps_flag) indicating whether the short-term reference picture set is selected with the SPS from among the decoded short-term reference picture sets and whether the short-term reference picture set is explicitly included in the slice header. When the short-term reference picture set is selected with the SPS with the decoded short-term reference picture sets, an identifier (short_term_ref_pic_set_idx) selecting one of the decoded short-term reference picture sets is included. When the short-term reference picture set is explicitly included in the slice header, the information corresponding to the syntax table (short_term_ref_pic_set(idx)) described with reference to FIG. 7 is included in the SPS short-term RPS information.

### (4. SH Long-Term RP Information)

The SH long-term RP information includes information regarding the long-term reference picture which can be used from the picture referring to the slice header.

Referring back to FIG. 44, the decoding of the SH long-term RP information will be described. A part (B) of FIG. 44 corresponds to the SH long-term RP information. The SH long-term RP information is included in the slice header only when the long-term reference picture can be used (long_term_ref_pic_present_flag) with the target picture. When one or more long-term reference pictures are decoded with the SPS (num_long_term_ref_pics_sps>0), the number of reference pictures (num_long_term_sps) which can be referred with the target picture among the long-term reference pictures decoded with the SPS is included in the SH long-term RP information. The number of long-term reference pictures (num_long_term_pics) explicitly transmitted with the slice header is included in the SH long-term RP information. Further, information (lt_idx_sps[i]) used to select the long-term reference pictures of the number of the foregoing num_long_term_sps from the long-term reference pictures transmitted with the SPS is included in the SH long-term RP information. As the information regarding the long-term reference picture explicitly included in the slice header, the POC (poc_lsb_lt[i]) of the reference picture and presence or absence of a possibility (used_by_curr_pic_lt_flag[i]) of a picture being usable as the reference picture of the target picture are included by the number of the foregoing num_long_term_pics.

### (RPL Correction Information Decoding Process)

The RPL correction information is information that is decoded from the SPS or the slice header to construct the reference picture list RPL. The RPL correction information includes SPS list correction information and SH list correction information.

### (SPS List Correction Information)

The SPS list correction information is information included in the SPS and information related to restriction of reference picture list correction. Referring back to FIG. 42, the SPS list correction information will be described. A part (C) of FIG. 42 corresponds to the SPS list correction information. The SPS list correction information includes a flag (restricted_ref_pic_lists_flag) indicating whether the reference picture list is common to the slice before the slice is included in the picture and a flag (lists_modification_present_flag) indicating whether information regarding list modification in the slice header is present.

### (SH List Correction Information)

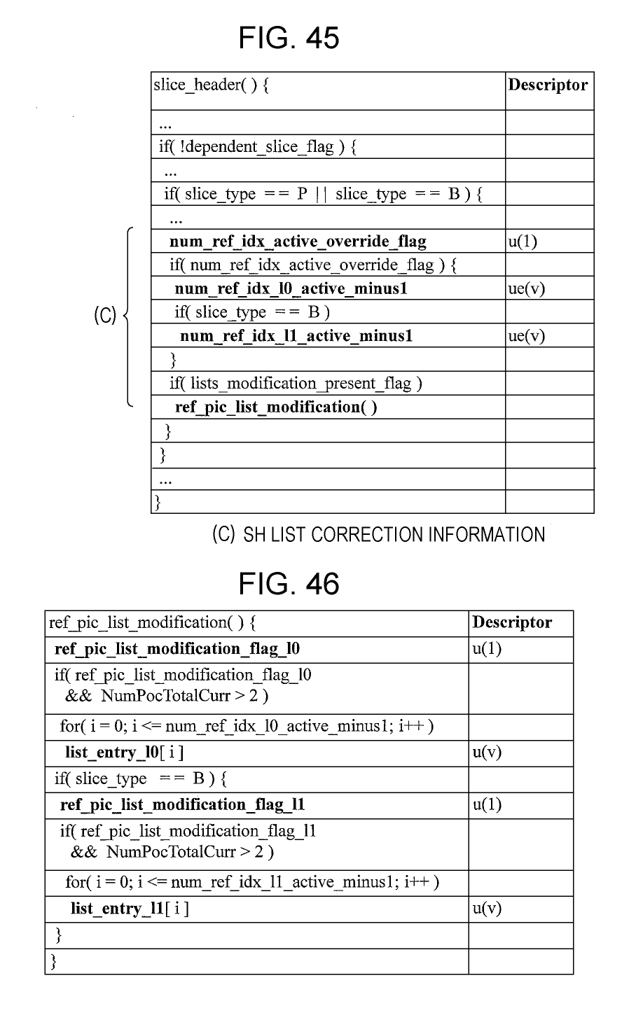

The SH list correction information is information included in the slice header and includes update information regarding the length (reference list length) of the reference picture list applied to the target picture and modification information (reference list modification information) regarding the reference picture list. The SH list correction information will be described with reference to FIG. 45. FIG. 45 exemplifies a part of a slice header syntax table used at the time of the slice header decoding in the header decoding section 10 and the reference picture information decoding section 218. A part (C) of FIG. 45 corresponds to the SH list correction information.

A flag (num_ref_idx_active_override_flag) indicating whether the list length is updated is included as the reference list length update information. Further, information (num_ref_idx_l0active_minus1) indicating the reference list length after change of the L0 reference list and information (num_ref_idx_l1active_minus1) indicating the reference list length after change of the L1 reference list are included.

Information included in the slice header as the reference list modification information will be described with reference to FIG. 46. FIG. 46 exemplifies a syntax table of the reference list modification information used at the time of the slice header decoding in the header decoding section 10 and the reference picture information decoding section 218.

The reference list modification information includes L0 reference list modification presence or absence flag (ref_pic_list_modification_flag_{—}10). When the value of the flag is greater than 1 (when the L0 reference list is modified) and NumPocTotalCurr is greater than 2, an L0 reference list modification order (list_entry_{—}10[i]) is included in the reference list modification information. Here, NumPocTotalCurr is a variable indicating the number of reference pictures which can be used in a current picture. Accordingly, when the L0 reference list is modified and only when the number of reference pictures which can be used in the current picture is greater than 2, the L0 reference list modification order is included in the slice header.

Likewise, when the reference picture is the B slice, that is, the L1 reference list can be used in the target picture, L1 reference list modification presence or absence flag (ref_pic_list_modification_flag_l1) is included in the reference list modification information. When the value of the flag is greater than 1 and NumPocTotalCurr is greater than 2, an L1 reference list modification order (list_entry_l1[i]) is included in the reference list modification information. In other words, when the L1 reference list is modified and only when the number of reference pictures which can be used in the current picture is greater than 2, the L1 reference list modification order is included in the slice header.

### (Details of Reference Picture Set Derivation Process)

The details of the process of S15 in the above-described moving-image decoding order, that is, the reference picture set derivation process executed by the reference picture set setting section, will be described.

As described above, the reference picture set setting section 131 generates the reference picture set RPS used to decode the target picture based on the RPS information and the information recorded on the decoded picture buffer 12.

The reference picture set RPS is a set of pictures (referable pictures) which can be used as reference images at the time of decoding in a target picture or a picture subsequent to the target picture in the decoding order. The reference picture set can be divided into two sub-sets according to the kinds of referable pictures as follows:
a current picture referable list ListCurr: a list of referable pictures in the target picture among the pictures on the decoded picture buffer; and
a subsequent picture referable list ListFoll: a list of pictures which are not referred in the target picture and which are recorded on the decoded picture buffer and can be referred to with the subsequent picture in the decoding order in the target picture.

The number of pictures included in the current picture referable list is referred to as the number of current picture referable pictures NumCurrList. Further, NumPocTotalCurr described above with reference to FIG. 46 is the same as NumCurrList.

The current picture referable list is configured to include three partial lists:
a current picture long-term referable list ListLtCurr: a current picture referable picture designated by the SPS long-term RP information or the SH long-term RP information;
a current picture short-term front referable list ListStCurrBefore: a current picture referable picture designated by the SPS short-term RPS information or the SH short-term RPS information and a picture earlier than the target picture in the display order; and
a current picture short-term rear referable list ListStCurrAfter: a current picture referable picture designated by the SPS short-term RPS information or the SH short-term RPS information and a picture earlier than the target picture in the display order.

The subsequent picture referable list is configured to include two partial lists:
a subsequent picture long-term referable list ListLtFoll: a subsequent picture referable picture designated by the SPS long-term RP information or the SH long-term RP information; and
a subsequent picture short-term referable list ListStFoll: a current picture referable picture designated by the SPS short-term RPS information or the SH short-term RPS information.

When the NAL unit type is a picture other than the IDR, the reference picture set setting section 131 generates the reference picture set RPS, that is, the current picture short-term front referable list ListStCurrBefore, the current picture short-term rear referable list ListStCurrAfter, the current picture long-term referable list ListLtCurr, the subsequent picture short-term referable list ListStFoll, and the subsequent picture long-term referable list ListLtFoll in the following order. Further, the variable NumPocTotalCurr indicating the number of current picture referable pictures is derived. Each of the foregoing referable lists is assumed to be set by default before the following process starts. When the NAL unit type is the IDR, the reference picture set setting section 131 derives the reference picture set RPS as a default.

(S201) A single short-term reference picture set used to decode the target picture is specified based on the SPS short-term RPS information and the SH short-term RPS information.

Specifically, when the value of short_term_ref_pic_set_sps included in the SH short-term RPS information is 0, the short-term RPS explicitly transmitted with the slice header included in the SH short-term RPS information is selected. Conversely, in the other cases (when the value of short_term_ref_pic_set_sps is 1), the short-term RPS indicated by short_term_ref_pic_set_idx included in the SH short-term RPS information is selected among the plurality of short-term RPS included in the SPS short-term RPS information.

(S202) The value of the POC of each reference picture included in the selected short-term RPS is derived, the position of the locally decoded image recorded in association with the value of the POC on the decoded picture buffer 12 is detected, and the position of the locally decoded image is derived as a recording position of the reference picture on the decoded picture buffer.

When the reference picture is the front short-term reference picture, the value of the POC of the reference picture is derived by subtracting a value of “delta_poc_s0_minus1[i]+1” from the value of the POC of the target picture. Conversely, when the reference picture is the rear short-term reference picture, the value of the POC of the reference picture is derived by adding a value of “delta_poc_s1_minus1[i]+1” to the value of the POC of the target picture.

(S203) The reference pictures are confirmed in the order in which the front reference pictures included in the short-term RPS are transmitted. When the value of the associated used_by_curr_pic_s0_flag[i] is 1, the front reference picture is added to the current picture short-term front referable list ListStCurrBefore. In the other cases (when the value of used_by_curr_pic_s0_flag[i] is 0), the front reference picture is added to the subsequent picture short-term referable list ListStFoll.

(S204) The reference pictures are confirmed in the order in which the rear reference pictures included in the short-term RPS are transmitted. When the value of the associated used_by_curr_pic_s1_flag[i] is 1, the rear reference picture is added to the current picture short-term rear referable list ListStCurrAfter. In the other case (when the value of used_by_curr_pic_s1_flag[i] is 0), the front reference picture is added to the subsequent picture short-term referable list ListStFoll.

(S205) The long-term reference picture set used to decode the target picture is specified based on the SPS long-term RP information and the SH long-term RP information. Specifically, the reference pictures of the number of num_long_term_sps are selected among the reference pictures which are included in the SPS long-term RP information and have the same layer ID as the target picture and are added in order to the long-term reference picture set. The selected reference pictures are reference pictures indicated by lt_idx_sps[i]. Next, the reference pictures of the number of num_long_term_pics, that is, the reference pictures included in the SH long-term RP information, are added in order to the long-term reference picture set. When the layer ID of the target picture is a value other than 0, the reference pictures having the same POC as the POC of the target picture are further added to the long-term reference picture set among the pictures having the different layer ID from the target picture, particularly, the reference pictures having the same layer ID as the dependent layer ref_layer_id of the target picture.

(S206) The value of the POC of each reference picture included in the long-term reference picture set is derived, the position of the locally decoded image recorded in association with the value of the POC among the reference pictures having the same layer ID as the target picture on the decoded picture buffer 12 is detected, and the position of the locally decoded image is derived as a recording position of the reference picture on the decoded picture buffer. For the reference pictures having the different layer ID from the target picture, the position of the locally decoded image recorded in association with the layer ID designated by the dependent layer ref_layer_id and the POC of the target picture is detected, and the position of the locally decoded image is derived as a recording position of the reference picture on the decoded picture buffer.

For the reference picture having the same layer ID as the target picture, the POC of the long-term reference picture is directly derived from the value of poc_{—}1st_lt[i] or lt_ref_pic_poc_lsb_sps[i] decoded in the association manner. For the reference picture having the different layer ID from the target picture, the POC of the target picture is set.

(S207) The reference pictures included in the long-term reference picture set are confirmed in order. When the value of the associated used_by_curr_pic_lt_flag[i] or used_by_curr_pic_lt_sps_flag[i] is 1, the long-term reference picture is added to the current picture long-term referable list ListLtCurr. In the other cases (when the value of used_by_curr_pic_lt_flag[i] or used_by_curr_pic_lt_sps_flag[i] is 0), the long-term reference picture is added to the subsequent picture long-term referable list ListLtFoll.

(S208) The value of the variable NumPocTotalCurr is set as a sum of the reference picture which can be referred to from the current picture. That is, the value of the variable NumPocTotalCurr is set as a sum of the number of components of three lists, the current picture short-term front referable list ListStCurrBefore, the current picture short-term rear referable list ListStCurrAfter, and the current picture long-term referable list ListLtCurr.

### (Details of Reference Picture List Construction Process)

The details of the process of S16 in the decoding order, that is, the reference picture list construction process, will be described with reference to FIG. 1. As described above, the reference picture list derivation section 132 generates the reference picture list RPL based on the reference picture set RPS and the RPL correction information.

The reference picture lists are configured to include the two lists, the L0 reference list and the L1 reference list. First, a construction order of the L0 reference list will be described. The L0 reference list is constructed in the following order of S301 to S307.

(S301) A temporary L0 reference list is generated and initialized as a default list.

(S302) The reference pictures included in the current picture short-term front referable list are added in order to the temporary L0 reference list.

(S303) The reference pictures included in the current picture short-term rear referable list are added in order to the temporary L0 reference list.

(S304) The reference pictures included in the current picture long-term referable list are added in order to the temporary L0 reference list.

(S305) When the reference picture list is corrected (when the value of lists_modification_present_flag included in the RPL correction information is 1), the following processes of S306a and S306b are executed. Otherwise (when the value of lists_modification_present_flag is 0), the process of S307 is executed.

(S306a) When the correction of the L0 reference picture is valid (the value of ref_pic_list_modification_flag_l0 included in the RPL correction information is 1) and the number of current picture referable pictures NumCurrList is 2), S306b is executed. In the other cases, S306c is executed.

(S306b) The value of the list modification order list_entry_l0[i] included in the RPL correction information is set by the following expression and S306c is subsequently executed.

list_entry_{—}0[0]=1

list_entry_{—}0[1]=0

(S306c) The components of the temporary L0 reference list are rearranged based on the value of the reference list modification order list_entry_l0[i] and the temporary L0 reference list is set as the L0 reference list. A component RefPicList0[rIdx] of the L0 reference picture list corresponding to the reference index rIdx is derived by the following expression. Here, RefListTemp0[i] indicates an i-th component of the temporary L0 reference list.

RefPicList0[rIdx]=RefPicListTemp0[list_entry_l0[rIdx]]

By the foregoing expression, the reference picture recorded at the position of the value in the temporary L0 reference list is stored as the reference picture at the position of rIdx of the L0 reference list with reference to the value recorded at the position indicated by the reference picture index rIdx in the reference list modification order list_entry_l0[i].

(S307) The temporary L0 reference list is set as the L0 reference list.

Next, the L1 reference list is constructed. The L1 reference list can also be constructed in the same order as that of the L0 reference list. In the construction order (S301 to S307) of the L0 reference list, the L0 reference picture, the L0 reference list, the temporary L0 reference list, and list_entry_l0 may be substituted with the L1 reference picture, the L1 reference list, a temporary L1 reference list, and list_entry_l1.

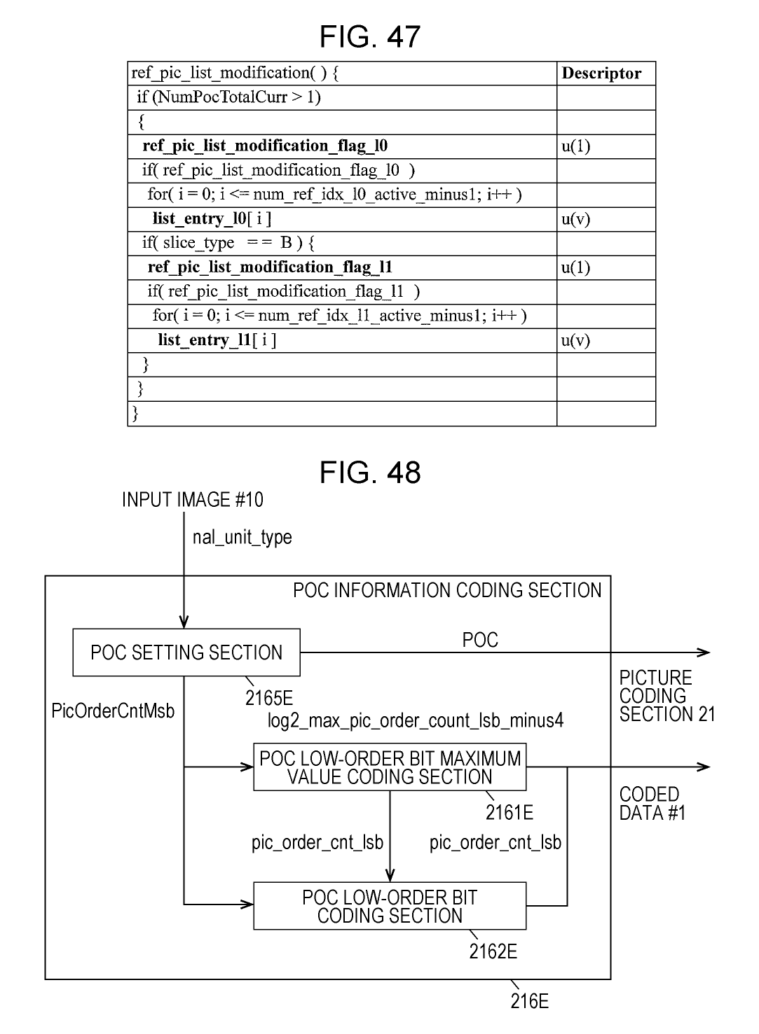

The example in which the RPL correction information is omitted when the number of current picture referable pictures is 2 has been described above in FIG. 46, but the invention is not limited thereto. When the number of current picture referable pictures is 1, the RPL correction information may be omitted. Specifically, the reference list modification information is parsed based on the syntax table illustrated in FIG. 47 in the process of decoding the SH list correction information in the reference picture information decoding section 218. FIG. 47 exemplifies a syntax table of the reference list modification information used to decode the slice header.

### [Picture Decoding Section 11]

The picture decoding section 11 generates the locally decoded image of each picture based on the coded data #1, the header information input from the header decoding section 10, the reference picture recorded on the decoded picture buffer 12, and the reference picture list input from the reference picture list derivation section 132 and records the locally decoded image on the decoded picture buffer 12.

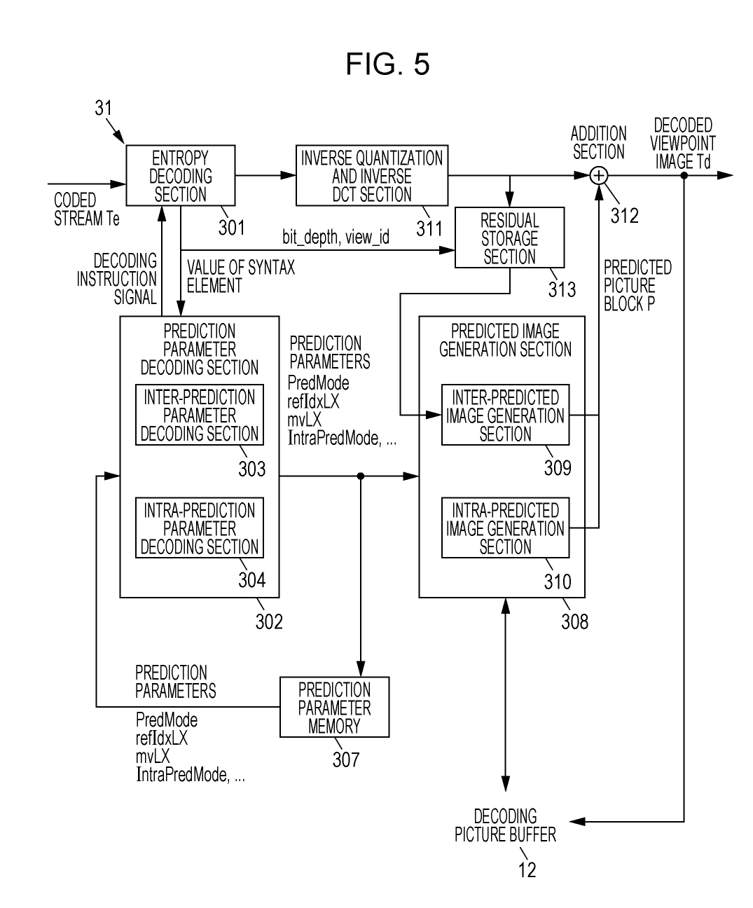

FIG. 5 is a schematic diagram illustrating the configuration of the picture decoding section 11 according to the embodiment. The picture decoding section 11 is configured to include an entropy decoding section 301, a prediction parameter decoding section 302, a prediction parameter memory (prediction parameter storage section) 307, a predicted image generation section 308, an inverse quantization and inverse DCT section 311, and an addition section 312.

The prediction parameter decoding section 302 is configured to include an inter-prediction parameter decoding section 303, and an intra-prediction parameter decoding section 304. The predicted image generation section 308 is configured to include an inter-predicted image generation section 309 and an intra-predicted image generation section 310.

The entropy decoding section 301 executes entropy decoding on the coded data #1 input from the outside to separate and decode an individual code (syntax element). The separated codes are, for example, prediction information used to generate a predicted image and residual information used to generate a difference image.

The entropy decoding section 301 outputs some of the separated codes to the prediction parameter decoding section 302. Some of the separated codes are, for example, the prediction mode PredMode, the split mode part_mode, the merge flag merge_flag, the merge index merge_idx, the inter-prediction flag inter_pred_idx, and the reference picture index refldxLX, the prediction vector index mvp_LX_idx, and the difference vector mvdLX. Whether a certain code is decoded is controlled based on an instruction of the prediction parameter decoding section 302. The entropy decoding section 301 outputs a quantization coefficient to the inverse quantization and inverse DCT section 311. The quantization coefficient is a coefficient which is obtained by executing Discrete Cosine Transform (DCT) on a residual signal and executing quantization in a coding process.

The inter-prediction parameter decoding section 303 decodes the inter-prediction parameters with reference to the prediction parameters stored in the prediction parameter memory 307 based on the codes input from the entropy decoding section 301.

The inter-prediction parameter decoding section 303 outputs the decoded inter-prediction parameters to the predicted image generation section 308 and stores the decoded inter-prediction parameters in the prediction parameter memory 307. The details of the inter-prediction parameter decoding section 303 will be described below.

The intra-prediction parameter decoding section 304 generates the intra-prediction parameters with reference to the prediction parameters stored in the prediction parameter memory 307 based on the codes input from the entropy decoding section 301. The intra-prediction parameter is information necessary when the predicted image of the decoding target block is generated using the intra-prediction and is, for example, the intra-prediction mode IntraPredMode.

The intra-prediction parameter decoding section 304 decodes a depth intra-prediction mode dmm_mode from the input code. The intra-prediction parameter decoding section 304 generates the intra-prediction mode IntraPredMode using the depth intra-prediction mode dmm_mode from the following expression.

IntraPredMode=dmm_mode+35

When the depth intra-prediction mode dmm_mode is 0 or 1, that is, indicates MODE_DMM_WFULL or MODE_DMM_WFULLDELTA, the intra-prediction parameter decoding section 304 decodes a wedgelet pattern index wedge_full_tab_idx from the input code.

When the depth intra-prediction mode dmm_mode is MODE_DMM_WFULLDELTA or MODE_DMM_CPREDTEXDELTA, the intra-prediction parameter decoding section 304 decodes a DC1 absolute value, a DC1 code, a DC2 absolute value, and a DC2 code from the input codes. In the depth intra-prediction mode dmm_mode, a quantization offset DC1 DmmQuantOffsetDC1 and a quantization offset DC2 DmmQuantOffsetDC2 are generated from the DC1 absolute value, the DC1 code, the DC2 absolute value, and the DC2 code by the following expressions.

DmmQuantOffsetDC1=(1−2*dmm_{—}dc_{—}1_sign_flag)dmm_{—}dc_{—}1_{—}abs

DmmQuantOffsetDC2=(1−2*dmm_{—}dc_{—}2_sign_flag)dmm_{—}dc_{—}2_{—}abs

The intra-prediction parameter decoding section 304 sets, as a prediction parameter, a wedgelet pattern index wedge_full_tab_idx decoded with the generated intra-prediction mode IntraPredMode, delta end, quantization offset DC1 DmmQuantOffsetDC1, and the quantization offset DC2 DmmQuantOffsetDC2.

The intra-prediction parameter decoding section 304 outputs the intra-prediction parameters to the predicted image generation section 308 and stores the intra-prediction parameters in the prediction parameter memory 307.

The prediction parameter memory 307 stores the prediction parameter at a position decided in advance for each picture and block of the decoded target. Specifically, the prediction parameter memory 307 stores the inter-prediction parameter decoded by the inter-prediction parameter decoding section 303, the intra-prediction parameter decoded by the intra-prediction parameter decoding section 304, and the prediction mode predMode separated by the entropy decoding section 301. The stored inter-prediction parameters are, for example, the prediction list use flag predFlagLX (the inter-prediction flag inter_pred_idx), the reference picture index refldxLX, and the vector mvLX.

The prediction mode predMode input from the entropy decoding section 301 is input to the predicted image generation section 308 and the prediction parameters are input from the prediction parameter decoding section 302 to the predicted image generation section 308. The predicted image generation section 308 reads the reference picture from the decoded picture buffer 12. The predicted image generation section 308 generates a predicted picture block P (predicted image) using the input prediction parameter and the read reference picture in the prediction mode indicated by the prediction mode predMode.

Here, when the prediction mode predMode is the inter-prediction mode, the inter-predicted image generation section 309 generates the predicted picture block P through the inter-prediction using the read reference picture and the inter-prediction parameter input from the inter-prediction parameter decoding section 303. The predicted picture block P corresponds to the PU. The PU corresponds to a part of the picture formed by a plurality of pixels which is a unit in which the prediction process is executed, as described above, that is, a decoding target block subjected to the prediction process at a time.

The inter-predicted image generation section 309 reads, from the decoded picture buffer 12, the reference picture block present at a position indicated by the vector mvLX using the decoding target block as a reference point from the reference picture indicated by the reference picture index refldxLX in regard to the reference picture list (the L0 reference list or the L1 reference list) of which the prediction list use flag predFlagLX is 1. The inter-predicted image generation section 309 generates the predicted picture block P by predicting the read reference picture block. The inter-predicted image generation section 309 outputs the generated predicted picture block P to the addition section 312.

When the prediction mode predMode is the intra-prediction mode, the intra-predicted image generation section 310 executes the intra-prediction using the read reference picture and the intra-prediction parameter input from the intra-prediction parameter decoding section 304. Specifically, the intra-predicted image generation section 310 reads the reference picture block which is a decoding target picture and is within a pre-decided range from the decoding target block among the already decoded blocks from the decoded picture buffer 12. The pre-decided range is, for example, one of the blocks adjacent to the left, the upper left, the upper, and the upper right when the decoding target block is moved sequentially in a so-called raster scanning order and is different according to the intra-prediction mode. The raster scanning order is an order in which each picture is moved sequentially from the left end to the right end of each row from the upper end to the lower end.

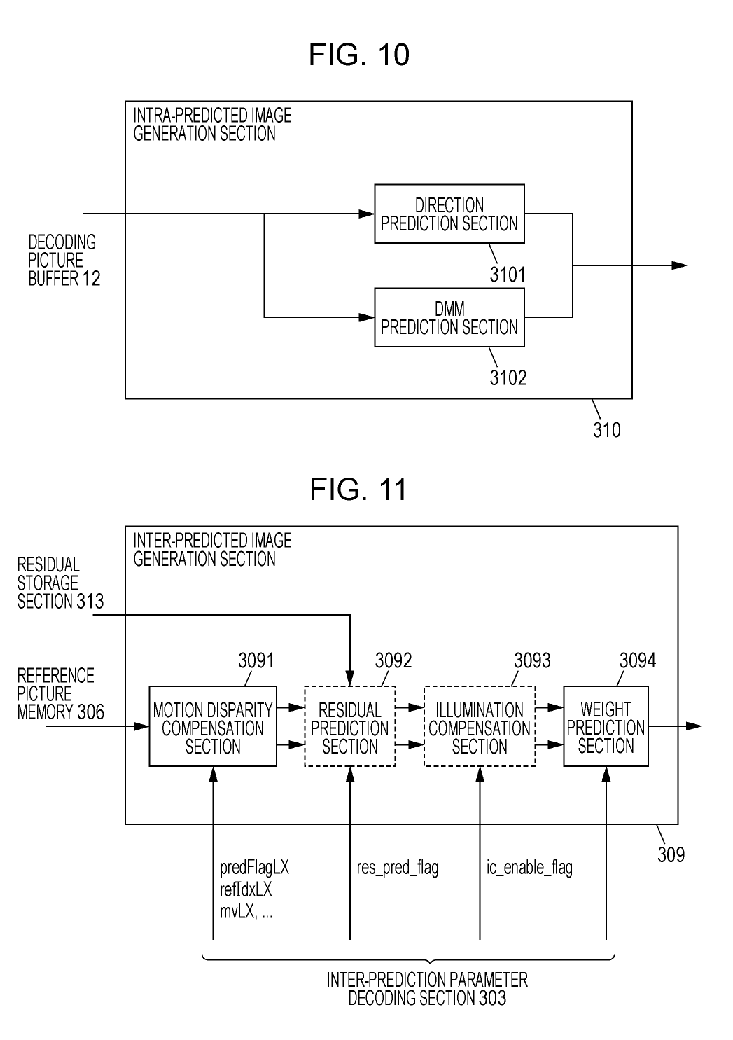

The intra-predicted image generation section 310 generates a predicted picture block using the read reference picture block and the input prediction parameters. FIG. 10 is a schematic diagram illustrating the configuration of the intra-predicted image generation section 310 according to the embodiment. The intra-predicted image generation section 310 is configured to include a direction prediction section 3101 and a DMM prediction section 3102.

When the value of the intra-prediction mode IntraPredMode included in the prediction mode is equal to or less than 34, the intra-predicted image generation section 310 generates a predicted picture block using the intra-prediction described in, for example, NPL 3 in the direction prediction section 3101.

When the value of the intra-prediction mode IntraPredMode is equal to or greater than 35, the intra-predicted image generation section 310 generates a predicted picture block using the depth intra-prediction in the DMM prediction section 3102.

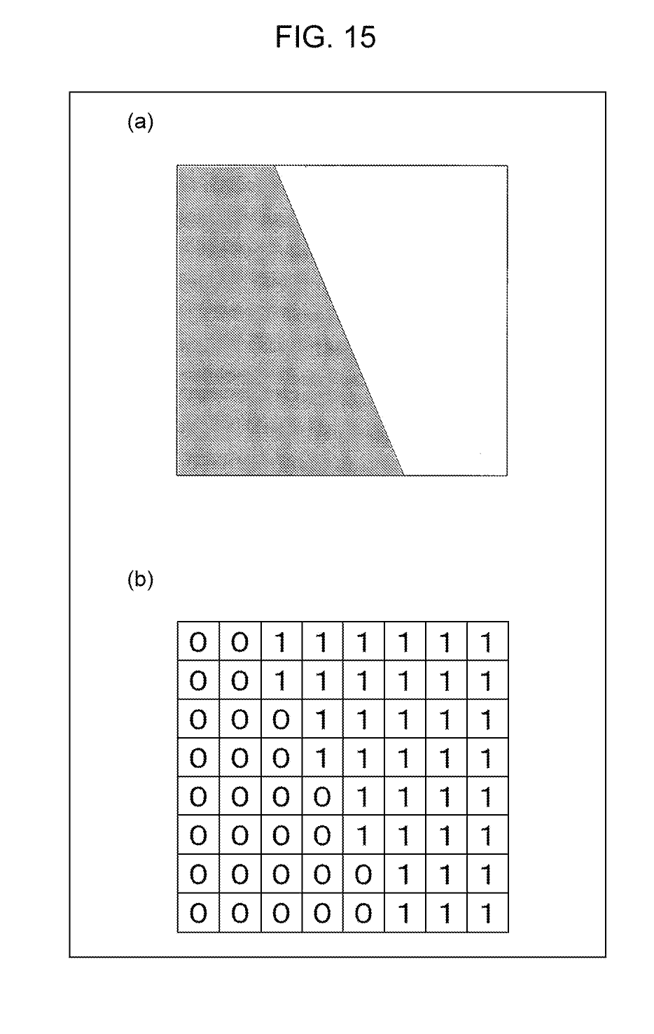

FIG. 15 is a conceptual diagram illustrating the depth intra-prediction processed by the intra-predicted image generation section 310. A depth map has characteristics in which pixel values are not substantially changed within an object and a sharp edge occurs in a boundary of the object. In the depth intra-prediction, as illustrated in FIG. 15(a), a target block is split into two regions along the edge of an object and a predicted picture block is generated by embedding the respective regions with the respective prediction values. The intra-predicted image generation section 310 generates a wedgelet pattern which is information indicating a target block splitting method, as illustrated in FIG. 15(b). The wedgelet pattern is a certain matrix with a size of the width×the height of a target block and indicates the region to which each pixel of the target block belongs between the two regions since 0 or 1 is set for each component.

When the value of the intra-prediction mode IntraPredMode is 35, the intra-predicted image generation section 310 generates a predicted picture block using the MODE_DMM_WFULL mode in the depth intra-prediction. The intra-predicted image generation section 310 first generates a wedgelet pattern list. Hereinafter, a method of generating the wedgelet pattern list will be described.

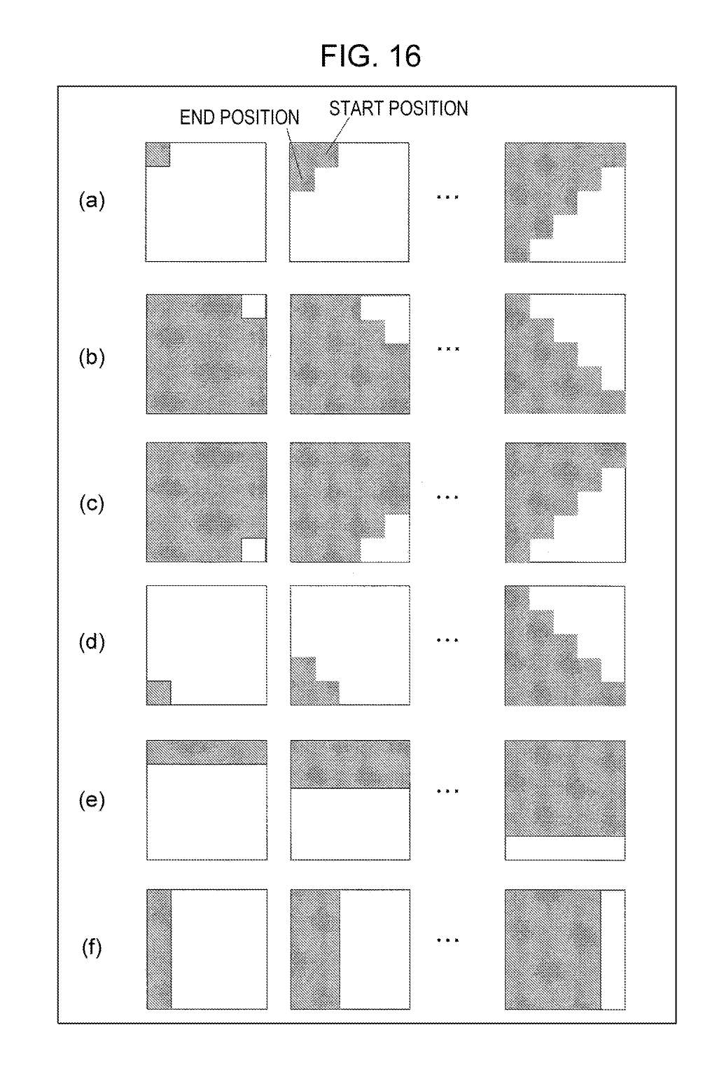

The intra-predicted image generation section 310 first generates a wedgelet pattern in which all of the components are 0. Next, the intra-predicted image generation section 310 sets a start position Sp (xs, ys) and an end position Ep (xe, ye) within the wedgelet pattern. In the case of FIG. 16(a), the start position Sp (xs, ys)=(0, 0) and the end position Ep (xe, ye)=(0, 0) are set as initial values, a line segment is pulled using the Bresenham algorithm between the start position Sp and the end position Ep, the components corresponding to the line segment and the coordinates of the left side of the line segment are set to 1 (grey components in FIG. 16(a)). The intra-predicted image generation section 310 stores the generated wedgelet pattern in the wedgelet pattern list. Next, the intra-predicted image generation section 310 adds 1 to the X coordinate of the start position Sp and the Y coordinate of the end position Ep to generate the wedgelet pattern according to the same method. The process continues until the start position Sp or the end position Ep exceeds the range of the wedgelet pattern.

In the case of FIG. 16(b), the start position Sp (xs, ys)=(blocksize−1, 0) and the end position Ep (xe, ye)=(blocksize−1, 0) are set as initial values, a wedgelet pattern is generated according to the same method as that of FIG. 16(a) by repeating addition of 1 to the Y coordinate of the start position Sp and subtraction of 1 from the X coordinate of the end position Ep, and the wedgelet pattern is added to the wedgelet pattern list. The blocksize indicates the size of the width and the height of the target block.

In the case of FIG. 16(c), the start position Sp (xs, ys)=(blocksize−1, blocksize−1) and the end position Ep (xe, ye)=(blocksize−1, blocksize−1) are set as initial values, a wedgelet pattern is generated according to the same method as that of FIG. 16(a) by repeating subtraction of 1 from the X coordinate of the start position Sp and from the Y coordinate of the end position Ep, and the wedgelet pattern is added to the wedgelet pattern list.

In the case of FIG. 16(d), the start position Sp (xs, ys)=(0, blocksize−1) and the end position Ep (xe, ye)=(0, blocksize−1) are set as initial values, a wedgelet pattern is generated according to the same method as that of FIG. 16(a) by repeating subtraction of 1 from the Y coordinate of the start position Sp and addition of 1 to the X coordinate of the end position Ep, and the wedgelet pattern is added to the wedgelet pattern list.

In the case of FIG. 16(e), the start position Sp (xs, ys)=(0, 0) and the end position Ep (xe, ye)=(0, blocksize−1) are set as initial values, a wedgelet pattern is generated according to the same method as that of FIG. 16(a) by repeating addition of 1 to the X coordinate of the start position Sp and the X coordinate of the end position Ep, and the wedgelet pattern is added to the wedgelet pattern list.

In the case of FIG. 16(f), the start position Sp (xs, ys)=(blocksize−1, 0) and the end position Ep (xe, ye)=(0, 0) are set as initial values, a wedgelet pattern is generated according to the same method as that of FIG. 16(a) by repeating addition of 1 to the Y coordinate of the start position Sp to the Y coordinate of the end position Ep, and the wedgelet pattern is added to the wedgelet pattern list.

The intra-predicted image generation section 310 generates the wedgelet pattern list using one of the foregoing methods from FIGS. 16(a) to 16(f) or all of the methods.

Next, the intra-predicted image generation section 310 selects the wedgelet pattern from the wedgelet pattern list using the wedgelet pattern index wedge_full_tab_idx included in the prediction parameter. The intra-predicted image generation section 310 splits the predicted picture block into two regions according to the wedgelet pattern and derives prediction values dmmPredPartitionDC1 and dmmPredPartitionDC2 for each region. In the prediction value derivation method, for example, an average value of the pixel values of the reference picture block adjacent to the region is set as the prediction value. When there is no reference picture block adjacent to the region and the bit depth of the pixels is set to BitDepth, “1<<(BitDepth−1)” is set to a prediction value. The intra-predicted image generation section 310 generates the predicted picture block by embedding each region with the prediction values dmmPredPartitionDC1 and dmmPredPartitionDC2.

When the value of the intra-prediction mode IntraPredMode is 36, the intra-predicted image generation section 310 generates the predicted picture block using the MODE_DMM_WFULLDELTA mode in the depth intra-prediction. First, the intra-predicted image generation section 310 selects the wedgelet pattern from the wedgelet pattern list as in the time of the MODE_DMM_WFULL mode and derives the prediction values dmmPredPartitionDC1 and dmmPredPartitionDC2 for each region.

Next, the intra-predicted image generation section 310 derives the depth intra-prediction offsets dmmOffsetDC1 and dmmOffsetDC2 using the quantization offsets DC1DmmQuantOffsetDC1 and DC2DmmQuantOffsetDC2 included in the prediction parameters by the following expressions when the quantization parameter is set QP.

dmmOffsetDC1=DmmQuantOffsetDC1*Clip3(1,(1<<BitDepthY)−1,2̂((QP/10)−2))

dmmOffsetDC2=DmmQuantOffsetDC2*Clip3(1,(1<<BitDepthY)−1,2̂((QP/10)−2))

The intra-predicted image generation section 310 generates the predicted picture block by embedding each region with values obtained by respectively adding the intra-prediction offsets dmmOffsetDC1 and dmmOffsetDC2 to the prediction values dmmPredPartitionDC1 and dmmPredPartitionDC2.

When the value of the intra-prediction mode IntraPredMode is 37, the intra-predicted image generation section 310 generates a predicted picture block using the MODE_DMM_CPREDTEX mode in the depth intra-prediction. The intra-predicted image generation section 310 reads the corresponding block from the decoded picture buffer 12. The intra-predicted image generation section 310 calculates an average value of the pixel values of the corresponding block. The intra-predicted image generation section 310 sets the calculated average value as a threshold value and divides the corresponding block into region 1 with a value equal to or greater than the threshold value and region 2 with a value equal to or less than the threshold value. The intra-predicted image generation section 310 splits the predicted picture block into two regions with the same shape between regions 1 and 2. The intra-predicted image generation section 310 derives the prediction values dmmPredPartitionDC1 and dmmPredPartitionDC2 for each region using the same method as that at the time of the MODE_DMM_WFULL mode. The intra-predicted image generation section 310 generates the predicted picture block by embedding each region with the prediction values dmmPredPartitionDC1 and dmmPredPartitionDC2.

When the value of the intra-prediction mode IntraPredMode is 38, the intra-predicted image generation section 310 generates a predicted picture block using the MODE_DMM_CPREDTEXDELTA mode in the depth intra-prediction. First, as in the MODE_DMM_CPREDTEX mode, the intra-predicted image generation section 310 splits the predicted picture block into two regions and derives the prediction values dmmPredPartitionDC1 and dmmPredPartitionDC2 for each region. Next, the intra-predicted image generation section 310 derives the intra-prediction offsets dmmOffsetDC1 and dmmOffsetDC2 as in the MODE_DMM_WFULLDELTA mode and generates the predicted picture block by embedding each region with values obtained by adding the intra-prediction offsets dmmOffsetDC1 and dmmOffsetDC2 to the prediction values dmmPredPartitionDC1 and dmmPredPartitionDC2.

The intra-predicted image generation section 310 outputs the generated predicted picture block P to the addition section 312.

The inverse quantization and inverse DCT section 311 executes inverse quantization on the quantization coefficient input from the entropy decoding section 301 to obtain a DCT coefficient. The inverse quantization and inverse DCT section 311 executes inverse discrete cosine transform (DCT) on the obtained DCT coefficient to calculate a decoded residual signal. The inverse quantization and inverse DCT section 311 outputs the calculated decoded residual signal to the addition section 312.

The addition section 312 adds the predicted picture block P input from the inter-predicted image generation section 309 and the intra-predicted image generation section 310 and the signal value of the decoded residual signal input from the inverse quantization and inverse DCT section 311 for each pixel to generate a reference picture block. The addition section 312 stores the generated reference picture block in the reference picture buffer 12 and outputs the decoded layer image Td in which the generated reference picture blocks are integrated for each picture to the outside.

### (Configuration of Inter-Prediction Parameter Decoding Section)

Next, the configuration of the inter-prediction parameter decoding section 303 will be described.

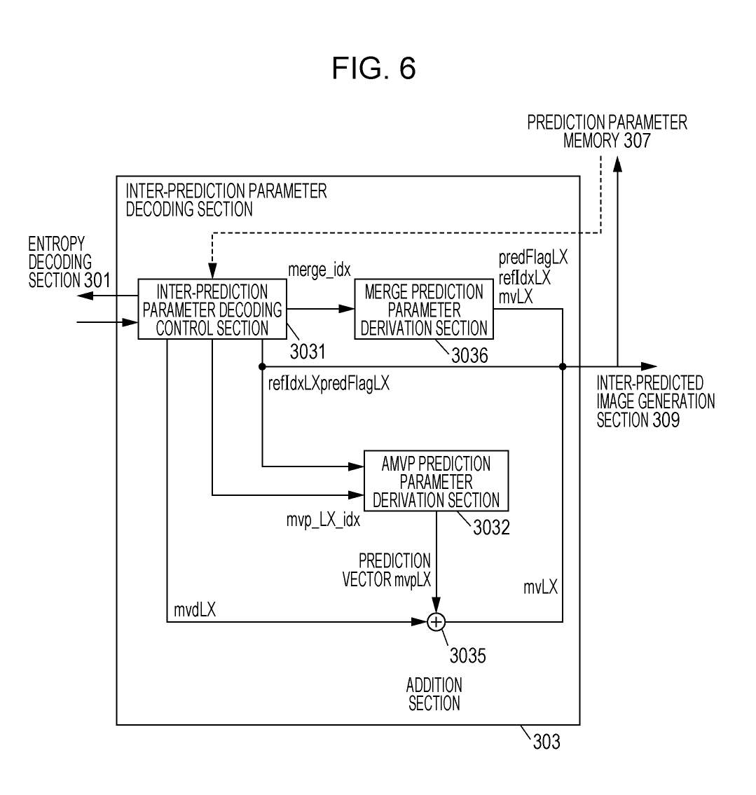

FIG. 6 is a schematic diagram illustrating the configuration of the inter-prediction parameter decoding section 303 according to the embodiment. The inter-prediction parameter decoding section 303 is configured to include an inter-prediction parameter decoding control section 3031, an AMVP prediction parameter derivation section 3032, an addition section 3035, and a merge prediction parameter derivation section 3036.

The inter-prediction parameter decoding control section 3031 instructs the entropy decoding section 301 to decode the code (syntax element) related to the inter-prediction and extracts codes (syntax elements) included in the coded data, for example, the split mode part_mode, the merge flag merge_flag, the merge index merge_idx, the inter-prediction flag inter_pred_idx, the reference picture index refldxLX, the prediction vector index mvp_LX_idx, and the difference vector mvdLX.

The inter-prediction parameter decoding control section 3031 first extracts the merge flag. When the inter-prediction parameter decoding control section 3031 denotes extractions of a certain syntax element, it is meant that the inter-prediction parameter decoding control section 3031 instructs the entropy decoding section 301 to decode the certain syntax element and reads the corresponding syntax element from the coded data. Here, when a value indicated by the merge flag is 1, that is, indicates the merge prediction mode, the inter-prediction parameter decoding control section 3031 extracts, for example, a merge index merge_idx as the prediction parameter related to the merge prediction. The inter-prediction parameter decoding control section 3031 outputs the extracted merge index merge_idx to the merge prediction parameter derivation section 3036.

When the merge flag merge_flag is 0, that is, indicates the AMVP prediction mode, the inter-prediction parameter decoding control section 3031 extracts the AMVP prediction parameter from the coded data using the entropy decoding section 301. As the AMVP prediction parameters, for example, there are the inter-prediction flag inter_pred_idx, the reference picture index refldxLX, the vector index mvp_LX_idx, and the difference vector mvdLX. The inter-prediction parameter decoding control section 3031 outputs the predicted list use flag predFlagLX and the reference picture index refldxLX derived from the extracted inter-prediction flag inter_pred_idx to the AMVP prediction parameter derivation section 3032 and the predicted image generation section 308 (see FIG. 5) and stores the predicted list use flag predFlagLX and the reference picture index refldxLX in the prediction parameter memory 307 (see FIG. 5). The inter-prediction parameter decoding control section 3031 outputs the extracted vector index mvp_LX_idx to the AMVP prediction parameter derivation section 3032. The inter-prediction parameter decoding control section 3031 outputs the extracted difference vector mvdLX to the addition section 3035.

FIG. 7 is a schematic diagram illustrating the configuration of the merge prediction parameter derivation section 3036 according to the embodiment. The merge prediction parameter derivation section 3036 includes a merge candidate derivation section 30361 and a merge candidate selection section 30362. The merge candidate derivation section 30361 is configured to include a merge candidate storage section 303611, an enhancement merge candidate derivation section 303612, a basic merge candidate derivation section 303613, and an MPI candidate derivation section 303614.

The merge candidate storage section 303611 stores merge candidates input from the enhancement merge candidate derivation section 303612 and the basic merge candidate derivation section 303613. The merge candidates are configured to include the prediction list use flag predFlagLX, the vector mvLX, and the reference picture index refldxLX. In the merge candidate storage section 303611, indexes can be allocated to the stored merge candidates according to a predetermined rule. For example, “0” is allocated as an index to the merge candidate input from the enhancement merge candidate derivation section 303612 or the MPI candidate derivation section 303614.

When the layer of the target block is the depth layer and motion parameter inheritance can be used, that is, both of the depth flag depth_flag and the motion parameter inheritance flag use_mpi_flag are 1, the MPI candidate derivation section 303614 derives the merge candidate using the motion compensation parameter of a different layer from the target layer. The different layer from the target layer is, for example, the picture of the texture layer having the same view ID view_id and the same POC as the target depth picture.

The MPI candidate derivation section 303614 reads the prediction parameter of the block (which is referred to as a corresponding block) with the same coordinates as the target block in the picture of the different layer from the target layer from the prediction parameter memory 307.

When the size of the corresponding block is less than the target block, the MPI candidate derivation section 303614 reads the split flag split_flag of the CTU with the same coordinates as the target block in the corresponding texture picture and the prediction parameters of the plurality of blocks included in the CTU.

When the size of the corresponding block is greater than the target block, the MPI candidate derivation section 303614 reads the prediction parameters of the corresponding block.

The MPI candidate derivation section 303614 outputs the read prediction parameters as the merge candidates to the merge candidate storage section 303611. When the split flag split_flag of the CTU is also read, the split information is also included in the merge candidate.

The enhancement merge candidate derivation section 303612 is configured to include a disparity vector acquisition section 3036122, an inter-layer merge candidate derivation section 3036121, and an inter-layer disparity merge candidate derivation section 3036123.

When the layer of the target block is not the depth layer or motion parameter inheritance may not be used, that is, either the depth flag depth_flag or the motion parameter inheritance flag use_mpi_flag is 0, the enhancement merge candidate derivation section 303612 derives the merge candidate. Further, when both of the depth flag depth_flag and the motion parameter inheritance flag use_mpi_flag are 1, the enhancement merge candidate derivation section 303612 may derive the merge candidate. In this case, the merge candidate storage section 303611 allocates different indexes to the merge candidates derived by the enhancement merge candidate derivation section 303612 and the MPI candidate derivation section 303614.

The disparity vector acquisition section 3036122 first acquires disparity vectors in order from a plurality of candidate blocks adjacent to a decoding target block (for example, blocks adjacent to the left, upper, and upper right sides). Specifically, one of the candidate blocks is selected and a reference layer determination section 303111 (which will be described below) is used to determine whether the vector of the selected candidate block is a disparity vector or a motion vector using the reference picture index refIdxLX of the candidate block. When there is the disparity vector, this disparity vector is set as a disparity vector. When there is no disparity vector in the candidate block, a subsequent candidate block is scanned in order. When there is no disparity vector in an adjacent block, the disparity vector acquisition section 3036122 attempts to acquire the disparity vector of a block located at a position corresponding to the target block of the block included in a reference picture of a temporarily different display order. When the disparity vector may not be acquired, the disparity vector acquisition section 3036122 sets a zero vector as the disparity vector. The disparity vector acquisition section 3036122 outputs the disparity vector to the inter-layer merge candidate derivation section 3036121 and the inter-layer disparity merge candidate derivation section.

The disparity vector is input from the disparity vector acquisition section 3036122 to the inter-layer merge candidate derivation section 3036121. The inter-layer merge candidate derivation section 3036121 selects a block indicated by only the disparity vector input from the disparity vector acquisition section 3036122 from the picture having the same POC as the decoding target picture of a different layer (for example, a base layer or a base view) and reads the prediction parameter which is a motion vector which the block has from the prediction parameter memory 307. More specifically, the prediction parameter read by the inter-layer merge candidate derivation section 3036121 is a prediction parameter of a block including coordinates for which the disparity vector is added to the coordinates of a starting point when a central point of the target block is set as the starting point.

The coordinates (xRef, yRef) of the reference block are derived by the following expressions when the coordinates of the target block are (xP, yP), the disparity vector is (mvDisp[0], mvDisp[1]), and the width and height of the target block are nPSW and nPSH.

xRef=Clip3(0,PicWidthInSamples_{L}−1,xP+((nPSW−1)>>1)+((mvDisp[0]+2)>2))

yRef=Clip3(0,PicHeightInSamples_{L}−1,yP+((nPSH−1)>>1)+((mvDisp[1]+2)>>2))

The inter-layer merge candidate derivation section 3036121 determines whether the prediction parameter is the motion vector by a method in which a determination result is false (not the disparity vector) in a determination method of the reference layer determination section 303111 to be described below included the inter-prediction parameter decoding control section 3031. The inter-layer merge candidate derivation section 3036121 outputs the read prediction parameter as the merge candidate to the merge candidate storage section 303611. When the prediction parameter may not be derived, the inter-layer merge candidate derivation section 3036121 outputs the non-derivation of the prediction parameter to the inter-layer disparity merge candidate derivation section. The merge candidate is an inter-layer candidate (interview candidate) of the motion prediction and is also stated as an inter-layer merge candidate (motion prediction).

The disparity vector is input from the disparity vector acquisition section 3036122 to the inter-layer disparity merge candidate derivation section 3036123. The inter-layer disparity merge candidate derivation section 3036123 outputs the input disparity vector and the reference picture index refIdxLX (for example, the index of the base layer image having the same POC as the decoding target picture) of the previous layer image indicated by the disparity vector as merge candidates to the merge candidate storage section 303611. These merge candidates are inter-layer candidates (interview candidates) of the disparity prediction and are also stated as inter-layer merge candidates (disparity prediction).

The basic merge candidate derivation section 303613 is configured to include a spatial merge candidate derivation section 3036131, a temporal merge candidate derivation section 3036132, a combined merge candidate derivation section 3036133, and a zero merge candidate derivation section 3036134.

The spatial merge candidate derivation section 3036131 reads the prediction parameters (the prediction list use flag predFlagLX, the vector mvLX, and the reference picture index refldxLX) stored by the prediction parameter memory 307 according to a predetermined rule and derives the read prediction parameters as merge candidates. The read prediction parameters are prediction parameters related to blocks present within a pre-decided range from the decoding target block (for example, some or all of the blocks adjacent to the lower left end, the upper left end, and the upper right end of the decoding target block). The derived merge candidates are stored in the merge candidate storage section 303611.

The temporal merge candidate derivation section 3036132 reads the prediction parameter of a block inside the reference image including the coordinates of the lower right of the decoding target block from the prediction parameter memory 307 and sets the read prediction parameter as a merge candidate. As a method of designating the reference image, for example, the reference image may be designated with the reference picture index refldxLX put and designated in the slice header or may be designated with the minimum index among the reference picture indexes refldxLX of the blocks adjacent to the decoding target block. The derived merge candidate is stored in the merge candidate storage section 303611.

The combined merge candidate derivation section 3036133 derives combined merge candidates by combining the vectors of two different derived merge candidates already derived and stored in the merge candidate storage section 303611 with the reference picture indexes and setting the combined vectors as vectors of L0 and L1. The derived merge candidates are stored in the merge candidate storage section 303611.

The zero merge candidate derivation section 3036134 derives a merge candidate of which the reference picture index refldxLX is 0 and both of the X and Y components of the vector mvLX are 0. The derived merge candidate is stored in the merge candidate storage section 303611.

The merge candidate selection section 30362 selects, an inter-prediction parameter of the target PU, as the merge candidate to which the index corresponding to the merge index merge_idx input from the inter-prediction parameter decoding control section 3031 among the merge candidates stored in the merge candidate storage section 303611 is allocated. The merge candidate selection section 30362 stores the selected merge candidate in the prediction parameter memory 307 (see FIG. 5) and outputs the selected merge candidate to the predicted image generation section 308 (see FIG. 5). The merge candidate selection section 30362 selects the merge candidate derived by the MPI candidate derivation section 303614 and the merge candidate includes the split flag split_flag, and the plurality of prediction parameters corresponding to blocks split by the split flag split_flag are stored in the prediction parameter memory 307 and are output to the predicted image generation section 308.

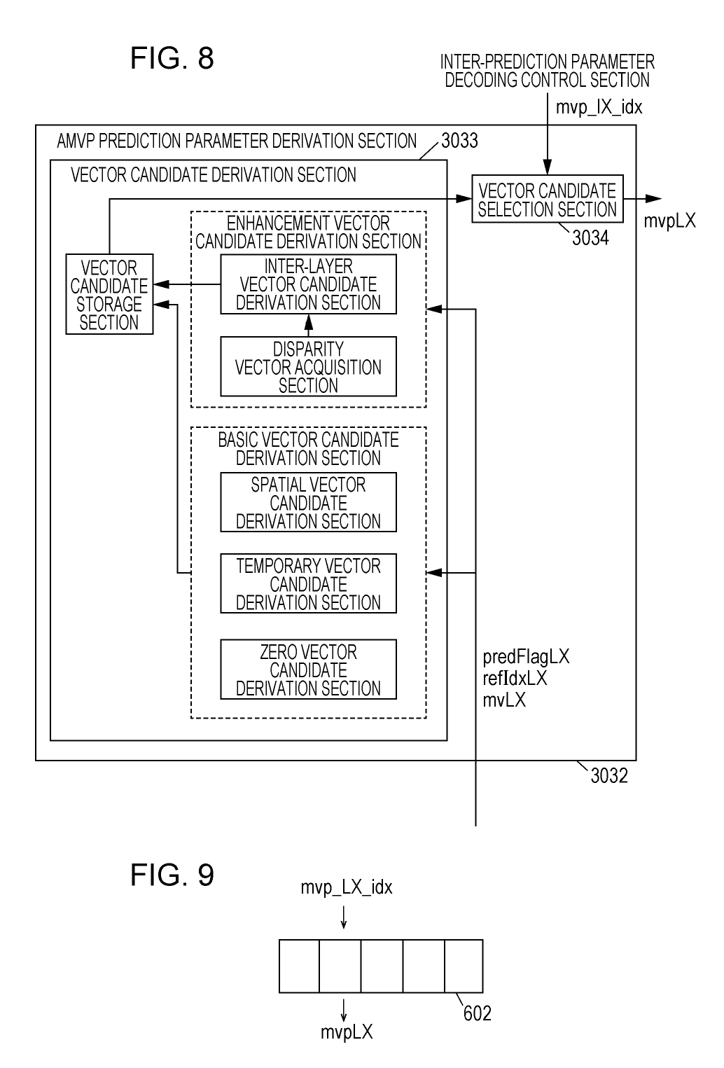

FIG. 8 is a schematic diagram illustrating the configuration of the AMVP prediction parameter derivation section 3032 according to the embodiment. The AMVP prediction parameter derivation section 3032 includes a vector candidate derivation section 3033 and a prediction vector selection section 3034. The vector candidate derivation section 3033 reads the vectors (the motion vectors or the disparity vectors) stored by the prediction parameter memory 307 (see FIG. 5) as the vector candidates based on the reference picture indexes refldx. The read vectors are vectors related to the block present within a pre-decided range from the decoding target block (for example, some or all of the blocks adjacent to the lower left end, the upper left end, and the upper right end of the decoding target block).

The prediction vector selection section 3034 selects, as the prediction vector mvpLX, the vector candidate indicated by the vector index mvp_LX_idx input from the inter-prediction parameter decoding control section 3031 among the vector candidates read by the vector candidate derivation section 3033. The prediction vector selection section 3034 outputs the selected prediction vector mvpLX to the addition section 3035.

FIG. 9 is a conceptual diagram illustrating an example of a vector candidate. A prediction vector list 602 illustrated in FIG. 9 is a list formed by the plurality of vector candidates derived by the vector candidate derivation section 3033. In the prediction vector list 602, five rectangles arranged horizontally in one line indicate regions indicating prediction vectors. A downward arrow immediately below the second mvp_LX_idx from the left end and mvPLX below the arrow indicate an index by which the vector index mvp_LX_idx refers to the vector mvpLX in the prediction parameter memory 307.

The candidate vector is generated based on a vector related to a referred block with reference to a block (for example, an adjacent block) on which a decoding process is completed and which is within a pre-decided range from a decoding target block. The adjacent blocks include not only blocks spatially adjacent to a target block, for example, a left block and an upper block, but also blocks temporarily adjacent to a target block, for example, blocks obtained at the same position as the target block from a block of which a display time is different.

The addition section 3035 adds the prediction vector mvpLX input from the prediction vector selection section 3034 and the difference vector mvdLX input from the inter-prediction parameter decoding control section to calculate a vector mvLX. The addition section 3035 outputs the calculated vector mvLX to the predicted image generation section 308 (see FIG. 5).

### (Configuration of Inter-Prediction Parameter Decoding Control Section)

Next, the configuration of the inter-prediction parameter decoding control section 3031 will be described. As illustrated in FIG. 10, the inter-prediction parameter decoding control section 3031 is configured to include a merge index decoding section 30312 and a vector candidate index decoding section 30313 and include a split mode decoding section, a merge flag decoding section, an inter-prediction flag decoding section, a reference picture index decoding section, and a vector difference decoding section (none of which is illustrated). The split mode decoding section, the merge flag decoding section, the merge index decoding section, the inter-prediction flag decoding section, the reference picture index decoding section, the vector candidate index decoding section 30313, and the vector difference decoding section respectively decode the split mode part_mode, the merge flag merge_flag, the merge index merge_idx, the inter-prediction flag inter_pred_idx, the reference picture index refldxLX, the prediction vector index mvp_LX_idx, and the difference vector mvdLX.

The additional prediction flag decoding section 30311 includes an additional prediction flag determination section 30314 therein. The additional prediction flag determination section 30314 determines whether the additional prediction flag xpred_flag is included in coded data (whether the additional prediction flag xpred_flag is read from the coded data and is decoded). When the additional prediction flag determination section 30314 determines that the additional prediction flag is included in the coded data, the additional prediction flag decoding section 30311 notifies the entropy decoding section 301 of decoding of the additional prediction flag and extracts a syntax element corresponding to the additional prediction flag from the coded data via the entropy decoding section 301. In contrast, when the additional prediction flag determination section 30314 determines that the additional prediction flag is not included in the coded data, a value (here, 1) indicating the additional prediction is derived (inferred) to the additional prediction flag. The additional prediction flag determination section 30314 will be described below.

### (Disparity Vector Acquisition Section)

When the block adjacent to the target PU has a disparity vector, the disparity vector acquisition section extracts the disparity vector from the prediction parameter memory 307 and reads the prediction flag predFlagLX, the reference picture index refIdxLX, and the vector mvLX of the block adjacent to the target PU with reference to the prediction parameter memory 307. The disparity vector acquisition section includes a reference layer determination section 303111 therein. The disparity vector acquisition section reads the prediction parameters of the block adjacent to the target PU in order and determines whether the adjacent block has a disparity vector from the reference picture index of the adjacent block using the reference layer determination section 303111. When the adjacent block has the disparity vector, the disparity vector is output. When there is no disparity vector in the prediction parameter of the adjacent block, a zero vector is output as the disparity vector.

### (Reference Layer Determination Section 303111)

The reference layer determination section 303111 decides a reference picture indicated by the reference picture index refIdxLX and reference layer information reference_layer_info indicating a relation of the target picture based on the input reference picture index refIdxLX. The reference layer information reference_layer_info is information indicating whether the vector mvLX to the reference picture is a disparity vector or a motion vector.

Prediction in a case in which the layer of the target picture is the same layer as the layer of the reference picture is referred to as same-layer prediction and a vector obtained in this case is a motion vector. Prediction in a case in which the layer of the target picture is a different layer from the layer of the reference picture is referred to as inter-layer prediction and a vector obtained in this case is a disparity vector.

Here, first to third determination methods will be described as examples of a determination process of the reference layer determination section 303111. The reference layer determination section 303111 may use one of the first to third determination methods or any combination of these methods.

### <First Determination Method>

When a display time (picture order number: Picture Order Count (POC)) related to the reference picture indicated by the reference picture index refldxLX is the same as a display time (POC) related to a decoding target picture, the reference layer determination section 303111 determines that the vector mvLX is the disparity vector. The POC is a number indicating an order in which a picture is displayed and is an integer (discrete time) indicating a display time at which the picture is acquired. When the vector mvLX is determined not to be the disparity vector, the reference layer determination section 303111 determines that the vector mvLX is the motion vector.

Specifically, when the picture order number POC of the reference picture indicated by the reference picture index refIdxLX is the same as the POC of the decoding target picture, the reference layer determination section 303111 determines that the vector mvLX is the disparity vector and executes the determination, for example, by the following expression.

POC==ReflayerPOC(refIdxLX,ListX)

Here, the POC is the POC of the decoding target picture and RefPOC (X, Y) is the POC of the reference picture designated by the reference picture index X and the reference picture list Y.

The fact that the reference picture of the same POC as the POC of the decoding target picture can be referred to means that the layer of the reference picture is different from the layer of the decoding target picture. Accordingly, when the POC of the decoding target picture is the same as the POC of the reference picture, the inter-layer prediction is determined to be executed (disparity vector). Otherwise, the same-layer prediction is determined to be executed (motion vector).

<Second Determination Method>

When a viewpoint related to the reference picture indicated by the reference picture index refldxLX is different from a viewpoint related to the decoding target picture, the reference layer determination section 303111 may determine that the vector mvLX is the disparity vector. Specifically, when a view IDview_id of the reference picture indicated by the reference picture index refldxLX is different from a view IDview_id of the decoding target picture, the reference layer determination section 303111 determines that the vector mvLX is the disparity vector by, for example, the following expression.

ViewID==ReflayerViewID(refldxLXListX)

Here, ViewID is a view ID of the decoding target picture and RefViewID (X, Y) is a view ID of the reference picture designated by the reference picture index X and the reference picture list Y.

The view IDview_id is information used to identify each viewpoint image. The difference vector dvdLX related to the disparity vector is based on the fact that the difference vector is obtained between pictures with different viewpoints and is not obtained between pictures with the same viewpoint. When the vector mvLX is determined not to be the disparity vector, the reference layer determination section 303111 determines that the vector mvLX is a motion vector.

An individual viewpoint image is a kind of layer. Therefore, when the view IDview_id is determined to be different, the reference layer determination section 303111 determines that the vector mvLX is the disparity vector (the inter-layer prediction is executed). Otherwise, the reference layer determination section 303111 determines that the vector mvLX is the motion vector (the same-layer prediction is executed).

### <Third Determination Method>

When a layer IDlayer_id related to the reference picture indicated by the reference picture index refldxLX is different from a layer IDlayer_id related to the decoding target picture, the reference layer determination section 303111 may determine that the vector mvLX is the disparity vector by, for example, the following expression.

layerID !=ReflayerID(refIdxLX,ListX)

Here, layerID is a layer ID of the decoding target picture and ReflayerID (X, Y) is a layer ID of the reference picture designated by the reference picture index X and the reference picture list Y. The layer IDlayer_id is data identifying each layer when one picture is configured to include data of a plurality of hierarchies (layers). In coded data obtained by coding a picture with a different viewpoint, the layer ID is based on the fact that the layer ID has a different value depending on a viewpoint. That is, the difference vector dvdLX related to the disparity vector is a vector obtained between a target picture and a picture related to a different layer. When the vector mvLX is determined not to be the disparity vector, the reference layer determination section 303111 determines that the vector mvLX is the motion vector.

When the layer ID layer_id is different, the reference layer determination section 303111 determines that the vector mvLX is the disparity vector (the inter-layer prediction is executed). Otherwise, the reference layer determination section 303111 determines that the vector mvLX is the motion vector (the same-layer prediction is executed).

### (Inter-Predicted Image Generation Section 309)

FIG. 11 is a schematic diagram illustrating the configuration of the inter-predicted image generation section 309 according to the embodiment. The inter-predicted image generation section 309 is configured to include a motion disparity compensation section 3091, a residual prediction section 3092, an illumination compensation section 3093, and a weight prediction section 3094.

### (Motion Disparity Compensation)

The motion disparity compensation section 3091 generates a motion disparity compensated image by reading a block located at a position deviated by the vector mvLX using the position of the target block of the reference picture designated by the reference picture index refldxLX as a starting point from the decoded picture buffer 12 based on the prediction list use flag predFlagLX, the reference picture index refldxLX, and the motion vector mvLX input from the inter-prediction parameter decoding section 303. Here, when the vector mvLX is not an integer vector, the motion disparity compensated image is generated by applying a filter called a motion compensation filter (or a disparity compensation filter) and used to generate a pixel at a predetermined position. In general, when the vector mvLX is the motion vector, the foregoing process is referred to as motion compensation. When the vector mvLX is the disparity vector, the foregoing process is referred to as disparity compensation. Here, the process is collectively denoted as motion disparity compensation. Hereinafter, a motion disparity compensated image of the L0 prediction is referred to as predSamplesL0 and a motion disparity compensation image of the L1 prediction is referred to as predSamplesL1. When both of the motion disparity compensated images are not distinguished from each other, the motion disparity compensated images are referred to as predSamplesLX. Hereinafter, an example in which a motion disparity compensated image predSamplesLX obtained by the motion disparity compensation section 3091 is further subjected to the residual prediction and the illumination compensation will be described. Such an output image is also referred to as the motion disparity compensated image predSamplesLX. When an input image and an output image of each means are distinguished from each other in the residual prediction and the illumination compensation to be described below, the input image is denoted as predSamplesLX and the output image is denoted as predSamplesLX′.

### (Residual Prediction)

When the residual prediction flag res_pred_flag is 1, the residual prediction section 3092 executes the residual prediction on the input motion disparity compensated image predSamplesLX. When the residual prediction flag res_pred_flag is 0, the input motion disparity compensated image predSamplesLX is output without change. The residual prediction section 3092 executes the residual prediction on the motion disparity compensated image predSamplesLX obtained by the motion disparity compensation section 3091 using the disparity vector mvDisp input from the inter-prediction parameter decoding section 303 and a residual refResSamples stored in the residual storage section 313. The residual prediction is executed by adding a residual of a reference layer (the first layer image) different from a target layer (the second layer image) which is a prediction image generation target to the motion disparity compensated image predSamplesLX which is a predicted image of the target layer. That is, on the assumption that the same residual as that of the reference layer also occurs in the target layer, the residual of the already derived reference layer is used as a predicted value of the residual of the target layer. Only an image of the same layer becomes the reference image in the base layer (base view). Accordingly, when the reference layer (the first layer image) is the base layer (the base view), a predicted image of the reference layer is a predicted image by the motion compensation. Therefore, in the prediction by the target layer (the second layer image), the residual prediction is also valid when the predicted image is the predicted image by the motion compensation. That is, there are characteristics in which the residual prediction is valid when the target block is for the motion compensation.

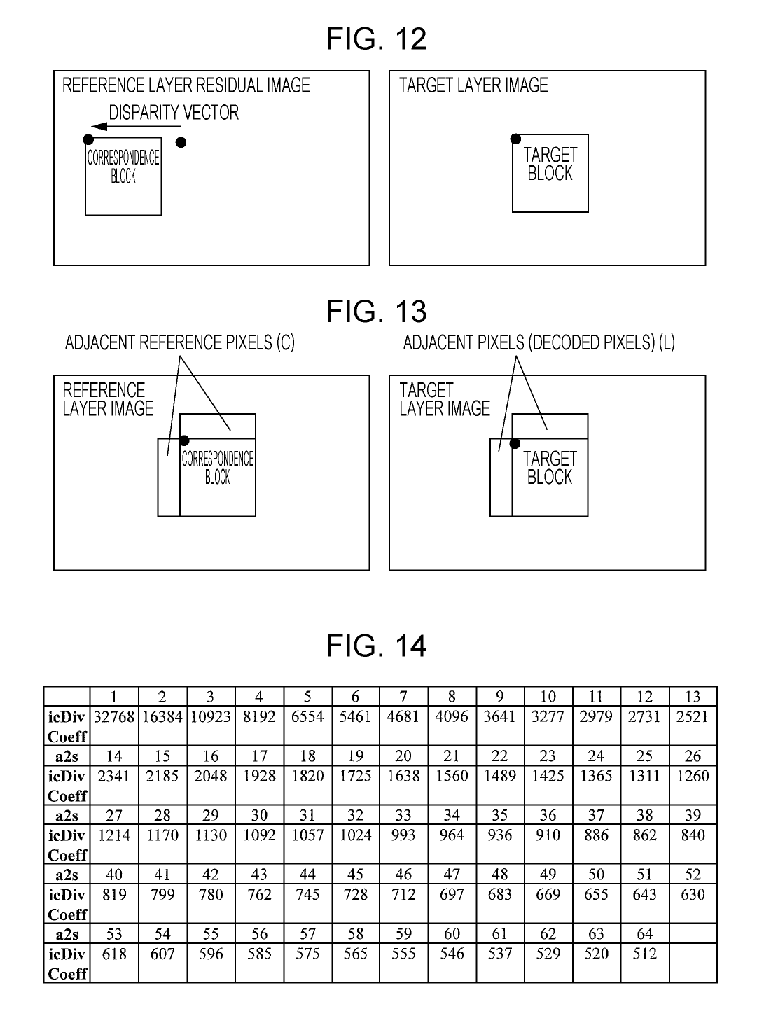

The residual prediction section 3092 is configured to include a residual acquisition section 30921 and a residual filter section 30922 (none of which is illustrated). FIG. 12 is a conceptual diagram illustrating the residual prediction. A correspondence block corresponding to the target block on the target layer is located in a block present at a position deviated by the disparity vector mvDisp which is a vector indicating a positional relation between the reference layer and the target layer using the position of the target block of the image on the reference layer as a starting point. Accordingly, a residual located at the position deviated by the disparity vector mvDisp is used as the residual used for the residual prediction. Specifically, the residual acquisition section 30921 derives a pixel present at a position at which the coordinates (x, y) of a pixel of the target block is deviated by an integer pixel component of the disparity vector mvDisp of the target block. In consideration that the disparity vector mvDisp has decimal precision, the residual acquisition section 30921 derives an X coordinate xR0 of a corresponding pixel R0 and an X coordinate xR1 of an adjacent pixel R1 of the pixel R0 when the coordinates of the pixel of the target block are (xP, yP), by the following expression.

xR0=Clip3(0,PicWidthInSamples_{L}−1,xP+x+(mvDisp[0]>>2))

xR1=Clip3(0,PicWidthInSamples_{L}−1,xP+x+(mvDisp[0]>>2)+1)

Here, Clip3 (x, y, z) is a function of restricting (clipping) z to a value equal to or greater than x and equal to or less than y. Further, mvDisp[0]>>2 is an expression by which an integer component is derived in a vector of quarter-pel precision.

The residual acquisition section 30921 derives a weight coefficient w0 of the pixel R0 and a weight coefficient w1 of the pixel R1 according to a decimal pixel position (mvDisp[0]−((mvDisp[0]>>2)<<2)) of the coordinates designated by the disparity vector mvDisp by the following expressions.

w0=4−mvDisp[0]+((mvDisp[0]>>2)<<2)

w1=mvDisp[0]−((mvDisp[0]>>2)<<2)

Subsequently, the residual acquisition section 30921 acquires the residuals of the pixels R0 and R1 by refResSamples_{L}[xR0, y] and refResSamplesL[xR1, y] from the residual storage section 313. The residual filter section 30922 derives a predicted residual delta′, by the following expression.

delta_{L}=(w0*refResSamples_{L}[xR0,y])+w1*refResSamples_{L}[xR1,y]+2))>>2

In the foregoing process, the pixel is derived through the linear interpolation when the disparity vector mvDisp has the decimal precision. However, a neighborhood integer pixel may be used without using the linear interpolation. Specifically, the residual acquisition section 30921 may acquire only a pixel xR0 as a pixel corresponding to the pixel of the target block and derive the predicted residual delta_{L} using the following expression.

delta_{L}=refResSamples_{L}[xR0,y]

### (Illumination Compensation)

When the illumination compensation flag ic_enable_flag is 1, the illumination compensation section 3093 executes illumination compensation on the input motion disparity compensated image predSamplesLX. When the illumination compensation flag ic_enable_flag is 0, the input motion disparity compensated image predSamplesLX is output without change. The motion disparity compensated image predSamplesLX input to the illumination compensation section 3093 is an output image of the motion disparity compensation section 3091 when the residual prediction is turned off. The motion disparity compensated image predSamplesLX is an output image of the residual prediction section 3092 when the residual prediction is turned on. The illumination compensation is executed based on the assumption that a change in a pixel value of a motion disparity image of an adjacent region adjacent to a target block which is a predicted image generation target with respect to a decoded image of the adjacent region is similar to a change in the pixel value in the target block with respect to the original image of the target block.

The illumination compensation section 3093 is configured to include an illumination parameter estimation section 30931 and an illumination compensation filter section 30932 (none of which is illustrated).

The illumination parameter estimation section 30931 obtains the estimation parameters to estimate the pixels of a target block (target prediction unit) from the pixels of a reference block. FIG. 13 is a diagram illustrating the illumination compensation. In FIG. 13, the positions of pixels C which are in the neighbor of the reference block on the reference layer image and are located at positions deviated by the disparity vector from the target block from pixels L in the neighbor of the target block are illustrated.

The illumination parameter estimation section 30931 obtains the estimation parameters (illumination change parameters) a and b from the pixels L (L0 to LN−1) in the neighbor of the target block and the pixels C (C0 to CN−1) in the neighbor of the reference block using the least-squares method by the following expressions.

LL=ΣLi×Li

LC=ΣLi×Ci

L=ΣLi

C=ΣCi

a=(N*LC−L*C)/(N*CC−C*C)

b=(LL*C−LC*L)/(N*CC−C*C)

Here, Σ is a function for addition for i. Here, i is a variable from 0 to N−1.

When the foregoing estimation parameters are decimal, it is necessary to execute a decimal operation in the foregoing expressions. As for a device, the estimation parameters and derivations of the parameters are preferably integers.

Hereinafter, a case in which the estimation parameters are integers will be described. The illumination compensation section 3093 derives estimation parameters (illumination change parameters) icaidx, ickidx, and icbidx by the following expressions.

k3=Max(0,bitDepth+Log 2(nCbW>>nSidx)−14)

k2=Log 2((2*(nCbW>>nSidx))>>k3)

a1=(LC<<k2)−L*C

a2=(LL<<k2)−L*L

k1=Max(0,Log 2(abs(a2))−5)−Max(0,Log 2(abs(a1))−14)+2

a1s=a1>>Max(0,Log 2(abs(a1))−14)

a2s=abs(a2>>Max(0,Log 2(abs(a2))−5))

a3=a2s<1?0:Clip3(−215,215−1,(a1s*icDivCoeff+(1<<(k1−1)))>>k1)

icaidx=a3>>Max(0,Log 2(abs(a3))−6)

ickidx=13−Max(0,Log 2(abs(icaidx))−6)

icbidx=(L−((icaidx*C)>>k1)+(1<<(k2−1)))>>k2

Here, bitDepth is a bit width (normally, 8 to 12) of the pixels, nCbW is the width of the target block, Max (x, y) is a function obtaining the maximum values of x and y, Log 2 (x) is a function obtaining a logarithm 2 of x, abs(x) is a function that obtains the absolute value of x. Further, icDivCoeff is a table illustrated in FIG. 14 for deriving a predetermined integer when a2s is an input.

The illumination compensation filter section 30932 included in the illumination compensation section 3093 derives pixels for which illumination change is compensated from target pixels using the estimation parameters derived by the illumination parameter estimation section 30931. For example, when the estimation parameters are decimals a and b, the pixels are obtained by the following expressions.

predSamples[x][y]=a*predSamples[x][y]+b

Here, predSamples is a pixel at coordinates (x, y) in the target block.

When the estimation parameters are the above-described integers icaidx, ickidx, and icbidx, the pixels are obtained by the following expression.

predSamples[x][y]=Clip3(0,(1<<bitDepth)−1,((((predSamplesL0[x][y]+offset1)>>shift1)ica0)>>ick0)+icb0)

### (Weight Prediction)

The weight prediction section 3094 generates a predicted picture block P (predicted image) by multiplying the input motion disparity image predSamplesLX by a weight coefficient. When the residual prediction and the illumination compensation are executed, the input motion disparity image predSamplesLX is an image subjected to the residual prediction and the illumination compensation. When one (predFlagL0 or predFlagL1) of the reference list use flags is 1 (in the case of the uni-prediction) and the weight prediction is not used, a process of the following expression that matches the input motion disparity image predSamplesLX (LX is L0 or L1) to the number of pixel bits is executed.

predSamples[x][y]=Clip3(0,(1<<bitDepth)−1,(predSamplesLX[x][y]+offset1)>>shift1)

Here, shift1=14−bitDepth and offset1=1<<(shift1−1).

When both (predFlagL0 or predFlagL1) of the reference list use flags are 1 (in the case of the bi-prediction) and the weight prediction is not used, a process of the following expression that averages the input motion disparity images predSamplesL0 and predSamplesL1 to be matched with the number of pixel bits is executed.

predSamples[x][y]=Clip3(0,(1<<bitDepth)−1,(predSamplesL0[x][y]+predSamplesL1[x][y]+offset2)>>shift2)

Here, shift2=15−bitDepth and offset2=1<<(shift2−1).

When the weight prediction is executed as the uni-prediction, the weight prediction section 3094 derives a weight prediction coefficient w0 and an offset o0 and executes a process of the following expression.

predSamples[x][y]=Clip3(0,(1<<bitDepth)−1,((predSamplesLX[x][y]w0+2 log 2WD−1)>>log 2WD)+00)

Here, log 2WD is a variable that indicates a predetermined shift amount.

When the weight prediction is executed in the case of the bi-prediction, the weight prediction section 3094 derives weight prediction coefficients w0, w1, o0, and of and executes a process of the following expression.

predSamples[x][y]=Clip3(0,(1<<bitDepth)−1, (predSamplesL0[x][y]w0+predSamplesL1[x][y]w1+((o0+o1+1)<<log 2WD))>>(log 2WD+1))

### [Image Coding Device]

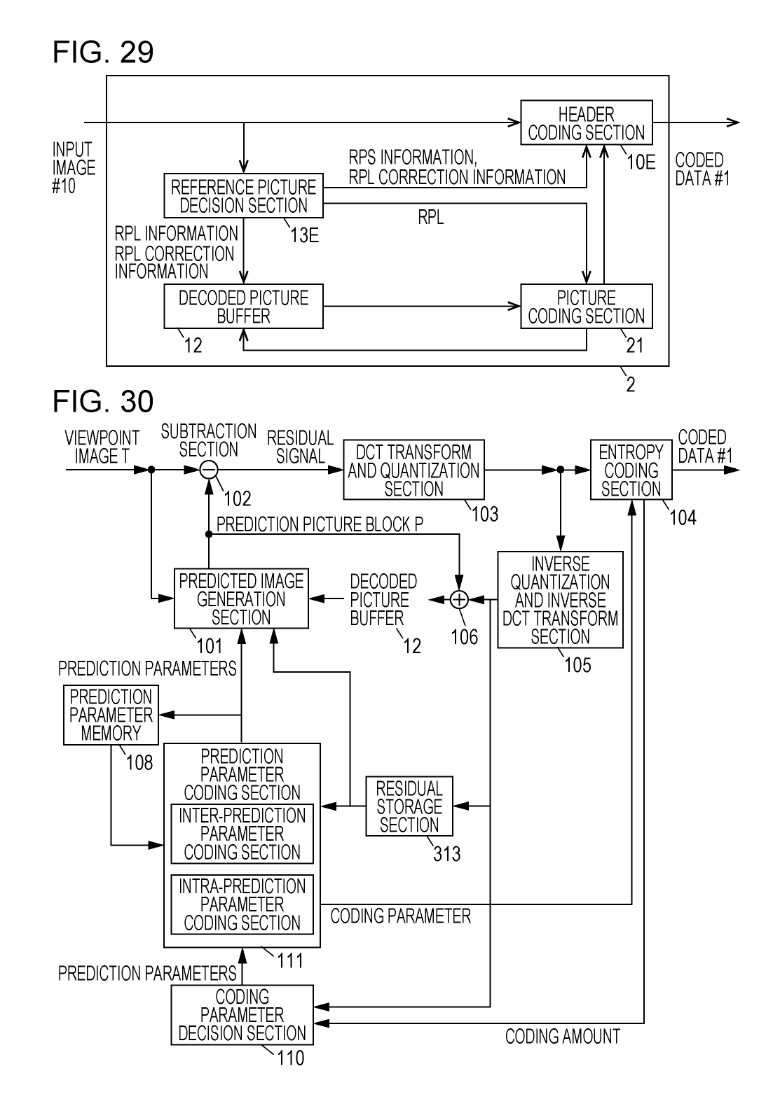

Hereinafter, the image coding device 2 according to the embodiment will be described with reference to FIG. 29.

### (Overview of Image Coding Device)

Roughly speaking, the image coding device 2 is a device that generates the coded data #1 by coding the input image #10 and outputs the coded data.

### (Configuration of Image Coding Device)

An example of the configuration of the image coding device 2 according to the embodiment will be described. FIG. 29 is a schematic diagram illustrating the configuration of the image coding device 2 according to the embodiment. The image coding device 2 is configured to include a header coding section 10E, a picture coding section 21, the decoded picture buffer 12, and a reference picture decision section 13E. The image coding device 2 can execute a random access decoding process of starting the decoding from the pictures at a specific time in images including a plurality of layers, as will be described below.

### [Header Coding Section 10E]

The header coding section 10E generates information used to decode the NAL unit header, the SPS, the PPS, the slice header, and the like in the NAL unit, the sequence unit, the picture unit, or the slice unit based on the input image #10, and then codes and outputs the information.

The header coding section 10E parses the VPS and the SPS included in the coded data #1 based on the given definition of the syntax and codes the information used for the decoding in the sequence unit. For example, the information regarding the number of layers is coded in the VPS and the information regarding the image size of the decoded image is coded in the SPS.

The header coding section 10E parses the slice header included in the coded data #1 based on the given definition of the syntax and codes the information used for the decoding in the slice unit. For example, the slice type is coded from the slice header.

As illustrated in FIG. 32, the header coding section 10E includes an NAL unit header coding section 211E, a VPS coding section 212E, a layer information storage section 213, a view depth derivation section 214, a POC information coding section 216E, a slice type coding section 217E, and a reference picture information coding section 218E.

### [NAL Unit Header Coding Section 211E]

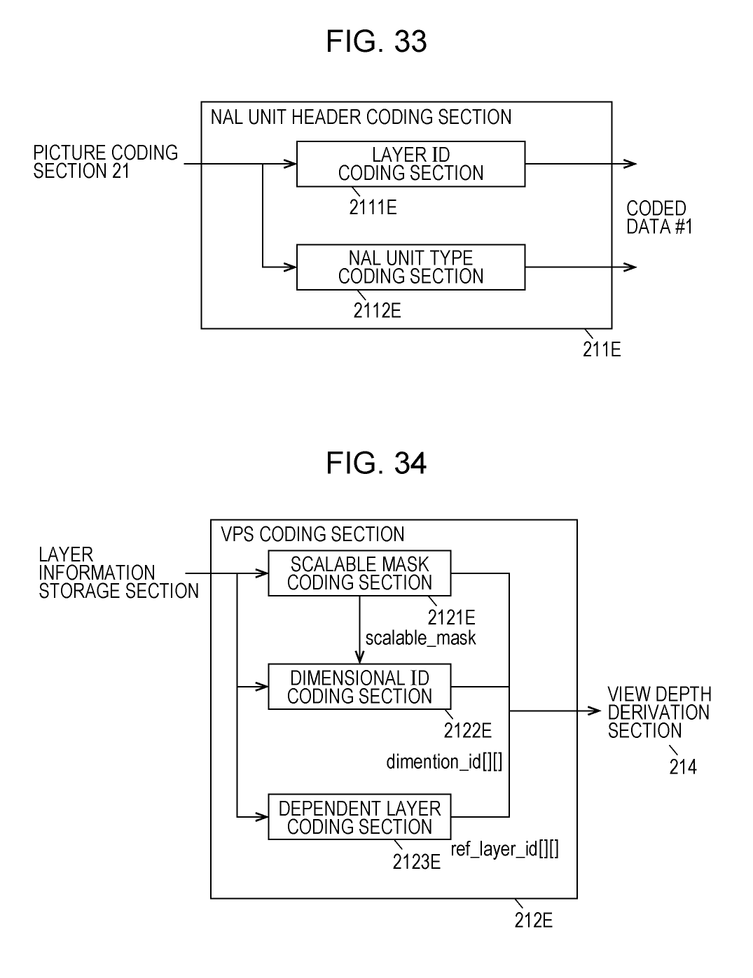

FIG. 33 is a functional block diagram illustrating a schematic configuration of the NAL unit header coding section 211E. As illustrated in FIG. 33, the NAL unit header coding section 211E is configured to include a layer ID coding section 2111E and an NAL unit type coding section 2112E. The layer ID coding section 2111E codes the layer ID in the coded data. The NAL unit type coding section 2112E codes the NAL unit type to the coded data.

### [VPS Coding Section 212E]

The VPS coding section 212E codes information used for the coding with the plurality of layers based on the regulated definition of the syntax as VPS and VPS extensions in the coded data. For example, the syntax illustrated in FIG. 20 is coded from the VPS and the syntax illustrated in FIG. 21 is coded from the VPS extension. To code the VPS extension, 1 is coded as the flag vps_extension_flag.

FIG. 34 is a functional block diagram illustrating a schematic configuration of the VPS coding section 212E. As illustrated in FIG. 34, the VPS coding section 212E is configured to include a scalable type coding section 2121E, a dimensional ID coding section 2122E, and a dependent layer coding section 2123E.

In the VPS coding section 212E, the syntax element vps_max_layers_minus1 indicating the number of layers is coded by an internal number-of-layer coding section (not illustrated).

The scalable type coding section 2121E reads the scalable mask scalable_mask from the layer information storage section 213 and codes the scalable mask scalable_mask in the coded data. The dimensional ID coding section 2122E codes the dimension ID dimension_id[i][j] for each layer i and scalable classification j. The index i of the layer ID has a value from 1 to vps_max_layers_minus1 and the index j indicating the scalable classification has a value from 0 to NumScalabilityTypes−1.

The dependent layer coding section 2123E codes the number of dependent layers num_direct_ref_layers and the dependent layer flag ref_layer_id in the coded data. Specifically, dimension_id[i][j] is coded by the number of dependent layers num_direct_ref_layers for each layer i. The index i of the layer ID has a value from 1 to vps_max_layers_minus1 and the index j of the dependent layer flag has a value from 0 to num_direct_ref_layers−1. For example, when layer 1 is dependent on layer 2 and layer 3, the number of dependent layers num_direct_ref_layers[1]=2 is satisfied, and ref_layer_id[1][0]=2 and ref_layer_id[1][1]=3 are coded.

### [Reference Picture Decision Section 13E]

The reference picture decision section 13E includes a reference picture information coding section 218E, a reference picture set decision section 24, and a reference picture list decision section 25.

The reference picture set decision section 24 decides the reference picture set RPS used for coding and local decoding of the coding target picture based on the input image #10 and the locally decoded image recorded on the decoded picture buffer 12, and then outputs the reference picture set RPS.

The reference picture list decision section 25 decides the reference picture list RPL used for coding and local decoding of the coding target picture based on the input image #10 and the reference picture set.

### [Reference Picture Information Coding Section 218E]

The reference picture information coding section 218E is included in the header coding section 10E and executes a reference picture information coding process based on the reference picture set RPS and the reference picture list RPL to generate the RPS information and the RPL correction information included in the SPS and the slice header.

(Correspondence Relation with Image Decoding Device)

The image coding device 2 has a configuration corresponding to each configuration of the image decoding device 1. Here, the correspondence means a relation in which the same process or a reverse process is executed.

For example, the reference picture information decoding process of the reference picture information decoding section 218 included in the image decoding device 1 is the same as the reference picture information coding process of the reference picture information coding section 218E included in the image coding device 2. More specifically, the reference picture information decoding section 218 generates the RPS information or the correction RPL information as a syntax value decoded from the SPS or the slice header. On the other hand, the reference picture information coding section 218E codes the input RPS information or correction RPL information as the syntax value of the SPS or the slice header.

For example, the process of decoding the syntax value from the bit string in the image decoding device 1 corresponds as a reverse process to the process of coding the bit string from the syntax value in the image coding device 2.

### (Flow of Process)

An order in which the image coding device 2 generates the output coded data #1 from the input image #10 is as follows.

(S21) The following processes of S22 to S29 are executed on each of the pictures (target pictures) forming the input image #10.

(S22) The reference picture set decision section 24 decides the reference picture set RPS based on the target picture in the input image #10 and the locally decoded image recorded on the decoded picture buffer 12 and outputs the reference picture set RPS to the reference picture list decision section 25. The RPS information necessary to generate the reference picture set RPS is derived and output to the reference picture information coding section 218E.

(S23) The reference picture list decision section 25 derives the reference picture list RPL based on the target pictures in the input image #10 and the input reference picture set RPS and outputs the reference picture list RPL to the picture coding section 21 and the picture decoding section 11. The RPL correction information necessary to generate the reference picture list RPL is derived and is output to the reference picture information coding section 218E.

(S24) The reference picture information coding section 218E generates the RPS information and the RPL correction information to be included in the SPS or the slice header based on the reference picture set RPS and the reference picture list RPL.

(S25) The header coding section 10E generates the SPS to be applied to the target picture based on the input image #10 and the RPS information and the RPL correction information generated by the reference picture decision section 13E and outputs the SPS.

(S26) The header coding section 10E generates and outputs the PPS to be applied to the target picture based on the input image #10.

(S27) The header coding section 10E codes the slice header of each slice forming the target picture based on the input image #10 and the RPS information and the RPL correction information generated by the reference picture decision section 13E, outputs the slice header as a part of the coded data #1 to the outside, and outputs the slice header to the picture decoding section 11.

(S28) The picture coding section 21 generates the slice data of each slice forming the target picture based on the input image #10 and outputs the slice data as a part of the coded data #1 to the outside.

(S29) The picture coding section 21 generates the locally decoded image of the target picture and records the locally decoded image in association with the POC and the layer ID of the target picture on the decoded picture buffer.

### [POC Information Coding Section 216E]

FIG. 48 is a functional block diagram illustrating a schematic configuration of the POC information coding section 216E. As illustrated in FIG. 48, the POC information coding section 216E is configured to include a POC setting section 2165, a POC low-order bit maximum value coding section 2161E, and a POC low-order bit coding section 2162E. The POC information coding section 216E separates and codes the high-order bit PicOrderCntMsb of the POC and the low-order bit pic_order_cnt_lsb of the POC.

The POC setting section 2165 sets a common time TIME on the pictures in all of the layers of the same time. The POC setting section 2165 sets the POC of the target picture based on the time TIM (common time TIME) of the target picture. Specifically, when the picture of the target layer is the RAP picture to be coded (the BLA picture or the IDR picture), the POC is set to 0 and the time TIME at this time is set in a variable TIME_BASE. TIME_BASE is recorded by the POC setting section 2165.

When the picture of the target layer is not the RAP picture for which the POC is coded, a value obtained by subtracting TIME_BASE from the time TIME is set in the POC.

The POC low-order bit maximum value coding section 2161E sets the POC low-order bit maximum value MaxPicOrderCntLsb common to all of the layers. The POC low-order bit maximum value MaxPicOrderCntLsb set in the coded data #1 is coded. Specifically, a value obtained by subtracting an integer 4 from the logarithm of the POC low-order bit maximum value MaxPicOrderCntLsb is coded as log 2_max_pic_order_cnt_lsb_minus4.

By setting the POC low-order bit maximum value MaxPicOrderCntLsb common to all of the layers, it is possible to generate the coded data having the above-described POC low-order bit maximum value restriction.

In the coded data structure having the POC low-order bit maximum value restriction, the update of the display time POC (POC high-order bit) is executed with the pictures of the same time in the plurality of layers having the same time. Therefore, the pictures in the plurality of layers having the same time can have the same display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing can be managed using the time of the picture. Thus, it is possible to obtain the advantageous effect of facilitating retrieval and synchronization of the reference picture.

The POC low-order bit coding section 2162E codes the POC low-order bit pic_order_cnt_lsb of the target picture from the POC of the target picture input from the POC setting section 2165. Specifically, the POC low-order bit pic_order_cnt_lsb is obtained by a remainder by the POC low-order bit maximum value MaxPicOrderCntLsb of the input POC and POC % MaxPicOrderCntLsb (or POC&(MaxPicOrderCntLsb−1)), and pic_order_cnt_lsb is coded in the slice header of the target picture.

In a coding device including the POC setting section 2165, the common time TIME is set in the pictures in all of the layers of the same time and the POC low-order bit maximum value MaxPicOrderCntLsb common to all of the layers is set in the POC low-order bit maximum value coding section 2161E. Thus, it is possible to generate the coded data having the above-described POC low-order bit pic_order_cnt_lsb.

In the coded data structure having the foregoing POC low-order bit restriction, the low-order bits of the display time POC are the same in the pictures of the same time in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing can be managed using the time of the picture. Thus, it is possible to obtain the advantageous effect of facilitating retrieval and synchronization of the reference picture.

### [POC Restriction]

### (First NAL Unit Type Restriction)

As described above, in the coded data structure according to the embodiment, as the first NAL unit type restriction, there is provided restriction that all of the pictures in all of the layers having the same time, that is, the pictures in all of the layers of the same access unit, indispensably include the same NAL unit type. When a target picture is in the layer other than the layer ID=0, the NAL unit type coding section 2112E according to the embodiment codes the NAL unit type of the picture with the layer ID=0 at the same time as the NAL unit type of the target layer in order to code the coded data having the first NAL unit type restriction.

### (Second NAL Unit Type Restriction)

As described above, in the coded data structure according to the embodiment, as the second NAL unit type restriction, there is provided restriction that when the picture of the layer with the layer ID of 0 is a RAP picture which is a picture for which the POC is initialized (when the picture is the IDR picture or the BLA picture), the pictures in the all of the layers having the same time, that is, the pictures in all of the layers of the same access unit, indispensably include the NAL unit type of the RAP picture for which the POC is initialized. When the target layer is the layer other than the layer ID=0 and the NAL unit type of the picture of the layer ID=0 is the RAP for which the POC is initialized, the NAL unit type coding section 2112E according to the embodiment codes the NAL unit type of the picture of the layer ID=0 as the NAL unit type of the target layer in order to code the coded data having the second NAL unit type restriction.

### (Second POC High-Order Bit Derivation Section 2163B)

An image coding device including the second POC high-order bit derivation section 2163B is configured such that the POC high-order bit derivation section 2163 in the POC information coding section 216E is substituted with the second POC high-order bit derivation section 2163B to be described below and the above-described means is used as other means.

When the target picture is the picture with the layer ID of 0 and the NAL unit type of the target picture input from the NAL unit header coding section 211E indicates the RAP picture for which it is necessary to initialize the POC (in the case of the BLA or the IDR), the second POC high-order bit derivation section 2163B initializes the POC high-order bit PicOrderCntMsb to 0 by the following expression.

PicOrderCntMsb=0

When the target picture is a picture with the layer ID other than 0 and the NAL unit type of the picture with the layer ID of 0 at the same time as the target picture indicates the RAP picture for which it is necessary to initialize the POC (in the case of the BLA or the IDR), the POC high-order bit PicOrderCntMsb is initialized to 0 by the following expression.

PicOrderCntMsb=0

In an image coding device including the second POC high-order bit derivation section 2163B, the display time POC is initialized in the pictures at the same time as the picture with the layer ID of 0 in the plurality of layers having the same time. Therefore, the pictures in the plurality of layers having the same time can have the display time POC. Thus, when the plurality of layers are synchronized and reproduced, for example, when a reference picture is managed and a 3-dimensional image is reproduced in a case in which the picture in a layer different from a target layer is used as the reference picture in the reference picture list, the fact that the pictures are the pictures of the same time can be managed using the POC in a case in which a display timing is managed using the time of the picture. Thus, it is possible to obtain the advantageous effect of facilitating retrieval and synchronization of the reference picture.

### [Slice Type Coding Section 217E]

The slice type coding section 217E codes the slice type slice_type in the coded data #1.

### [Slice Type Restriction]

In the embodiment, the following restriction is imposed as coded data restriction. In first coded data restriction of the embodiment, when a layer is a base layer (when the layer ID is 0) and the NAL unit type is a random access picture (RAP), that is, the picture is the BLA, the IDR, or the CRA, the slice type slice_type shall be coded as an intra-slice I_SLICE. When the layer ID is a value other than 0, the coding is executed without restriction of the slice type.

In the restriction of the range of the value of the slice type dependent on the layer ID, as described above, the slice type is restricted to the intra-slice I_SLICE when the NAL unit type is a random access picture (RAP) in the picture of the layer with the layer ID of 0. In a picture of the layer with the layer ID other than 0, the slice type is not restricted to the intra-slice I_SLICE even when the NAL unit type is a random access picture (RAP). Therefore, in a picture of the layer with the layer ID other than 0, the picture with the layer ID of 0 at the same display time can be used as the reference image even when the NAL unit type is a random access picture (RAP). Therefore, it is possible to obtain the advantageous effect of improving the coding efficiency.

In the restriction of the range of the value of the slice type dependent on the layer ID is restricted, as described above, a picture with the layer ID other than 0 at the same display time can be set to a random access picture (RAP) without deterioration in the coding efficiency when the picture is a random access picture with the layer ID of 0. Therefore, it is possible to obtain the advantageous effect of facilitating the random access. In the structure in which the POC is initialized in the case of the NAL unit type of the IDR or the BLA, in order to equalize the initialization timings of the POCs between different layers, it is necessary to set the IDR or the BLA as the picture even in the layer with the layer ID other than 0 when the picture is the IDR or the BLA with the layer ID of 0. However, even in this case, the NAL unit type can remain in the IDR or the BLA for which the POC is initialized in the picture of the layer with the layer ID other than 0 and the picture with the layer ID of 0 at the same display time can be used as the reference image. Therefore, it is possible to obtain the advantageous effect of improving the coding efficiency.

### (Configuration of Picture Coding Section 21)

Next, the configuration of the picture coding section 21 according to the embodiment will be described. FIG. 30 is a block diagram illustrating the configuration of the picture coding section 21 according to the embodiment. The picture coding section 21 is configured to include a predicted image generation section 101, a subtraction section 102, a DCT and quantization section 103, an entropy coding section 104, an inverse quantization and inverse DCT section 105, an addition section 106, a prediction parameter memory 108, a coding parameter decision section 110, and a prediction parameter coding section 111. The prediction parameter coding section 111 is configured to include an inter-prediction parameter coding section 112 and an intra-prediction parameter coding section 113.

The predicted image generation section 101 generates the predicted picture block P for each block which is a region separated from each picture in regard to the picture at each viewpoint of the layer image T input from the outside. Here, the predicted image generation section 101 reads the reference picture block from the prediction parameter coding section 111 based on the prediction parameter input from the decoded picture buffer 12. The prediction parameter input from the prediction parameter coding section 111 is, for example, the motion vector or the disparity vector. The predicted image generation section 101 reads the reference picture block of the block located at a position indicated by the motion vector or the disparity vector predicated using a coding target block as a starting point. The predicted image generation section 101 generates the predicted picture block P using one prediction scheme among a plurality of prediction schemes in regard to the read reference picture block. The predicted image generation section 101 outputs the generated predicted picture block P to the subtraction section 102. Since the operation of the predicted image generation section 101 is the same as the operation of the predicted image generation section 308 described above, the details of the generation of the predicted picture block P will be omitted.

To select the prediction scheme, the predicted image generation section 101 selects, for example, a prediction scheme in which an error value based on a difference between a signal value for each pixel of the block included in the layer image and a signal value for each pixel corresponding to the predicted picture block P is the minimum. The method of selecting the prediction scheme is not limited thereto.

When the picture of a coding target is the base view picture, the plurality of prediction schemes are intra-prediction, motion prediction, and merge prediction. The motion prediction is display inter-temporal prediction among the above-described inter-prediction. The merge prediction is prediction in which the same reference picture block as a block, which is an already encoded block and is a block within a pre-decided range from the coding target block, and the prediction parameters are used. When the picture of the coding target is the non-base view picture, the plurality of prediction schemes are intra-prediction, motion prediction, merge prediction, and disparity prediction. The disparity prediction (parallax prediction) is prediction between different layer images (different viewpoint images) in the above-described inter-prediction. Further, the prediction schemes are the motion prediction, the merge prediction, and the disparity prediction. In the disparity prediction (parallax prediction), there are prediction when the additional prediction (the residual prediction and the illumination compensation) is executed and prediction when the additional prediction is not executed.

When the intra-prediction is selected, the predicted image generation section 101 outputs the prediction mode predMode indicating the intra-prediction mode used at the time of the generation of the predicted picture block P to the prediction parameter coding section 111.

When the motion prediction is selected, the predicted image generation section 101 stores the motion vector mvLX used at the time of the generation of the predicted picture block P in the prediction parameter memory 108 and outputs the motion vector mvLX to the inter-prediction parameter coding section 112. The motion vector mvLX indicates a vector from the position of the coding target block to the position of the reference picture block at the time of the generation of the predicted picture block P. Information indicating the motion vector mvLX includes information (for example, the reference picture index refIdxLX or the picture order number POC) indicating the reference picture and may indicate the prediction parameter. The predicted image generation section 101 outputs a prediction mode predMode indicating the inter-prediction mode to the prediction parameter coding section 111.

When the disparity prediction is selected, the predicted image generation section 101 stores the disparity vector used at the time of the generation of the predicted picture block P in the prediction parameter memory 108 and outputs the disparity vector to the inter-prediction parameter coding section 112. The disparity vector dvLX indicates a vector from the position of the coding target block to the position of the reference picture block at the time of the generation of the predicted picture block P. Information indicating the disparity vector dvLX includes information (for example, the reference picture index refldxLX or the view ID view_id) indicating the reference picture and may indicate the prediction parameter. The predicted image generation section 101 outputs a prediction mode predMode indicating the inter-prediction mode to the prediction parameter coding section 111.

When the merge prediction is selected, the predicted image generation section 101 outputs the merge index merge_idx indicating the selected reference picture block to the inter-prediction parameter coding section 112. Further, the predicted image generation section 101 outputs a prediction mode predMode indicating the merge prediction mode to the prediction parameter coding section 111.

When the predicted image generation section 101 executes the residual prediction as the additional prediction in the motion prediction, the disparity prediction, and the merge prediction described above, the residual prediction section 3092 included in the predicted image generation section 101 executes the residual prediction, as described above. When the predicted image generation section 101 executes the illumination compensation as the additional prediction, the illumination compensation section 3093 included in the predicted image generation section 101 executes the illumination compensation prediction, as described above.

The subtraction section 102 generates a residual signal by subtracting a signal value of the predicted picture block P input from the predicted image generation section 101 for each pixel from a signal value of the block corresponding to the layer image T input from the outside. The subtraction section 102 outputs the generated residual signal to the DCT and quantization section 103 and the coding parameter decision section 110.

The DCT and quantization section 103 executes DCT on the residual signal input from the subtraction section 102 to calculate a DCT coefficient. The DCT and quantization section 103 quantizes the calculated DCT coefficient to obtain a quantization coefficient. The DCT and quantization section 103 outputs the obtained quantization coefficient to the entropy coding section 104 and the inverse quantization and inverse DCT section 105.

The quantization coefficient is input from the DCT and quantization section 103 to the entropy coding section 104 and the coding parameter is input from the coding parameter decision section 110 to the entropy coding section 104. As the input coding parameter, for example, there are codes such as the reference picture index refIdxLX, the vector index mvp_LX_idx, the difference vector mvdLX, the prediction mode predMode, and the merge index merge_idx.

The entropy coding section 104 executes entropy coding on the input quantization coefficient and coding parameter to generate the coded data #1 and outputs the generated coded data #1 to the outside.

The inverse quantization and inverse DCT section 105 executes inverse quantization on the quantization coefficient input from the DCT and quantization section 103 to obtain a DCT coefficient. The inverse quantization and inverse DCT section 105 executes the inverse DCT on the obtained DCT coefficient to calculate a decoding residual signal. The inverse quantization and inverse DCT section 105 outputs the calculated decoding residual signal to the addition section 106.

The addition section 106 adds a signal value of the predicted picture block P input from the predicted image generation section 101 and a signal value of the decoding residual signal input from the inverse quantization and inverse DCT section 105 for each pixel to generate a reference picture block. The addition section 106 stores the generated reference picture block in the decoded picture buffer 12.

The prediction parameter memory 108 stores the prediction parameter generated by the prediction parameter coding section 111 at a position decided in advance for each picture and block of the coding target.

The coding parameter decision section 110 selects one set from a plurality of sets of coding parameters. The coding parameters are the above-described prediction parameters or parameters which are coding targets generated in association with the prediction parameters. The predicted image generation section 101 generates the predicted picture block P using each set of coding parameters.

The coding parameter decision section 110 calculates a cost value indicating the size of an information amount or a coding error in each of the plurality of sets. The cost value is, for example, a sum of the coding amount and a value obtained by multiplying a squared error by a coefficient λ. The coding amount is an information amount of the coded data #1 obtained by executing entropy coding on a quantized error and the coding parameter. The squared error is a total sum of squared values of residual values of residual signals calculated in the subtraction section 102 between the pixels. The coefficient λ is a larger real number than preset zero. The coding parameter decision section 110 selects the set of coding parameters for which the calculated cost value is the minimum. In this way, the entropy coding section 104 outputs the selected set of coding parameters as the coded data #1 to the outside and does not output the unselected set of coding parameters.

The prediction parameter coding section 111 derives the prediction parameters used at the time of the generation of the predicted picture based on the parameter input from the predicted image generation section 101 and codes the derived prediction parameter to generate the set of coding parameters. The prediction parameter coding section 111 outputs the generated set of coding parameters to the entropy coding section 104.

The prediction parameter coding section 111 stores the prediction parameter corresponding to the set of coding parameters selected by the coding parameter decision section 110 among the generated sets of coding parameters in the prediction parameter memory 108.

When the prediction mode predMode input from the predicted image generation section 101 is the inter-prediction mode, the prediction parameter coding section 111 operates the inter-prediction parameter coding section 112. When the prediction mode predMode indicates the intra-prediction mode, the prediction parameter coding section 111 operates the intra-prediction parameter coding section 113.

The inter-prediction parameter coding section 112 derives the inter-prediction parameter based on the prediction parameter input from the coding parameter decision section 110. The inter-prediction parameter coding section 112 includes the same configuration as the configuration in which the inter-prediction parameter decoding section 303 (see FIG. 5 or the like) derives the inter-prediction parameter as the configuration in which the inter-prediction parameter is derived. The configuration of the inter-prediction parameter coding section 112 will be described below.

The intra-prediction parameter coding section 113 decides an intra-prediction mode IntraPredMode indicated by the prediction mode predMode input from the coding parameter decision section 110 as the set of inter-prediction parameter.

### (Configuration of Inter-Prediction Parameter Coding Section)

Next, the configuration of the inter-prediction parameter coding section 112 will be described. The inter-prediction parameter coding section 112 is means corresponding to the inter-prediction parameter decoding section 303.

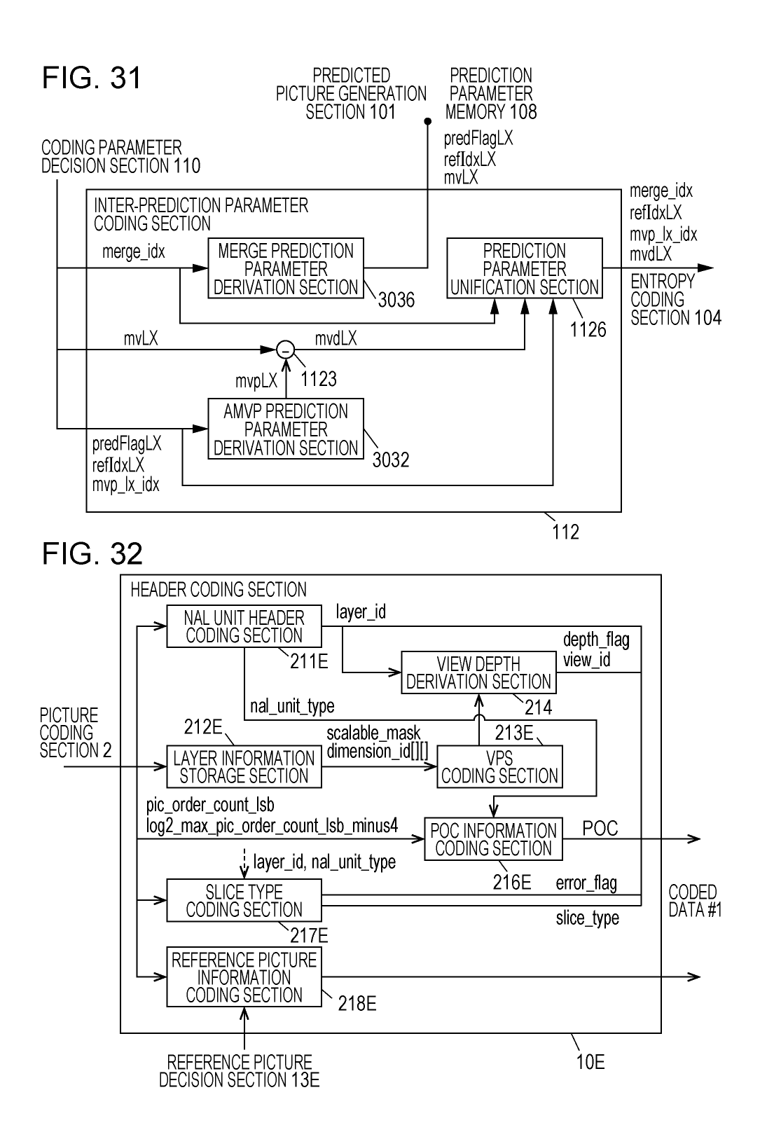

FIG. 31 is a schematic diagram illustrating the configuration of the inter-prediction parameter coding section 112 according to the embodiment.

The inter-prediction parameter coding section 112 is configured to include an inter-prediction parameter coding control section 1031, a merge prediction parameter derivation section 1121, an AMVP prediction parameter derivation section 1122, a subtraction section 1123, and a prediction parameter unification section 1126.

The merge prediction parameter derivation section 1121 has the same configuration as the above-described merge prediction parameter derivation section 3036 (see FIG. 7).

The inter-prediction parameter coding control section 1031 instructs the entropy coding section 104 to decode the codes (syntax elements) related to the inter-prediction. The codes (syntax elements) included in the coded data #1, for example, the split mode part_mode, the merge flag merge_flag, the merge index merge_idx, the inter-prediction flag inter_pred_idx, the reference picture index refldxLX, the prediction vector index mvp_LX_idx, and the difference vector mvdLX, are coded.

When the prediction mode predMode input from the predicted image generation section 101 indicates the merge prediction mode, the merge index merge_idx is input from the coding parameter decision section 110 to the merge prediction parameter derivation section 1121. The merge index merge_idx is output to the prediction parameter unification section 1126. The merge prediction parameter derivation section 1121 reads the vector mvLX and the reference picture index refIdxLX of the reference block indicated by the merge index merge_idx among the merge candidates from the prediction parameter memory 108. The merge candidate is a reference block which is a reference block (for example, among the reference blocks adjacent to the lower left end, the upper left end, and the upper right end of the coding target block) within a range decided in advance from the coding target block which is the coding target and is the reference block subjected to the coding process.

The AMVP prediction parameter derivation section 1122 has the same configuration as the above-described AMVP prediction parameter derivation section 3032 (see FIG. 8).

When the prediction mode predMode input from the predicted image generation section 101 indicates the inter-prediction mode, the vector mvLX is input from the coding parameter decision section 110 to the AMVP prediction parameter derivation section 1122. The AMVP prediction parameter derivation section 1122 derives the prediction vector mvpLX based on the input vector mvLX. The AMVP prediction parameter derivation section 1122 outputs the derived prediction vector mvpLX to the subtraction section 1123. The reference picture index refldx and the vector index mvp_LX_idx are output to the prediction parameter unification section 1126.

The subtraction section 1123 subtracts the prediction vector mvpLX input from the AMVP prediction parameter derivation section 1122 from the vector mvLX input from the coding parameter decision section 110 to generate a difference vector mvdLX. The difference vector mvdLX is output to the prediction parameter unification section 1126.

When the prediction mode predMode input from the predicted image generation section 101 indicates the merge prediction mode, the prediction parameter unification section 1126 outputs the merge index merge_idx input from the coding parameter decision section 110 to the entropy coding section 104.

When the prediction mode predMode input from the predicted image generation section 101 indicates the inter-prediction mode, the prediction parameter unification section 1126 executes the following process.

The prediction parameter unification section 1126 unifies the reference picture index refIdxLx and the vector index mvp_LX_idx input from the coding parameter decision section 110 and the difference vector mvdLX input from the subtraction section 1123. The prediction parameter unification section 1126 outputs the unified code to the entropy coding section 104.

### CONCLUSION

An image decoding device with a first configuration includes an NAL unit header decoding section that decodes a layer ID and an NAL unit type nal_unit_type defining a type of NAL unit from an NAL unit header. Here, nal_unit_type of a picture with the layer ID other than 0 which is decoded by the NAL unit header decoding section is the same as nal_unit_type of a picture with the layer ID of 0 corresponding to the picture with the layer ID other than 0.

In the coded data structure of the first configuration, the coded data configured to include one or more NAL units when the NAL unit header and NAL unit data are set as a unit (NAL unit) has the restriction that the NAL unit header includes the layer ID and the NAL unit type nal_unit_type defining a type of NAL unit and the NAL unit header with the layer ID other than 0 indispensably includes nal_unit_type which is the same as the NAL unit header with the layer ID of 0 at the same display time.

In the coded data structure and the image decoding device of the first configuration, the picture with the layer ID of 0 and the picture with the layer ID other than 0 include the same nal_unit_type. Therefore, when the picture with the layer ID of 0 is a random access point, the picture with the layer ID other than 0 also becomes a random access point and the decoding can start from the same point of time irrespective of the layer ID. Therefore, it is possible to obtain the advantageous effect of improving random access performance.

When the picture with the layer ID of 0 is the random access point, the picture with the layer ID other than 0 also becomes the random access point and the decoding can start from the same point of time irrespective of the layer ID. Therefore, it is possible to obtain the advantageous effect of improving random access performance.

An image decoding device with a second configuration includes an NAL unit header decoding section that decodes a layer ID and an NAL unit type nal_unit_type defining a type of NAL unit from an NAL unit header. When the layer ID is 0 and the foregoing nal_unit_type is the RAP picture, nal_unit_type of a picture with the layer ID other than 0 which is decoded by the NAL unit header decoding section and which corresponds to the layer ID of 0 is the same as nal_unit_type of a picture with the layer ID of 0.

In the coded data structure of the second configuration, the coded data configured to include one or more NAL units when the NAL unit header and NAL unit data are set as a unit (NAL unit) has the restriction that the NAL unit header includes the layer ID and the NAL unit type nal_unit_type defining a type of NAL unit and the NAL unit header with the layer ID other than 0 indispensably includes nal_unit_type which is the same as the NAL unit header with the layer ID of 0 at the same display time when the NAL unit header with the layer ID of 0 includes the NAL unit type nal_unit_type of the RAP picture (BLA or IDR) for which it is necessary to initialize the display time.

In the coded data structure of the second configuration and the image decoding device of the second configuration, when the picture with the layer ID of 0 is a random access point, the picture with the layer ID other than 0 also becomes a random access point and the decoding can start from the same point of time irrespective of the layer ID. Therefore, it is possible to obtain the advantageous effect of improving random access performance.

An image decoding device with a third configuration includes: an NAL unit header decoding section that decodes a layer ID and an NAL unit type nal_unit_type defining a type of NAL unit from an NAL unit header; and a slice header decoding section that decodes a slice type indicating an intra-slice or one or more inter-slices from a slice header. When the layer ID is 0 and the NAL unit type nal_unit_type is the RAP picture, the slice type decoded by the slice header decoding section is the intra-slice. When the layer ID is a value other than 0 and the foregoing nal_unit_type is the RAP picture, the slice types decoded by the slice header decoding section are the intra-slice and the inter-slice.

The coded data structure of the third configuration includes a slice header that defines a slice type. The slice header has restriction that the slice type is an intra-slice in the case of a slice with a layer ID of 0 and has no restriction that the slice type is the intra-slice in the case in a slice with a layer ID other than 0.

In the coded data structure of the third configuration and the image decoding device of the third configuration, the inter-prediction in which the decoded image of the picture with the layer ID of 0 is referred to can be used in the slice with the layer ID other than 0 while maintaining the random access performance. Therefore, it is possible to obtain the advantageous effect of the improving the coding efficiency.

An image decoding device with a fourth configuration includes an NAL unit header decoding section that decodes a layer ID and an NAL unit type nal_unit_type defining a type of NAL unit from an NAL unit header; a POC low-order bit maximum value decoding section that decodes a low-order bit maximum value MaxPicOrderCntLsb of a display time POC from a picture parameter set; a POC low-order bit decoding section that decodes a low-order bit pic_order_cnt_lsb of the display time POC from a slice header; a POC high-order bit derivation section that derives a POC high-order bit from the NAL unit type nal_unit_type, the POC low-order bit maximum value MaxPicOrderCntLsb, and the POC low-order bit pic_order_cnt_lsb; and a POC addition section that derives the display time POC from a sum of the POC high-order bit and the POC low-order bit.

In the coded data structure of the fourth configuration, in the coded data configured to include one or more NAL units when the NAL unit header and NAL unit data are set as a unit (NAL unit), the NAL unit header includes the layer ID and the NAL unit type nal_unit_type defining a type of NAL unit. The picture parameter set included in the NAL unit data includes the low-order bit maximum value MaxPicOrderCntLsb of the display time POC. The slice data included in the NAL unit data is configured to include the slice header and the slice data. In the slice data in the coded data including the low-order bit pic_order_cnt_lsb of the display time POC, all of the NAL units stored in a same access unit in all the layers include the same display time POC in the included slice header.

In the coded data structure of the fourth configuration and the image decoding device of the fourth configuration, since it is ensured that the NAL units having the same time have the same display time (POC), whether a picture is the picture having the same time between different layers can be determined using the display time POC. Thus, it is possible to obtain the advantageous effect in which a decoded image at the same time can be referred to.

In regard to a coded data structure of a fifth configuration, the coded data structure of the fourth configuration has restriction that in a case in which an NAL unit header with the layer ID of 0 at the same display time POC includes the NAL unit type nal_unit_type of a picture for which it is necessary to initialize the display time POC, the NAL unit header with the layer ID other than 0 indispensably includes nal_unit_type which is the same as the NAL unit header with the layer ID of 0 at the same display time.

In the coded data structure of the fifth configuration, when the picture with the layer ID of 0 is the random access point of the IDR or the BLA and the display time POC is initialized, the picture with the layer ID other than 0 also becomes the random access point and the display time POC is initialized. Therefore, it is possible to obtain the advantageous effect of equalizing the display time POC between the layers.

In regard to a coded data structure of a sixth configuration, the coded data structure of the fourth configuration has restriction that all of the NAL units stored in the same access unit in all the layers indispensably include the same low-order bit maximum value MaxPicOrderCntLsb in the corresponding picture parameter set. The coded data structure further has restriction that all of the NAL units stored in the same access unit in all the layers indispensably include the low-order bit pic_order_cnt_lsb of the same display time POC in the included slice header.

In the coded data structure of the sixth configuration, the different layers are ensured to have the same low-order bit maximum value MaxPicOrderCntLsb. Therefore, when the POC is updated according to the value of the low-order bit of the display time POC, the POC is updated to the same value and the high-order bit of the display time POC is the same value between the different layers. The low-order bit of the display time POC is ensured to have the same between the different layers. Therefore, it is possible to obtain the advantageous effect in which the high-order bit and the low-order bit of the display time POC are the same between the different layers, that is, the different layers have the same display time POC.

An image decoding device with a seventh configuration includes an NAL unit header decoding section that decodes a layer ID and an NAL unit type nal_unit_type defining a type of NAL unit from an NAL unit header; a POC low-order bit maximum value decoding section that decodes a low-order bit maximum value MaxPicOrderCntLsb of a display time POC from a picture parameter set; a POC low-order bit decoding section that decodes a low-order bit pic_order_cnt_lsb of the display time POC from a slice header; a POC high-order bit derivation section that derives a high-order bit of the POC from the NAL unit type nal_unit_type, the POC low-order bit maximum value MaxPicOrderCntLsb, and the POC low-order bit pic_order_cnt_lsb; and a POC addition section that derives the display time POC from a sum of the high-order bit of the POC and the low-order bit of the POC. The POC high-order bit derivation section initializes the display time POC of a target layer when the NAL unit type nal_unit_type of a picture with the layer ID of 0 is an RAP picture (BLA or IDR) for which the display time POC is initialized.

In the image decoding device of the seventh configuration, the POC is initialized at the same timing between the different layers even when the NAL unit type nal_unit_type is different between the plurality of layer IDs. Therefore, it is possible to obtain the advantageous effect in which the display time POC are the same between the different layers.

A computer may be allowed to realize some of the image coding device 2 and the image decoding device 1 according to the above-described embodiment, for example, the entropy decoding section 301, the prediction parameter decoding section 302, the predicted image generation section 101, the DCT and quantization section 103, the entropy coding section 104, the inverse quantization and inverse DCT section 105, the coding parameter decision section 110, the prediction parameter coding section 111, the entropy decoding section 301, the prediction parameter decoding section 302, the predicted image generation section 308, and the inverse quantization and inverse DCT section 311. In this case, a program realizing the control function may be recorded on a computer-readable recording medium and the program recorded on the recording medium may be read to a computer system to be executed so that the functions are realized. The “computer system” mentioned here is a computer system included in one of the image coding device 2 and the image decoding device 1 and includes an OS and hardware such as peripheral device. The “computer-readable recording medium” refers to a portable medium such as a flexible disk, a magneto-optical disc, a ROM, or a CD-ROM or a storage device such as a hard disk included in a computer system. The “computer-readable recording medium” may also include a medium retaining a program dynamically for a short time, such as a communication line when a program is transmitted via a network such as the Internet or a communication circuit line such as a telephone circuit and a medium retaining a program for a given time, such as a volatile memory included in a computer system serving as a server or a client in this case. The program may be a program used to realize some of the above-described functions or may be a program combined with a program already stored in a computer system to realize the above-described functions.

Some or all of the image coding device 2 and the image decoding device 1 according to the above-described embodiment may be realized as an integrated circuit such as large scale integration (LSI). Each of the functional blocks of the image coding device 2 and the image decoding device 1 may be individually formed as a processor or some or all of the functional blocks may be integrated to be formed as a processor. A method for an integrated circuit is not limited to the LSI, but may be realized by a dedicated circuit or a general processor. When an integrated circuit technology substituting the LSI with an advance in semiconductor technologies appears, an integrated circuit may be used by the technology.

The embodiment of the invention has been described above in detail with reference to the drawings, but a specific configuration is not limited to the above-described configuration. The invention can be modified in various forms within the scope of the invention without departing from the gist of the invention.

The invention is not limited to the above-described embodiments, but can be modified in various ways within the range described in the claims and embodiments obtained by appropriately combining the technical means disclosed in the different embodiments are also included in the technical range of the invention. By combining the technical means disclosed in the embodiments, it is possible to form new technical features.

### INDUSTRIAL APPLICABILITY

The invention can be appropriately applied to an image decoding device that decodes coded data obtained by coding image data and an image coding device that generates coded data obtained by coding image data. Further, the invention can be appropriately applied to the data structure of coded data generated by an image coding device and referred to by an image decoding device.

### REFERENCE SIGNS LIST

1 IMAGE DECODING DEVICE
2 IMAGE CODING DEVICE
3 NETWORK
4 IMAGE DISPLAY DEVICE
5 IMAGE TRANSMISSION SYSTEM
10 HEADER DECODING SECTION
10E HEADER CODING SECTION
11 PICTURE DECODING SECTION
12 DECODED PICTURE BUFFER
13 REFERENCE PICTURE MANAGEMENT SECTION
131 REFERENCE PICTURE SET SETTING SECTION
132 REFERENCE PICTURE LIST DERIVATION SECTION
13E REFERENCE PICTURE DECISION SECTION
101 PREDICTED IMAGE GENERATION SECTION
102 SUBTRACTION SECTION
103 DCT AND QUANTIZATION SECTION
1031 INTER-PREDICTION PARAMETER CODING CONTROL SECTION
104 ENTROPY CODING SECTION
105 INVERSE QUANTIZATION AND INVERSE DCT SECTION
106 ADDITION SECTION
108 PREDICTION PARAMETER MEMORY
110 CODING PARAMETER DECISION SECTION
111 PREDICTION PARAMETER CODING SECTION
112 INTER-PREDICTION PARAMETER CODING SECTION
1121 MERGE PREDICTION PARAMETER DERIVATION SECTION
1122 AMVP PREDICTION PARAMETER DERIVATION SECTION
1123 SUBTRACTION SECTION
1126 PREDICTION PARAMETER UNIFICATION SECTION
113 INTRA-PREDICTION PARAMETER CODING SECTION
21 PICTURE CODING SECTION
211 NAL UNIT HEADER DECODING SECTION
2111 LAYER ID DECODING SECTION
2112 NAL UNIT TYPE DECODING SECTION
2123 DEPENDENT LAYER ID DECODING SECTION
211E NAL UNIT HEADER CODING SECTION
2111E LAYER ID CODING SECTION
2112E NAL UNIT TYPE CODING SECTION
2123E DEPENDENT LAYER CODING SECTION
212 VPS DECODING SECTION
2121 SCALABLE TYPE DECODING SECTION
2122 DIMENSIONAL ID DECODING SECTION
212E VPS CODING SECTION
2121E SCALABLE TYPE CODING SECTION
2122E DIMENSIONAL ID CODING SECTION
213 LAYER INFORMATION STORAGE SECTION
214 VIEW DEPTH DERIVATION SECTION
216 POC INFORMATION DECODING SECTION
216E POC INFORMATION CODING SECTION
2161 POC LOW-ORDER BIT MAXIMUM VALUE DECODING SECTION
2161E POC LOW-ORDER BIT MAXIMUM VALUE CODING SECTION
2162 POC LOW-ORDER BIT DECODING SECTION
2162E POC LOW-ORDER BIT CODING SECTION
2163 POC HIGH-ORDER BIT DERIVATION SECTION
2163B POC HIGH-ORDER BIT DERIVATION SECTION
2164 POC ADDITION SECTION
2165 POC SETTING SECTION
217 SLICE TYPE DECODING SECTION
217E SLICE TYPE CODING SECTION
218 REFERENCE PICTURE INFORMATION DECODING SECTION
218E REFERENCE PICTURE INFORMATION CODING SECTION
24 REFERENCE PICTURE SET DECISION SECTION
25 REFERENCE PICTURE LIST DECISION SECTION
301 ENTROPY DECODING SECTION
302 PREDICTION PARAMETER DECODING SECTION
303 INTER-PREDICTION PARAMETER DECODING SECTION
3031 INTER-PREDICTION PARAMETER DECODING CONTROL SECTION
30311 ADDITIONAL PREDICTION FLAG DECODING SECTION
303111 REFERENCE LAYER DETERMINATION SECTION
30312 MERGE INDEX DECODING SECTION
30313 VECTOR CANDIDATE INDEX DECODING SECTION
30314 ADDITIONAL PREDICTION FLAG DETERMINATION SECTION
3032 AMVP PREDICTION PARAMETER DERIVATION SECTION
3033 VECTOR CANDIDATE DERIVATION SECTION
3034 PREDICTION VECTOR SELECTION SECTION
3035 ADDITION SECTION
3036 MERGE PREDICTION PARAMETER DERIVATION SECTION
30361 MERGE CANDIDATE DERIVATION SECTION
303611 MERGE CANDIDATE STORAGE SECTION
303612 ENHANCEMENT MERGE CANDIDATE DERIVATION SECTION
3036121 INTER-LAYER MERGE CANDIDATE DERIVATION SECTION
3036122 DISPARITY VECTOR ACQUISITION SECTION
3036123 INTER-LAYER DISPARITY MERGE CANDIDATE DERIVATION SECTION
303613 BASIC MERGE CANDIDATE DERIVATION SECTION
3036131 SPATIAL MERGE CANDIDATE DERIVATION SECTION
3036132 TEMPORAL MERGE CANDIDATE DERIVATION SECTION
3036133 COMBINED MERGE CANDIDATE DERIVATION SECTION
3036134 ZERO MERGE CANDIDATE DERIVATION SECTION
303614 MPI CANDIDATE DERIVATION SECTION
30362 MERGE CANDIDATE SELECTION SECTION
304 INTRA-PREDICTION PARAMETER DECODING SECTION
307 PREDICTION PARAMETER MEMORY
308 PREDICTED IMAGE GENERATION SECTION
309 INTER-PREDICTED IMAGE GENERATION SECTION
3091 DISPARITY COMPENSATION SECTION
3092 RESIDUAL PREDICTION SECTION
30921 RESIDUAL ACQUISITION SECTION
30922 RESIDUAL FILTER SECTION
3093 ILLUMINATION COMPENSATION SECTION
30931 ILLUMINATION PARAMETER ESTIMATION SECTION
30932 ILLUMINATION COMPENSATION FILTER SECTION
3094 PREDICTION SECTION
310 INTRA-PREDICTED IMAGE GENERATION SECTION
3101 DIRECTION PREDICTION SECTION
3102 DMM PREDICTION SECTION
311 INVERSE QUANTIZATION AND INVERSE DCT SECTION
312 ADDITION SECTION
313 RESIDUAL STORAGE SECTION

1-7. (canceled)

8. An image decoding device, comprising:
a receiver configured to receive a Sequence Parameter Set and a slice header, wherein the Sequence Parameter Set determines one or more parameters of each picture; and
a derivation section configured to derive a Picture Order Count (POC) of a current picture;
wherein the derivation section is configured to derive the POC, wherein the POC of the each picture in an access unit has same value, wherein the access unit is a set of NAL units.

9. The image decoding device according to claim 8, further comprising:
a first decoder configured to decode a low-order bit pic_order_cnt_lsb of the POC in the slice header.

10. The image decoding device according to claim 8, further comprising:
a second decoder configured to decode a syntax log 2_max_pic_order_cnt_lsb_minus4, wherein the syntax indicates a low-order bit maximum value MaxPicOrderCntLsb in the Sequence Parameter Set.

11. The image decoding device according to claim 8, further comprising:
a POC high-order bit derivation section configured to derive a high-order bit PicOrderCntMsb of the POC by the low-order bit maximum value;
wherein the derivation section is configured to derive the POC by adding the low-order bit to the high-order bit

12. A method for decoding information, the method comprising:
receiving a Sequence Parameter Set and a slice header, wherein the Sequence Parameter Set determines one or more parameters of each picture; and
deriving a Picture Order Count (POC) of a current picture;
wherein the POC of the each picture in an access unit has same value, wherein the access unit is a set of NAL units.
